(19) United States
(12) Patent Application Publication
(10) Pub. No.: US 2009/0281853 A1
(43) Pub. Date: Nov. 12, 2009

(54) Legal Instrument Management Platform

(75) Inventors: Christian J. Misvaer, New York, NY (US); Praful Saklani, New York, NY (US); Brijdeep S. Bhasin, Brooklyn, NY (US); Thomas P. Guhin, New York, NY (US)

Correspondence Address: MERCHANT & GOULD PC, P.O. BOX 2903, MINNEAPOLIS, MN, 55402-0903, US

(73) Assignee: Pramata Corporation, New York, NY (US)

(21) Appl. No.: 12/437,742

(22) Filed: May 8, 2009

Related U.S. Application Data
(60) Provisional application No. 61/051,506, filed on May 8, 2008.

(51) Int. Cl. G06Q 10/00; G06F 17/30; G06F 17/40; G06F 3/048

(52) U.S. Cl. 705/7; 707/3; 707/9; 715/708; 707/E17.014; 707/E17.044; 707/E17.005

(57) ABSTRACT

A legal instrument management system facilitates the storage and management of documents including contracts or other legal instruments. The system facilitates the review of stored documents as well as the creation of new documents. The system also provides searching capabilities to quickly identify documents that match a search query. Contract models can be structured to define how data is organized and to normalize the description of contract terms in the system. Methods are also disclosed.

### CROSS-REFERENCE TO RELATED APPLICATIONS

This application claims priority to U.S. Provisional Patent Application No. 61/051,506, filed on May 8, 2008, entitled LEGAL INSTRUMENT MANAGEMENT PLATFORM, the disclosure of which is incorporated by reference herein in its entirety.

### BACKGROUND

Companies enter into a host of contractual relationships. For example, even small companies can have multiple contracts defining relationships with customers, service providers, and other vendors. For many companies, the primary method of storing and tracking contracts is paper-based and manual (i.e., the filing cabinet). Even larger companies with hundreds or thousands of contracts typically track the contracts in paper form or using rudimentary electronic storage options. To further complicate matters, data relating to the contracts process can be spread across different business units, such as sales, legal, finance, and in other areas of the company, as well as be recorded in disparate formats including emails, word processing and PDF documents, notepads, and hard documents.

The failure to adequately track contractual relationships can have various adverse consequences. For example, many companies have difficultly ascertaining contractual liabilities in a timely, cost-effective fashion since contract terms are not readily accessible (or completely inaccessible in some instances). In the event of a contractual claim, a manual review process is usually activated, which is both time consuming and potentially fraught with errors.

Further, because of the diversity of contract types, product lines, and the number of customers/vendors for large companies, it is difficult to manually keep track of all of the contractual terms that have been agreed to and to access the same in a timely fashion. This can lead to inefficiencies and lost opportunities, as well as have adverse legal consequences.

For example, because most terms are not monitored for compliance/follow-up, there is opportunity for business losses such as, for example, revenue losses (e.g., missed sales opportunities, expiration of favorable contract terms, etc.) or losses associated with inadequate internal controls over the negotiation of contractual terms, which can increase liability.

Further, when negotiating a new contract with a customer, corporate guidelines and standards are difficult to communicate and enforce across multiple departments and geographies. In addition, access to historical data (including data on the negotiating process for previous contracts with that customer or customer type) can be important in understanding negotiating tactics and in streamlining the process. In the absence of accurate or timely data on historical information as well as new contract requests, companies are often ‘flying blind’ and losing any learning gained from previous negotiating experience.

In addition, the adoption of Sarbanes-Oxley (SOX) has caused public companies to be under heightened requirements for managing processes which may have a material impact on their earnings. Many auditors conclude that the contract management process falls within the overview of SOX. As a result, repositories, reporting, and overall processes that are manual, ad hoc, and/or constantly changing are subject to heightened scrutiny, which translates into time and money in terms of internal commitments and fees associated with the auditing process.

### SUMMARY

In general terms the present disclosure is directed to systems and methods for managing documents, such as documents relating to contracts.

One aspect is a system for creating and managing contractual information, the system comprising a processing device and memory. The memory stores program instructions that when executed by the processor cause the processor to generate a contract modeling module, a customer module, a contract review module, and a user management module. The a contract modeling module is programmed to define a plurality of contract terms that are incorporated into a contract model, as well as to define a template that is configured to generate a draft contract. The customer module is programmed to execute a wizard associated with the contract model to receive information associated with the contract terms, validate the information, and apply the information to the template to generate the draft contract. The contract review module programmed to import an existing contract and to identify contract terms within the existing contract. The user management module programmed to restrict access to the draft contract based on the contract terms.

Another aspect is a method of managing contractual information, the method comprises: storing a master term list including a plurality of master terms in memory with a computing device, the plurality of master terms including at least a first master term; storing a first document in the memory with the computing device; outputting the first document with the computing device; receiving with the computing device a first input identifying a first document term in the first document; receiving with the computing device a second input identifying the first master term of the master term list; and associating the first document term with the first master term in the memory with the computing device.

A further aspect is a method of managing contractual information. The method includes: storing a master term list in a memory with a computing device, the master term list identifying a plurality of contract terms; storing a plurality of documents in the memory with the computing device; associating document terms within the plurality of documents with the contract terms of the master list and storing the associations in the memory with the computing device to normalize the document terms; receiving with the computing device a search request including at least one of the contract terms; performing a search to identify a subset of the plurality of documents that match the search request; and generating a report identifying the subset of the plurality of documents that match the search request.

### DESCRIPTION OF THE DRAWINGS

FIG. 1 shows an example contract management system.

FIG. 2 shows example modules of the contract management system of FIG. 1.

FIG. 3 shows example physical and logical security layers of the contract management system of FIG. 1.

FIG. 4 shows an example data structure for the contract management system of FIG. 1.

FIG. 5 shows an example method for creating contract models for the contract management system of FIG. 1.

FIG. 6 shows an example contract model interface.

FIG. 7 shows an example master term list interface.

FIG. 8 shows another example interface of the master term list interface of FIG. 7.

FIG. 9 shows an example master questions interface.

FIG. 10 shows an example wizard creation interface.

FIG. 11 shows another example interface of the wizard creation interface of FIG. 10.

FIG. 12 shows an example action/status creation interface.

FIG. 13 shows another example interface of the action/status creation interface of FIG. 12.

FIG. 14 shows an example approval creation interface.

FIG. 15 shows an example method for creating a contract using the contract management system of FIG. 1.

FIG. 16 shows the initiation operation of the example method of FIG. 15.

FIG. 17 shows the draft creation operation of the example method of FIG. 15.

FIG. 18 shows the negotiation operation of the example method of FIG. 15.

FIG. 19 shows the execution operation of the example method of FIG. 15.

FIG. 20 shows the filing operation of the example method of FIG. 15.

FIG. 21 shows the reporting and analysis operation of the example method of FIG. 15.

FIG. 22 shows an example dashboard user interface of the contract management system of FIG. 1.

FIG. 23 shows an example news feed details interface of the contract management system of FIG. 1.

FIG. 24 shows an example process manager interface of the contract management system of FIG. 1.

FIG. 25 shows an example request action interface of the contract management system of FIG. 1.

FIG. 26 shows another example of the request interface of FIG. 25.

FIG. 27 shows an example new contract request interface of the contract management system of FIG. 1.

FIG. 28 shows another example of the new contract request interface of FIG. 27.

FIG. 29 shows another example of the new contract request interface of FIG. 27.

FIG. 30 shows another example of the new contract request interface of FIG. 27.

FIG. 31 shows another example of the new contract request interface of FIG. 27.

FIG. 32 shows another example of the new contract request interface of FIG. 27.

FIG. 33 shows another example of the new contract request interface of FIG. 27.

FIG. 34 shows an example request summary interface of the contract management system of FIG. 1.

FIG. 35 shows an example key terms interface of the contract management system of FIG. 1.

FIG. 36 shows an example full-text contract interface of the contract management system of FIG. 1.

FIG. 37 shows another example of the full-text contract interface of FIG. 36.

FIG. 38 shows another example of the full-text contract interface of FIG. 36.

FIG. 39 shows an example versions interface of the contract management system of FIG. 1.

FIG. 40 shows an example approvals interface of the contract management system of FIG. 1.

FIG. 41 shows an example audit trail interface of the contract management system of FIG. 1.

FIG. 42 shows an example notes interface of the contract management system of FIG. 1.

FIG. 43 shows an example search interface of the contract management system of FIG. 1.

FIG. 44 shows another example search interface of the contract management system of FIG. 1.

FIG. 45 shows an example report interface of the contract management system of FIG. 1.

FIG. 46 shows an example contract list view interface of the contract management system of FIG. 1.

FIG. 47 shows an example contract family view interface of the contract management system of FIG. 1.

FIG. 48 shows an example executive summary interface of the contract management system of FIG. 1.

FIG. 49 shows an example key terms interface of the contract management system of FIG. 1.

FIG. 50 shows an example contract image interface of the contract management system of FIG. 1.

FIG. 51 shows an example non-standard terms interface of the contract management system of FIG. 1.

FIG. 52 shows an example contract family view interface of the contract management system of FIG. 1.

FIG. 53 shows an example notes interface of the contract management system of FIG. 1.

FIG. 54 shows an example amendments interface of the contract management system of FIG. 1.

FIG. 55 shows an example transaction list view interface of the contract management system shown in FIG. 1.

FIG. 56 shows an example transaction family view interface of the contract management system shown in FIG. 1.

FIG. 57 shows an example transaction view interface of the contract management system shown in FIG. 1.

FIG. 58 shows another example transaction view interface of the contract management system shown in FIG. 1.

FIG. 59 shows another example transaction view interface of the contract management system shown in FIG. 1.

FIG. 60 shows an example contract interface of the contract management system shown in FIG. 1.

FIG. 61 shows another example transaction view interface of the contract management system shown in FIG. 1.

FIG. 62 shows an example dashboard interface of the contract management system shown in FIG. 1.

FIG. 63 shows an example reporting interface of the contract management system shown in FIG. 1.

FIG. 64 shows another example reporting interface of the contract management system shown in FIG. 1.

FIG. 65 shows another example reporting interface of the contract management system shown in FIG. 1.

FIG. 66 shows another example reporting interface of the contract management system shown in FIG. 1.

FIG. 67 shows another example reporting interface of the contract management system shown in FIG. 1.

FIG. 68 shows an example search interface module of the contract management system shown in FIG. 1.

FIG. 69 shows another example reporting interface of the contract management system shown in FIG. 1.

FIG. 70 shows an example transaction model interface of the contract management system shown in FIG. 1.

FIG. 71 shows another example transaction model interface of the contract management system shown in FIG. 1.

FIG. 72 shows an example block diagram of the server of the contract management system shown in FIG. 1.

### DETAILED DESCRIPTION

The present disclosure relates to systems and methods for managing legal instruments. In example embodiments, the legal instruments relate to contractual information, although other types of legal documents can also be used. The example systems and methods described herein allow users to administer, create, search, secure, share, and analyze contractual information in an automated fashion. Further details on the example systems and methods are described below.

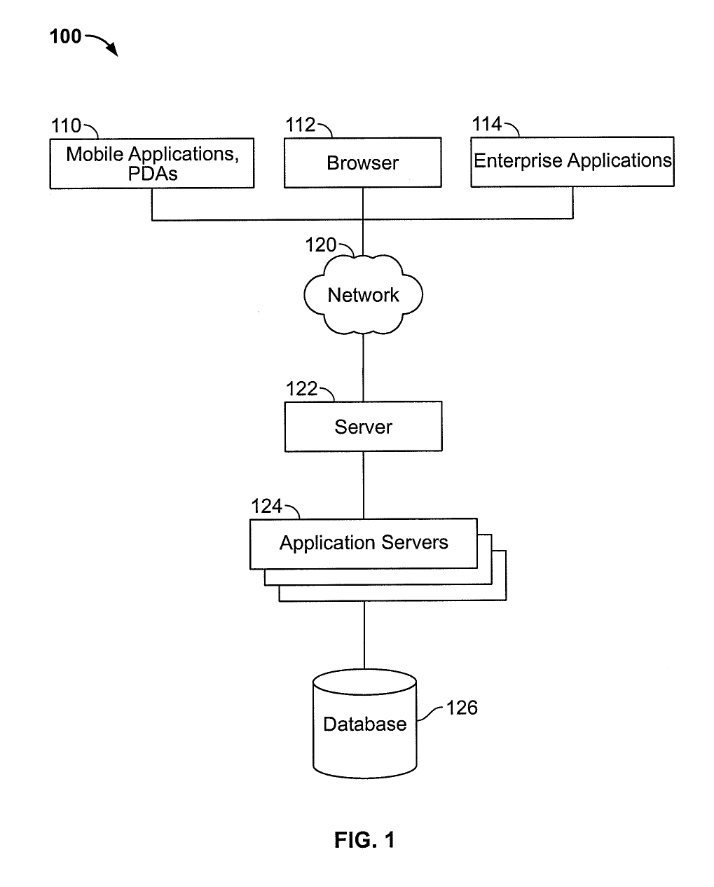

Referring now to FIG. 1, an example contract management system 100 is shown. Generally, the contract management system 100 allows users to query, manage, and collaborate using contract information managed by the system 100. The system 100 includes a server 122, application servers 124, and a database 126.

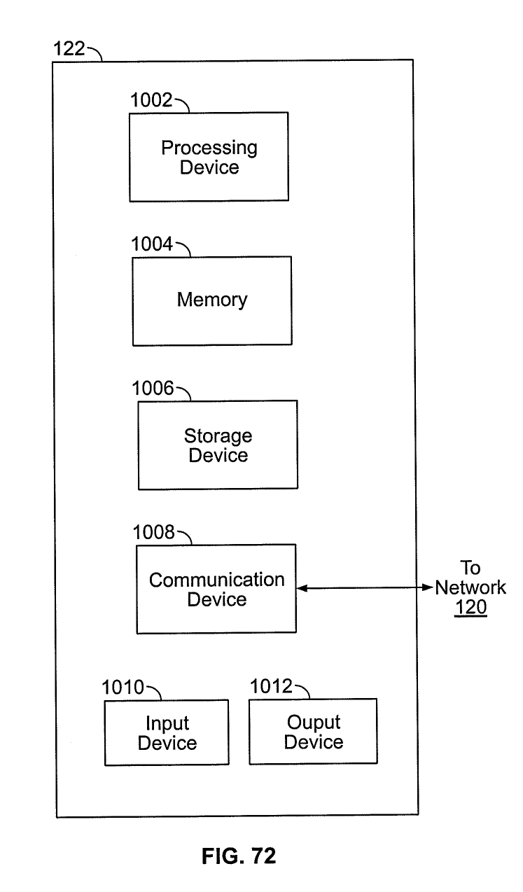

In example embodiments, the server 122 is a web server that is accessible through a network 120, such as a LAN, a WAN, or the Internet. The server 122 accepts requests from a plurality of clients 110, 112, 114. An example of a client is mobile client 110. A mobile client typically communicates with network 120 using wireless communication signals (e.g., radio frequency communication, infrared communication, etc.). Examples of mobile client 110 include a handheld computer, BlackBerry® Smartphone, iPhone® mobile digital device, WAP-enabled devices and other mobile devices. Another example of a client is a device 112 operating a browser software application. Yet another example of a client is a device 114 operating an enterprise software application. In some embodiments clients 110, 112, and 114 are computing systems, such as illustrated and described herein with reference to FIG. 72.

In the example shown, the web server 122 passes such requests to the application servers 124. The application servers 124 process the requests and access contract information from the database 126. The application servers 124 then send a response back to the server 122. The server 122, in turn, forwards the response to the requesting client 110, 112, 114.

In the example shown, the server 122 is an Apache Web Server (V2.x). The application servers 124 instantiate one or more contract management applications that serve requests from the clients 110, 112, 114 and manage the contract information in the database 126. In the example shown, such contract management applications are implemented using the Ruby on Rails (“Ruby”) framework. The application servers 124 are Mongrel servers running an HTTP library and server for Ruby. For scalability, a cluster of servers 124 can be deployed to enhance system performance.

Each of the servers 122, 124 is a computer system including a processing unit and computer readable media. For example, in one embodiment, the servers 122, 124 are AMD 64-bit architecture machines running Red Hat Enterprise Linux (RHEL) CentOS 4.x distribution. Computer readable media can include memory such as volatile (such as RAM) and non-volatile (such as ROM, flash memory, etc.), or some combination thereof. Additionally, the computer readable media can include mass storage (removable and/or non-removable) such as a magnetic or optical disks or tape. An operating system, such as Linux or Windows, and one or more application programs can be stored on the mass storage device. The computer system can include input devices (such as a keyboard and mouse) and output devices (such as a monitor and printer). The computer system also includes network connections that allow the servers 122, 124 to communicate with each other, as well as other devices, computers, networks, servers, etc.

The database 126 is programmed to store contractual information that can be accessed by the application servers 124. As described further below, this contractual information can take the form of the contracts and supporting documentation, as well as metadata, rules, templates, and other information that allows users to create, share, and search for specific contractual information. In the example shown, the database 126 is driven by MySQL V4.1.2, which supports Online Transaction Processing (OLTP) and multi-terabyte Data Warehousing applications. In some embodiments database 126 is computer readable media. In other embodiments, database 126 is computer storage media.

In example embodiments, the application servers 124 and the database 126 are programmed to host contract information for a plurality of different companies. This allows the applications and data associated with the contractual information from the plurality of companies to exist on a single code base. Differences in functionality between companies can be achieved through configuration, rather than customization. This simplifies maintenance and upgrades. Further, because the example system is hosted, upgrades and patches are done on a server-wide basis, and companies do not need to dedicate internal resources to managing the system 100.

In such a hosted system, third-party services are provided to a company to assist the company in the entry of contract information into the database 126. Also, the third-party services can assist in the development of wizards and templates that define the creation and review of new contracts. The company can thereupon access the application servers 124 to search for and review existing contract information, as well as create new contracts using the wizards and templates.

To create a robust hosted environment, the servers 122, 124 and database 126 can be run in redundant stacks and can be hosted in different data centers that are located in geographically-remote areas. Data can be mirrored between the two environments, and in the event of a failure of one of the environments, the application is seamlessly switched to the other environment. Clustering and load balancing can be added at various tiers of the system (server, application server, or database). The system 100 can also include built-in mechanisms for regular backups of the database(s) 126 and can maximize data redundancy by replicating the database(s) 126. In addition, mission critical applications running on servers 122, 124 are monitored through a series of application monitoring agents to maximize uptime.

In alternative embodiments, other configurations and hardware can be used for the system 100. For example, in another embodiment, the servers 122, 124 can be combined into a single-tiered environment with a server that accepts requests over a network, accesses data from the database 126, and responds to the requests. In other alternatives, a company can host and maintain the application servers 124 and database 126 servers internally, rather than rely on the hosted architecture described above.

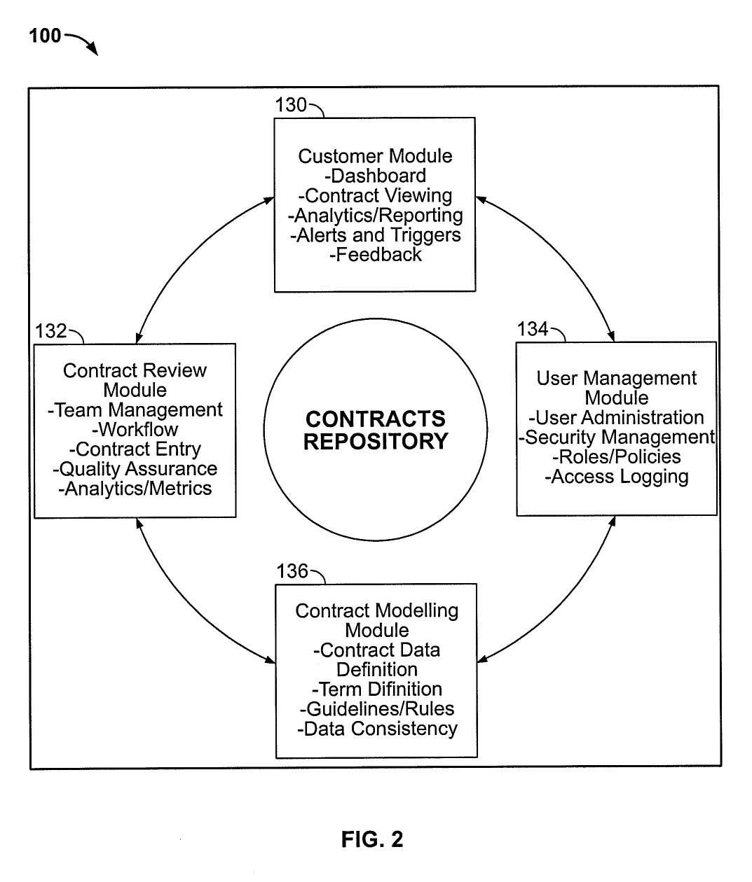

Referring now to FIG. 2, the system 100 can be broken logically into a plurality of modules. Specifically, the system includes a customer module 130, a contract review module 132, a user management module 134, and a contract modeling module 136.

The example customer module 130 is programmed to include a user interface that allows users to navigate the contracts repository and drill-down to specific contract terms, as well as retrieve scanned contract documents and other individual pieces of contract-related information.

Also, the users can generate reports on contracts using almost any piece of contract information (or a combination) stored in the database as the report criteria. Reporting information can also be shared or output using Microsoft Excel and PDF formats. Because of the rich information collected during each contract request, the system 100 is able to provide robust reporting on the entire request process. For example, the customer module 130 can generate reports to indicate which people have the highest number of non-standard term (described below) requests, allowing companies to understand the origin of non-standard term enquiries. Reports can be generated showing which divisions request certain types of clauses and contracts, the average amount of time required to create a contract, contracts related to a specific product or customer, etc. The information can be saved and shared with other users of the system 100.

The customer module 130 also allows users to define alerts and triggers related to various aspects of the contract creation and management process, such as the review and approval of specific contractual terms.

In addition, the customer module 130 is programmed to streamline and automate the process of requesting and generating contracts. For example, as described further below, the customer module 130 can include a plurality of contract request wizards that are defined to allow the user to quickly request and create a desired contract. In example embodiments, the wizards sequentially take user through a series of customized questions about the terms of the contract the user is requesting. Specific questions can be dynamically displayed based on previous entries or combinations of answers. Further, data from a plurality of sources, including both internal and external databases, can be accessed to populate information during creation of the contract.

The customer module 130 is also programmed to generate a dashboard that is customized for each user of the system 100. As described further below, the dashboard can include configurable information related to the contract request and management process. All submissions, approvals, and status changes can be made visible through the dashboard based on the user's role. For example, the dashboard for a requestor from a sales group can be configured to only monitor requests that pertain to that specific person, and only track specific actions (such as the completion of all approvals, or the fact that contract is ready for distribution). Since each dashboard can be tailored to the specific user, the information displayed to the user can be controlled based on the user's role. For example, key terms of a contract that are visible to a sales user may be very different than the terms that are visible to a legal user. This allows information to be shared more effectively between different groups, since people see only information that is relevant to their business function.

In addition, the dashboard allows managers to assign specific tasks associated with the creation and approval of a contract. For example, the tasks associated with contract requests can be managed and assigned from within the Dashboard. Managers can monitor the current status of various contracts, and also assign contracts to specific resources for follow up. In addition, assignments can also be automated so that contracts matching certain criteria can be automatically routed the correct resource(s) for handling. Targets and milestones can also be created to ensure that requests move forward in a timely manner, with automated alerts being generated when tasks are delayed.

The example contract review module 132 is programmed to allow users to accurately enter and review information for existing contracts (terms and data elements) into the system 100. In example embodiments, the contract review module 132 is programmed to streamline extraction and capture of data from existing contracts in a defined framework while maximizing data accuracy. For example, the contract review module 132 is programmed to allow a user to extract contract terms from an existing contract so that the system 100 can be used to search, retrieve, and report on the terms and/or the specific contract.

Each contract is broken down into terms that are normalized within a contract model. The normalized data enables enhanced levels of searching, reporting, and analysis. For example, there are multiple ways to state that a limitation of liability clause will not exceed 12 months of fees (e.g., “limitation of liability will not exceed one year” or “maximum damages will be limited to 4 quarters of payment”). When this data associated with the contract is entered into the system 100 using the contract review module 132, the data is normalized to enhance reporting. Also, the values can be compared to defined corporate guidelines and alerts generated when the values fall outside the guidelines.

In the example shown, the contract review module 132 is programmed to be used by a third-party service that analyzes the contract, dissects the contract into the normalized terms, and inputs the terms into the system 100 for the company. In the example shown, the contract review module 132 can also be programmed to identify non-standard terms (i.e., terms that fall outside a given value) in a contract. When such non-standard terms are identified, the contract review module 132 is programmed to auto-generate any approvals that may be necessary for the non-standard terms.

In addition, the approval workflow process of the contract review module 132 is configurable based on customer business rules. For example, a rule can define that a contract over a certain monetary value can be forwarded to a financial executive for approval. This approval workflow includes both serial and parallel routing, delegations, and manual overrides, if required. In addition, some users, such as legal resources, can be given the option to manually create approvals, if required.

Because of the data-driven approach, approvers can be asked to approve specific data within a contract, rather than having to read an entire contract. For example, if the only term that requires approval is the monetary value of a contract, the contract review module 132 is programmed specifically ask the approver whether the monetary value is authorized. This process helps to minimize review time and brings more precision into the process of reviewing and approving contracts. The contract review module 132 can be programmed to route approval requests to approvers via email and/or through the approver's dashboard within the system 100. For simple approvals, users have the option to click on a link within an email to approve a contract, without having to log into the system 100. For denials where an explanation is required, the user can click on a link and then enter a comment.

Further, the contract review module 132 is programmed to notify the correct users when a contract is ready for signature, or when a signed copy has been received. In addition, contracts with a status of ‘Signature Pending’ can be tracked, to ensure that signed copies are received. Similarly, when a contract is ready for distribution, the system 100 is configured to automatically route the information to the correct resources. In addition, the distribution summary can show only the information that is required by the person receiving the notice. For example, a financial resource can receive a distribution notice highlighting the specific invoicing details related to a contract, while a legal resource can receive a different sub-set of information associated with the contract.

The contract review module 132 also allows auditing to determine who specifically approved which non-standard term. For example, the system 100 is programmed to track each contract version, including the date of the version, the user who saved/uploaded the version, and any comments associated with the version. For example, requestors and approvers can submit notes and comments throughout the contract creation process, and these notes and comments are captured. Users can also select multiple versions to compare text differences. Versions can be kept with the signed contract in the database 126 for future reference. The system 100 also includes the option to automatically ‘destroy’ any past versions once a contract has been completed, if that is preferred.

In this manner, the contract review module 132 can be leveraged to analyze and input contracts that are both paper and electronic-based and that originate with the company or with a third-party contractor.

The example user management module 134 is programmed to manage user accounts, assign roles, and specify security policies associated with the system 100. Roles and security policies can be used to control the access to data and functionality. For example, the user management module 134 can be programmed to restrict access to a given documents on the system 100. Additional details regarding security for the system 100 are described below.

The example contract modeling module 136 is programmed to efficiently model contracts in the system 100. In general, the contract modeling module 136 provides a dictionary of various categories of contracts terms and applicable data elements for similar contracts. Multiple models can be defined. For example, the contract modeling module 136 is programmed to generate a contract model relating a Non-Disclosure Agreement having 25 pieces of data, as well as a contract model for a complex sales contract having 100 pieces of information. Both of these models are managed efficiently by the contract modeling module 136 within the system 100.

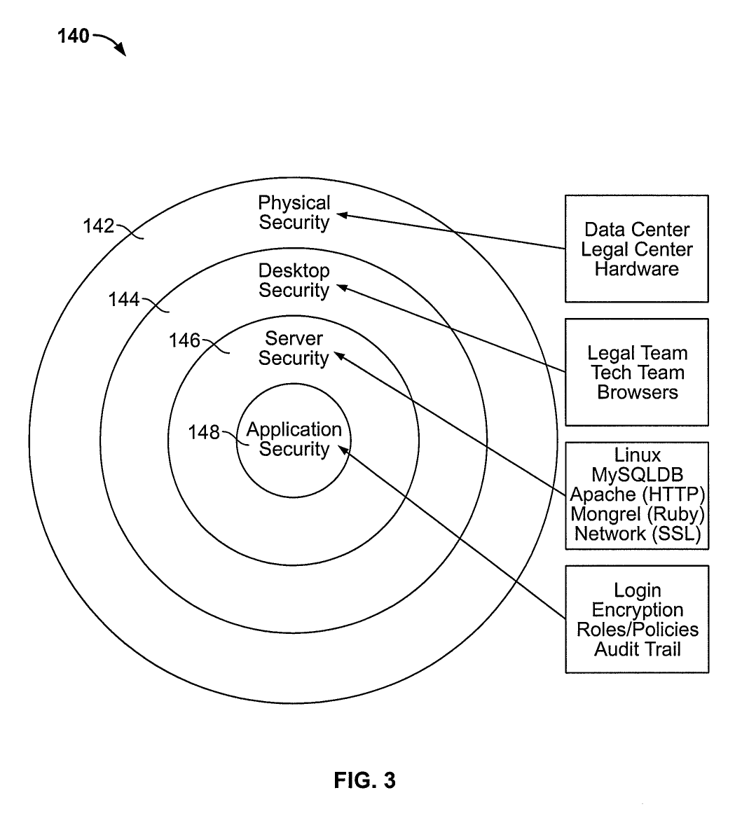

Referring now to FIG. 3, in a hosted environment, the system 100 is designed to host confidential contract information for a plurality of companies. Therefore, the system 100 includes security safeguards to maximize data protection. In the example shown, the system 100 is designed with a security architecture 140 having four layers 142, 144, 146, 148.

The security layer 142 includes the physical security of the various components of the system 100. This involves securing all server equipment in locked-down data centers with limited physical access to administrators. In addition, security of any physical document information is accomplished by limiting entry to facilities housing the documents through various security devices, such as bio-metric devices, closed circuit cameras, and professional security services.

The security layer 144 includes securing communications to and from clients connecting to the servers of the system 100. In example embodiments, the system 100 secures all communication through encryption, such as requiring the use of an Internet browser's SSL encryption capabilities. Other security measures can include: storage of information on the server only (without local machine storage); automated cleaning of client's browser caches on a periodic (e.g., daily) basis; disabling of output devices such as printers, USB ports, CD-ROMs and Floppy Drives; limiting access to other Internet sites; and blocking of various forms of electronic communication such as email, instant messaging, etc.

Security can be further enhanced by providing dedicated servers for each individual company with contract information hosted on the system 100. Each company can have separate servers with dedicated IP addresses that are accessible only through the customer's dedicated URL. The system 100 can also be configured to allow access only from specific subnets or through a VPN, thereby giving an additional layer of security.

The security layers 146 and 148 include securing of the servers 122, 124 and applications running on the servers of the system 100. In the example shown, the servers 122, 124 are programmed to dynamically limit access to any content delivered by the servers 122, 124. All security permissions can be password driven, and roles and security policies can be assigned to individual users or to specific groups of users. Examples of such security include module-level security that allows access to each of the modules 130, 132, 134, 136 to be limited, and role-based security that allows access to be limited based on a user's defined roles. In addition, logins and user actions can be audited.

Security in the system can also be driven by any data in the contract model. For example, the user management module 134 can be programmed to restrict access to a given document based on contract model terms such as ‘Region,’ ‘Product Name,’ and ‘Contract Value,’ so that a user would only have access to North American contracts involving Product A with a value less than $10 million. Example restrictions can include not having access to the contract data, not having access to the original document, or having access only to specific aspects of the given contract. This data driven security is managed through a series of rules, which can be chained to create highly complex roles for access.

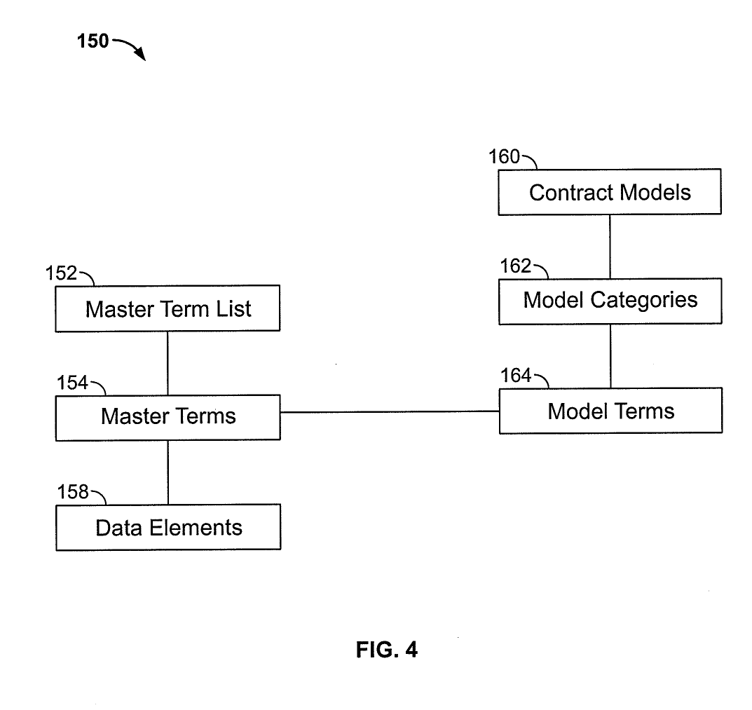

Referring now to FIG. 4, in examples shown herein, an example hierarchical data structure 150 for the system 100 is shown. As noted above, as contracts are generated or entered into the system 100, the contracts are broken into their constituent terms.

For example, the data structure 150 defines a master term list 152. The master term list 152 is a superset of all terms that are included in a company's various contracts, such as licensing agreement, non-disclosure agreements, and vendor contracts. The master term list 152 is used to build master terms 154 that are used to define specific terms in a model for a contract, as described below.

The master terms 154 can be further divided into specific data elements 158, each of which conveys different aspects of the specific master term 154. For example, the “Expiration Date” data element of a “Confidentiality Obligations” term can be set to a specific date (e.g., Oct. 1, 2010) and additionally have a “qualifier” for extra information (e.g., 5 years from date of Disclosure). Each of the data elements 158 can have a set of guideline values based on the company's internal business process.

The master terms 154 are used as model terms 164 when creating a contract model. The model terms 164 are organized into model categories 162 and can be used to build contract models 160 for each desired kind of contract type (e.g., non-disclosure agreement, vendor supplier agreement, etc.). The contract models 160 are, in turn, used to automate the building of contracts using one or more wizards and templates, as described further below.

In example embodiments, the contract models 160 are conceptually separated from the underlying data. This allows for greater flexibility in the analysis of data capture associated with the contracts even though the format of the actual contracts may be different. For example, two contracts can each have a Limitation of Liability clause, but in the first contract it is on page 3 and in the second contract it is on page 17. The contract models 160 are flexible to allow for the capture of the common ‘type’ of information (in this case Limitation of Liability), regardless of the underlying structure of the legal documents. This allows the system 100 to address different formats of contracts and extract common data across large sets of documents.

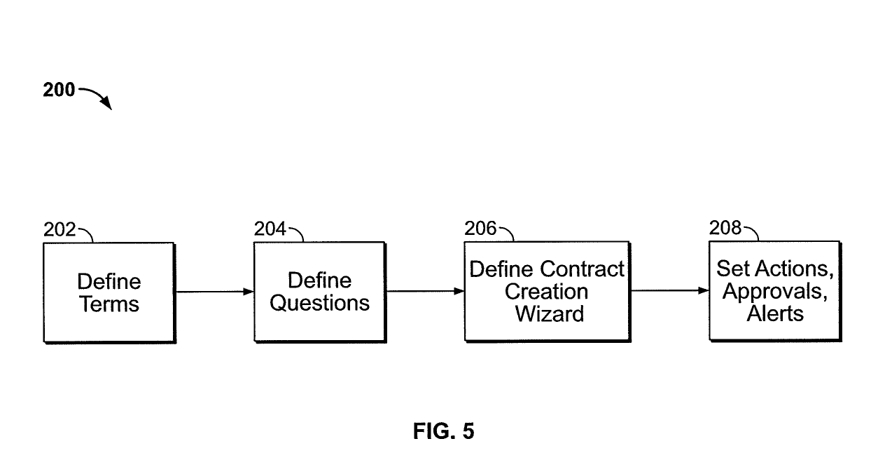

Referring now to FIG. 5, an example method 200 for creating a contract request is shown.

Initially, at operation 202, the terms that are desired for the contract request are defined. For example, terms can be added or modified on the master term list 152, if needed. Next, at operation 204, the questions that are to be included as part of the contract model are defined.

Next, control is passed to operation 206, and the contract wizard is created. The contract wizard defines the steps that are taken to create a contract using the contract model. In example embodiments, the wizard includes two or more steps and prompts the user in a particular order with questions at each step, as defined in operation 204. As described further below, the wizard can implement a series of rules that define which questions are asked based on answers to current or previous questions.

Finally, at operation 208, any desired action, approvals and/or alerts are defined for the contract request. For example, a particular action can simply be a generic action such as “Take Action,” in which a user forwards a contract to one or more people for any reason. The system tracks that: a) an action has occurred; b) when it occurred; c) whether it has been followed up upon; and d) whose desk(s) the action has been sent to. In other instances, an action can be configured to match a workflow such as “Send for Financial Check,” or “Send to Order Department.” In these cases, the actions are mapped to a specific delivery list, and the information provided to the users (either through email or the system 100) is specifically tailored towards the users' needs. The action model is fully configurable for each customer.

As described herein, an approval can define the process by which a non-standard term is approved and/or the general approval for various aspects of the contract. An alert provides automated information based on a trigger, such as an alert that provides a user with a reminder when a contract is about to expire.

In example embodiments, the method 200 can be tailored to each individual company that uses the system 100. For example, the company's existing contracts can be analyzed and employees consulted to develop terms, questions, wizards, approval, and alerting that meet the particular company's needs. Typically, the existing framework of terms, questions, wizards, etc. meet most of the company's needs, and any desired additional functionality is created by leveraging the existing wizards and templates of the system 100 to create custom contracts.

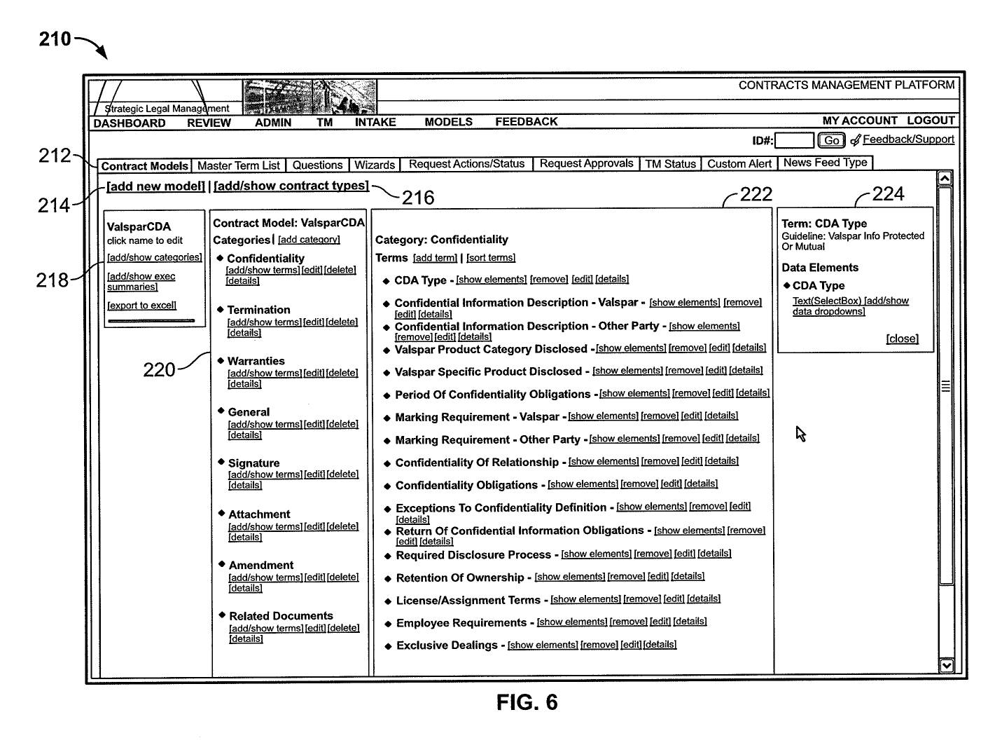

Referring now to FIGS. 6-15, example graphical user interfaces are shown that allow a user to create a contract model and contract request. In some embodiments, the graphical user interfaces are web pages hosted on the server 122 of the system 100. A user can access these pages using an Internet browser.

Referring now to FIG. 6, an example contract model interface 210 is shown. The contract model interface 210 is accessed by selecting the “Contract Models” tab on a toolbar 212. A new model can be initiated by selecting a link 214, and different contract types can be shown by selecting a link 216. The contract model interface 210 also includes sub-modules 218, 220, 222, 224.

The sub-module 218 provides the name of the currently-selected and displayed contract model. The sub-module 218 also allows the user to display categories and executive summaries associated with the contract model.

When the user opts to display the categories by selecting the link in the sub-module 218, the sub-module 220 lists the categories associated with the contract model. The-sub-module 220 allows the user to add categories, as well as to show, edit, delete, and show details for the terms associated with each category. In addition, the user can re-order the categories by dragging and dropping the categories into the desired order.

When the user selects a particular category in the sub-module 220, the sub-module 222 shows the terms associated with the selected category. In the example shown, the sub-module 222 also allows the user to add terms and sort the terms. The user can also show, remove, edit, or show details associated with the terms.

When the user selects a particular term in the sub-module 222, the sub-module 224 shows the elements associated with the selected term. In the example shown, the sub-module 224 also allows the user to add and show data associated with the element. In example embodiments, the data can be listed as part of a drop-down list so that the data is normalized.

If the user selects the link from the sub-module 218 to show the executive summary, the user can similarly define the executive summary associated with the contract model. The executive summary can be tailored to the needs of the particular role type. For example, the executive summary for the administrator role can be tailored to show contract details that differ from the executive summary defined for a user in the marketing role. As noted above, this also allows for enhanced security by defining what information is provided to a user based on the user's role.

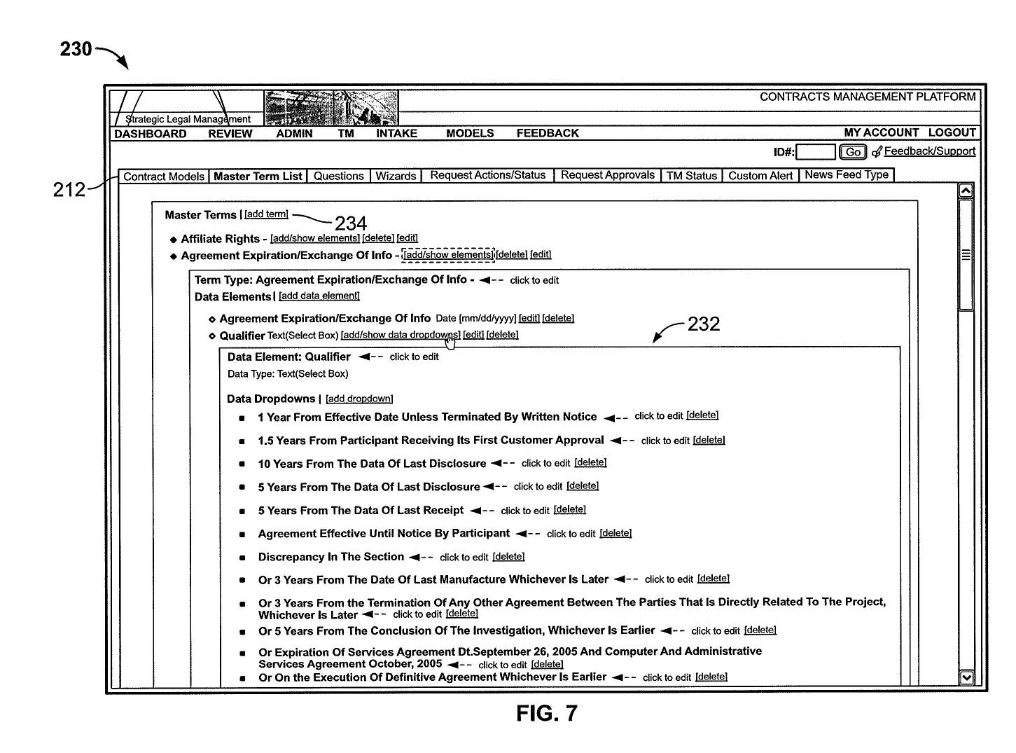

Referring now to FIG. 7, a master term list interface 230 is shown. The master term list 230 is accessed by selecting the “Master Term List” tab from the toolbar 212. The master term list interface 230 includes a list 232 of all of the terms that are available for contract models.

The list 232 is displayed in hierarchical format, and each term listed can include the term name, term type, and data elements associated with the term. These attributes of the term can be modified, if needed.

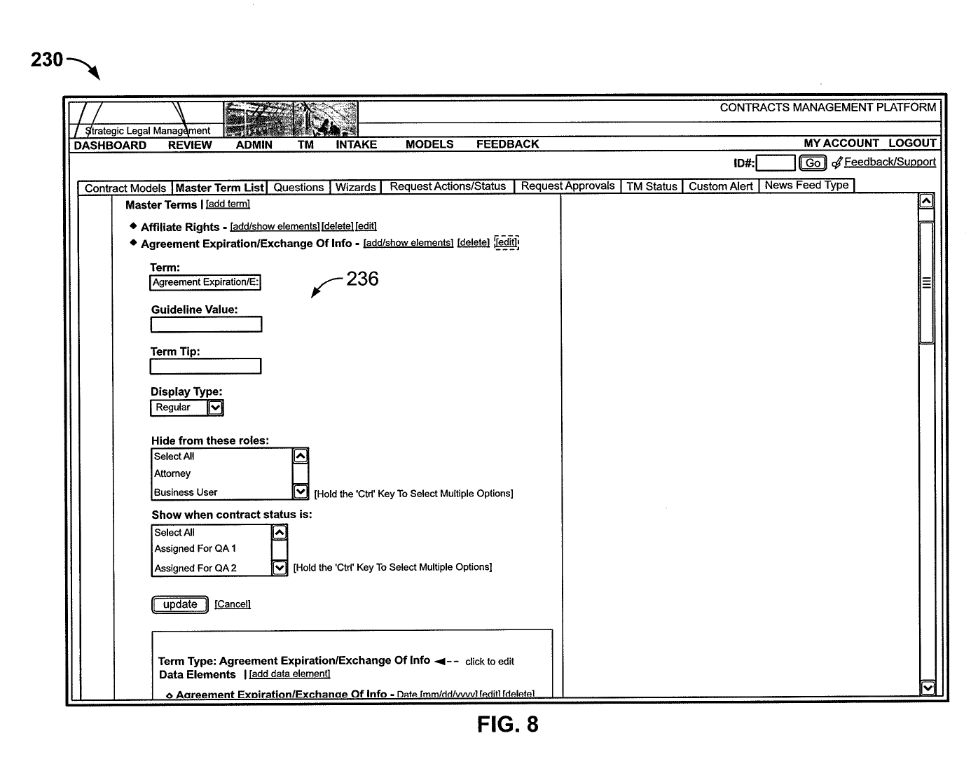

Referring now to FIG. 8, additional terms can be added to the list 232 by selecting the link 234. When selected, a module 236 is displayed that allows the user to define the attributes associated with the new term. In example embodiments, these attributes include the following:
Term—the name associated with the new term;
Guideline Value—defines expected values for the term;
Term Tip—a short description of how the term is defined for the company;
Display Type—defines the manner in which the term is displayed, such as “regular” for a simple term, or other more complex display types like grids, tables, and addresses;
Hide from these roles—defines which user roles, if any, the term will be hidden from (for example, for security purposes); and
Show when contract status is—defines when during the contract creation or review process the term is shown.

The module 236 is also used to define the data elements associated with the term. As noted above, the data elements convey different aspects of the selected term.

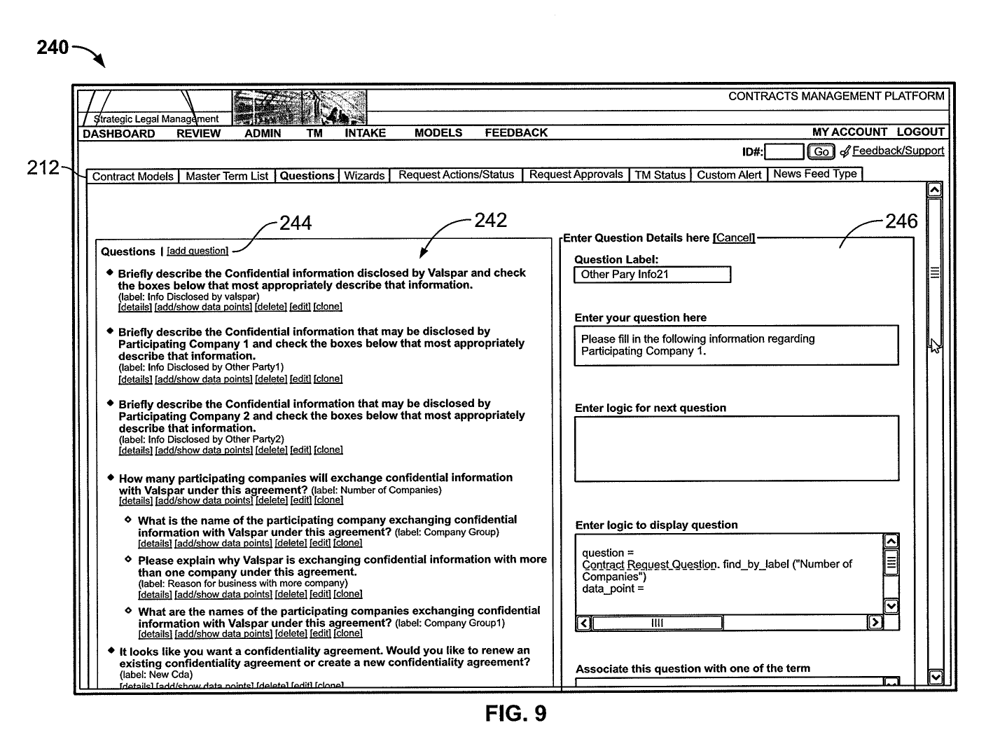

Referring now to FIG. 9, a master questions interface 240 is available when the user selects the “Questions” tab from the toolbar 212. The questions interface 240 includes a list 242 of the questions that are available to be used within wizards. Each of the questions in the list corresponds to a term, and each question can be shown, deleted, edited, or cloned to create a new question. Additional questions can also be created by selecting a link 244.

A module 246 is provided to create a new question. In the example shown, the module 246 includes a plurality of fields that are completed by the user to define the attributes of the new question, including:
Question Label—the shorthand label that identifies the question;
Enter your question here—the text of the question;
Enter logic for next question—logic that determines the sequence of the question based on answers to previous questions;
Enter logic to display question—logic to as to how the question is presented to the user;
Associate this question with one of the term—defines the term to which the question is related;
Display Type—defines the display type, such as “regular” for a simple question, or compound for a question with multiple parts;
Display this question to user?—defines which questions are displayed to the user by role type;
Allow multiple responses to this question?—defines whether a question requires only a single answer or can have multiple answers;
Mark as mandatory question?—defines whether the question must be answered or is optional;
Map this to company group?—allows a question's choices and responses to be pulled from the list of current customers in a database;
Map this to effective date?—allows a response to the question to be mapped to the Effective Date Key Term in the contract model; and
You can enter help text here—defines help text associated with the question.

In example embodiments, the user can also define the choice values for particular questions, including such attributes as the questions to which the value is associated, if the choice is a default choice, and if the choice should be marked as a non-standard choice (e.g., based on corporate guidelines), which questions trigger alerts and require additional approvals.

In addition, the user can also define the configuration for the answers to particular questions, such as the data type (e.g., text box, number, currency, date, Yes/No, file, list, percentage, etc.), format type (e.g., text box, text area, single selection list, multiple selection list, radio button, etc.), size, and logic for the choices that are displayed to the user (e.g., logic to pull choices dynamically from a database). Other configurations are possible.

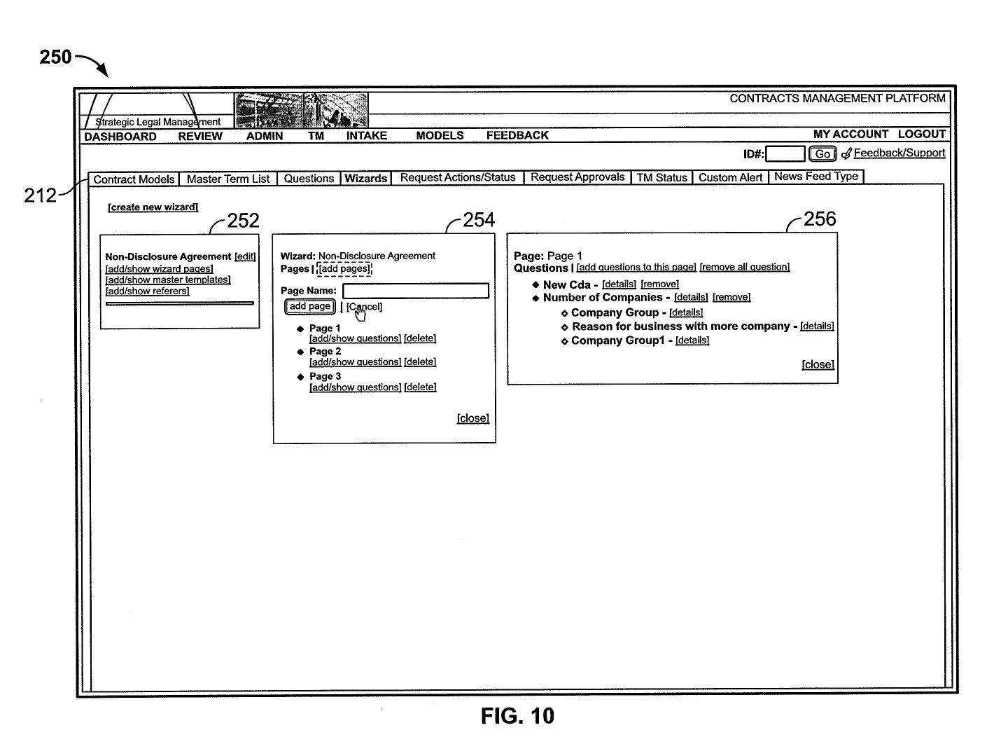

Referring now to FIG. 10, a wizard creation interface 250 is shown when the user selects the “Wizards” tab from the toolbar 212. The wizard creation interface 250 allows the user to define what questions are displayed to the user and the order in which the information is displayed during contract creation.

The wizard interface 250 includes a sub-module 252 that allows the user to add/show the wizard pages, add/show the templates, and add/show the referers pages. Referers pages are intranet links that give users access to a particular wizard or set of wizards. The system looks up the IP address of the referring page (which is known as a referer), and makes sure that it is authorized to access the wizard.

If the user selects the wizard pages, a sub-module 254 is shown that lists the pages associated with the wizard. The user can also add pages, as well as add/show and delete questions on each page. If the user selects a particular page, a sub-module 256 shows the questions associated with the selected page. The user can add and remove questions, as well as remove and show details of the terms and data elements associated with the questions on the selected page.

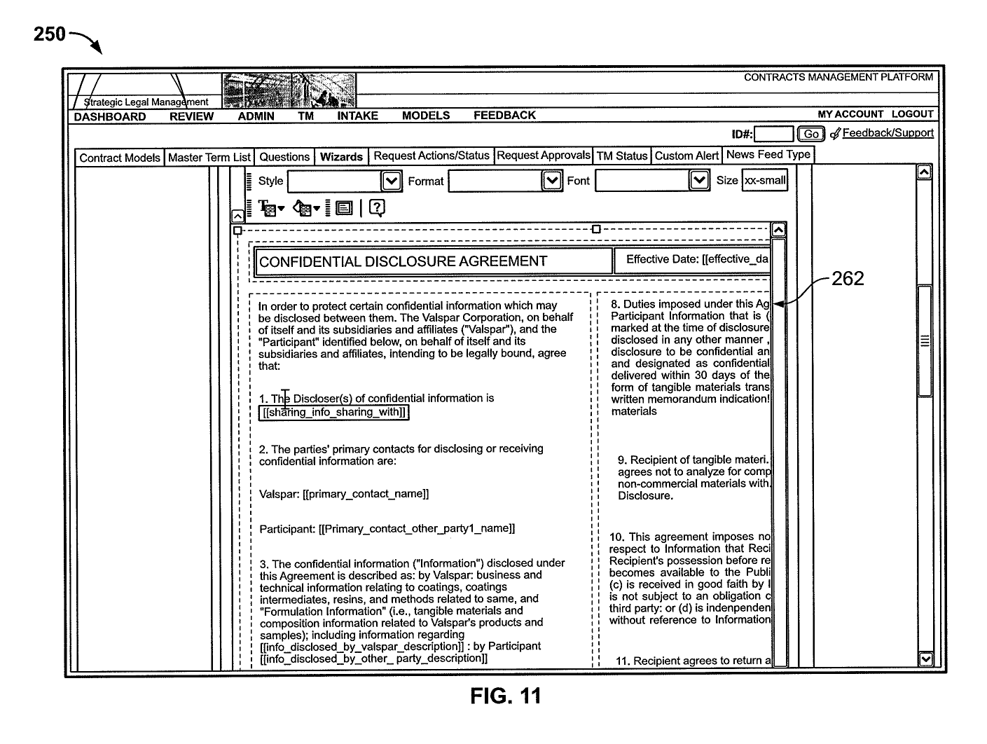

Referring now to FIG. 11, if the user selects the template from sub-module 252, the template 262 for the particular contract is shown. The template 262 includes the text of the contract. In the text, terms fields are referenced in double brackets “[[ ]]”. The terms are auto-populated once the wizard is completed by the end user. The user can edit the text, as well as change formatting and other attributes associated with the template. Advanced logic can also be defined to determine the resulting text of the contract such as, for example, rules that include or exclude whole text portions based on the answers provided by the user. As described further below, the templates can be used to auto-generate a contract once the terms are defined using the contract wizard.

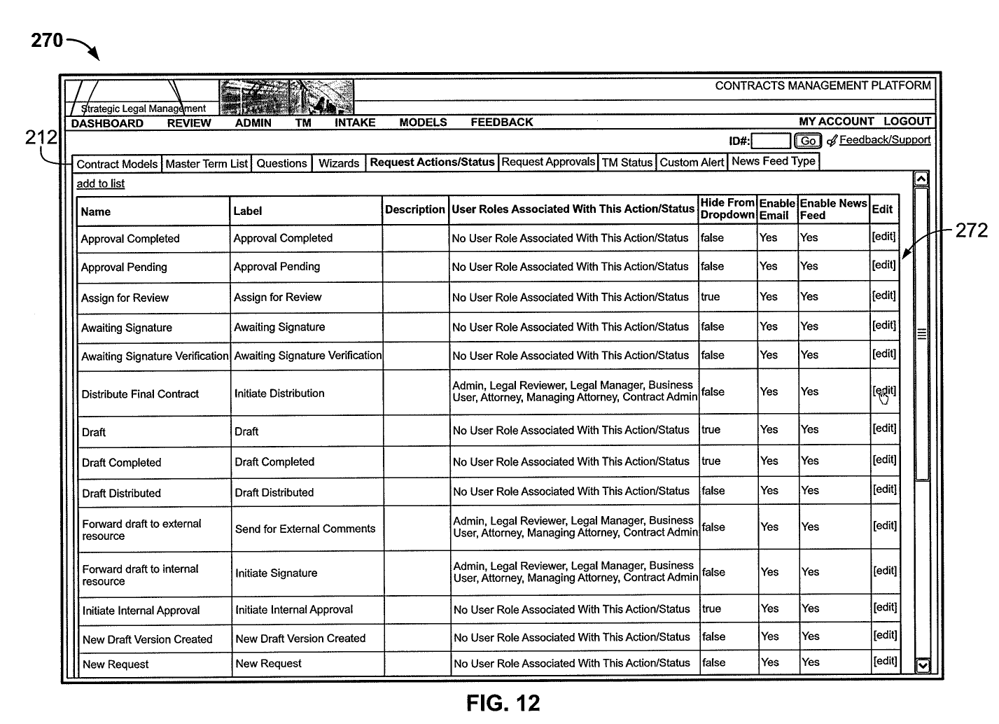

Referring now to FIG. 12, the user can select the “Request Actions/Status” tab from the toolbar 212 to access an action/status creation interface 270. The interface 270 includes a table 272 listing the actions associated with the creation of a contract. Examples of such actions can include approval of non-standard terms, review, signature, and distribution. In the example shown, the table 272 includes a plurality of columns that define attributes related to each action. In addition, the table 272 includes a plurality of rows listing the actions. The user can edit an action by selecting the appropriate edit link for the particular action in the table 272.

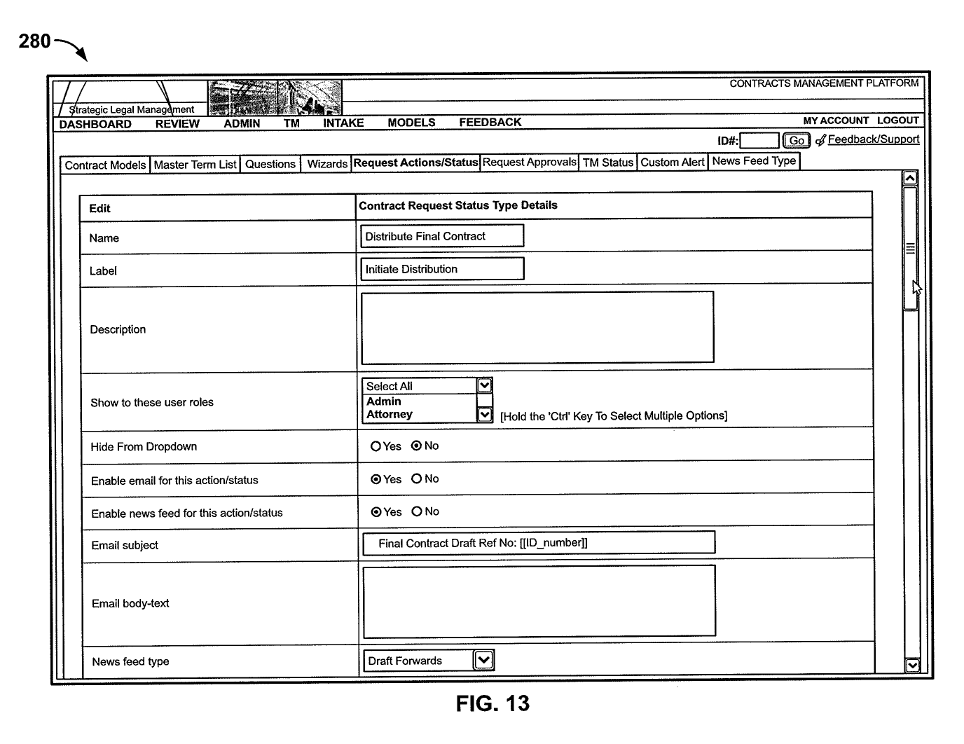

Referring now to FIG. 13, a sub-interface 280 allows the user to define the attributes associated with a particular action from the table 272, including: action name; label; description; user roles associated with the action; hide from dropdown; enable email approvals; enable news feed (i.e.; a feed that is sent to a user and displayed in a news feed area that provides a quick view into the user's workflow processes); and logic associated with the action. Other configurations are possible.

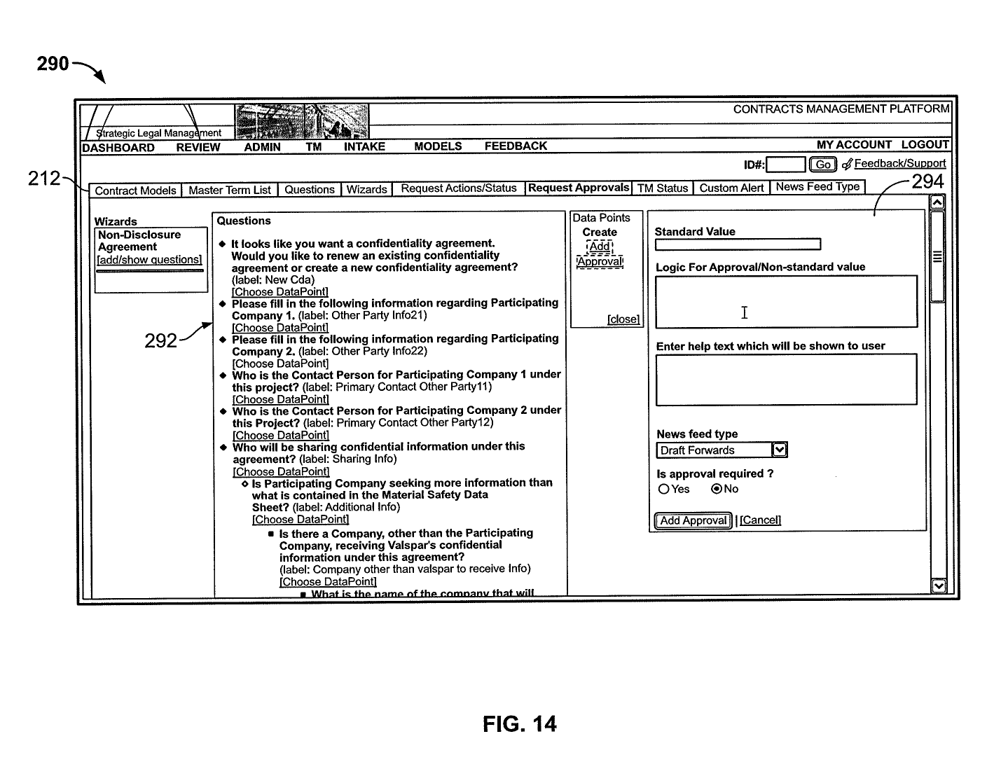

Referring now to FIG. 14, an approval creation interface 290 is shown when the user selects the “Request Approvals” tab from the toolbar 212. The interface 290 allows the user to define approval workflows that are required for non-standard terms. The questions associated with the selected wizard shown in a list 292. The user can select a particular question in the list 292 to add an approval using a module 294. The module 294 allows the user to define the standard value, as well as logic for approval and help text. Other parameters, such as news feed type can be defined to be generated for any action in the system, including a status change or a particular type of action (such as Approval, or New Request).

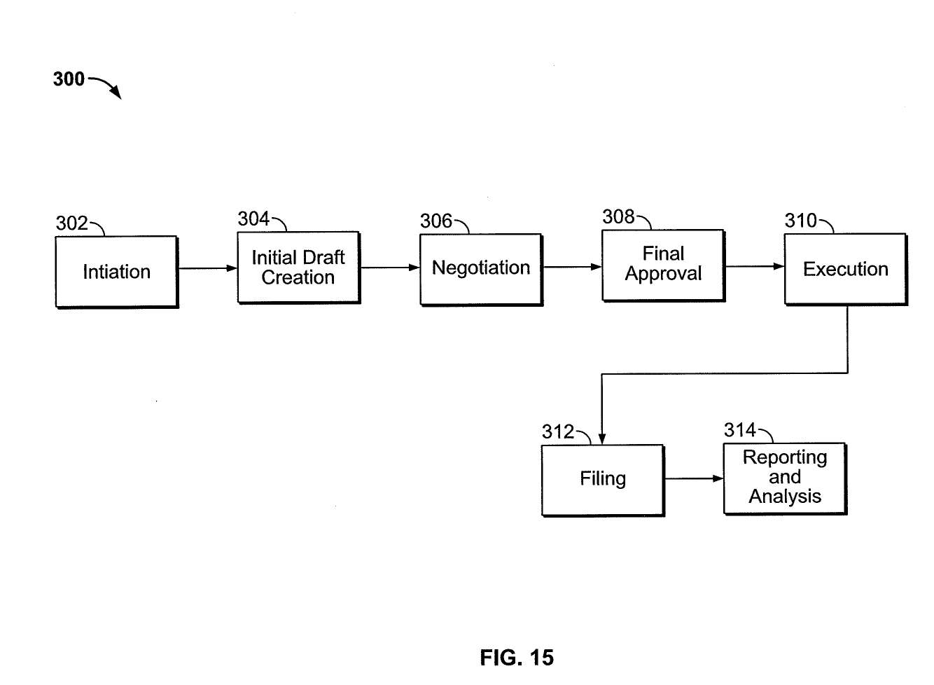

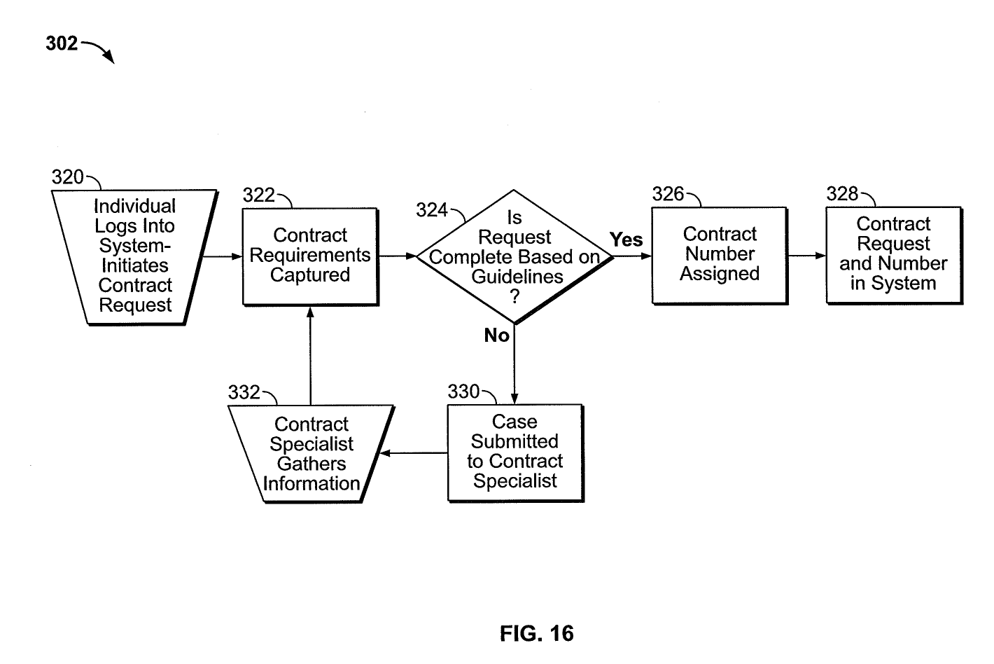

An example method 300 for creating a contract using the system 100 is shown in FIG. 15. FIGS. 16-21 provide further details regarding the method 300.

Referring to FIG. 15, the method 300 initiates at an operation 302, at which the user requests that a new contract be created using the system 100. Next, at operation 304, the initial draft of the contract is created. Control is then passed to operation 306, at which the contract is negotiated with the third party and any revisions to the contract are captured. Next, at operation 308, final approval of the contract is obtained, and the contract is executed at operation 310. Control is then passed to operation 312, at which the contract is filed within the system 100, and reporting and analysis of the contract are performed at operation 314.

Referring now to FIG. 16, the initiation operation 302 is shown in greater detail. Initially, at operation 320, the user logs into the system 100 and requests that a new contract be generated. In the example shown, the user can log into the system using an Internet browser that is directed to a specific URL associated with the system 100. The user typically provides a user name and password, as well as possibly other authentication parameters. In example embodiments, the user can be a legal administrator for the company or a non-legal employee such as sales, marketing, or human resource individuals.

Next, at operation 322, the contract requirement details are captured. In the examples shown, the contract details are captured using one of the wizards stored on the system 100. The user selects a wizard based on the needed contract, and the selected wizard walks the user through a series of questions to obtain the contract requirements.

At operation 324, user responses are validated based on one or more criteria, such as: (i) to determine completeness so that all material terms of the requested contract are defined; (ii) compared to guideline values to determine if a requested term is a non-standard term; and (iii) compared to company-defined guidelines to determine and flag a term if it breaches the guidelines.

If the terms are valid, control is then passed to operation 326 and the contract is assigned a number and forwarded to the legal department for review. If, alternatively, the terms are not valid for one or more of the reasons identified above, control is instead passed to operation 330, and the request is referred to a contract specialist. In example embodiments, the contract specialist can be an individual at the company, an administrator of the system 100, or a third party service provider that then follows up at operation 332 to gather more information regarding the noted terms. Control is then passed back to operation 322.

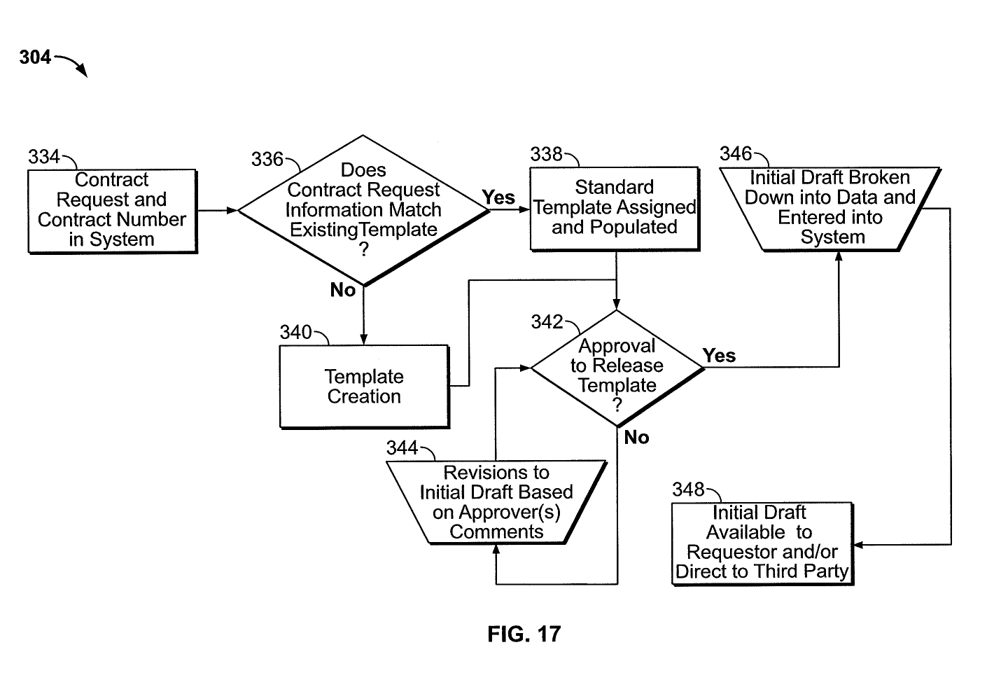

Referring now to FIG. 17, the draft creation operation 304 is shown in greater detail. Initially, at operation 334, the contract request information and number are available in the system 100.

Next, at operation 336, a determination is made as to whether the contract request information matches a template that exists in the system. For example, in some embodiments, each of the wizards is tied to a particular template so that, once the questions in the wizard have been answered, the template can be automatically or manually populated with the answers to create the contract. If a template exists, control is passed to operation 338, and the template is assigned and populated with the data. If a template does not exist, control is instead passed to operation 340, and a template is created using an automated or manual process.

Next, at operation 342, the draft contract undergoes initial review for approval. This approval process can include: (i) verification of terms against guidelines to verify compliance; (ii) change requests and approvals for specific terms by both the requester and legal reviewer (such changes can be shown in the draft contract itself); and (iii) routing and approval processes based on specific terms (e.g., a contract having a value greater than $1 million needs approval by the VP of Sales).

If approval is not received, control is passed to operation 344 and revisions are made based on the comments from the non-approving party. Control is then passed back to operation 342 to again undergo the initial approval process.

If approval is received from the necessary parties, control is passed to operation 346, at which the draft contract is broken down and entered into the system 100. Next, control is passed to operation 348, at which the draft contract is available for review by the requester and/or an appropriate third party.

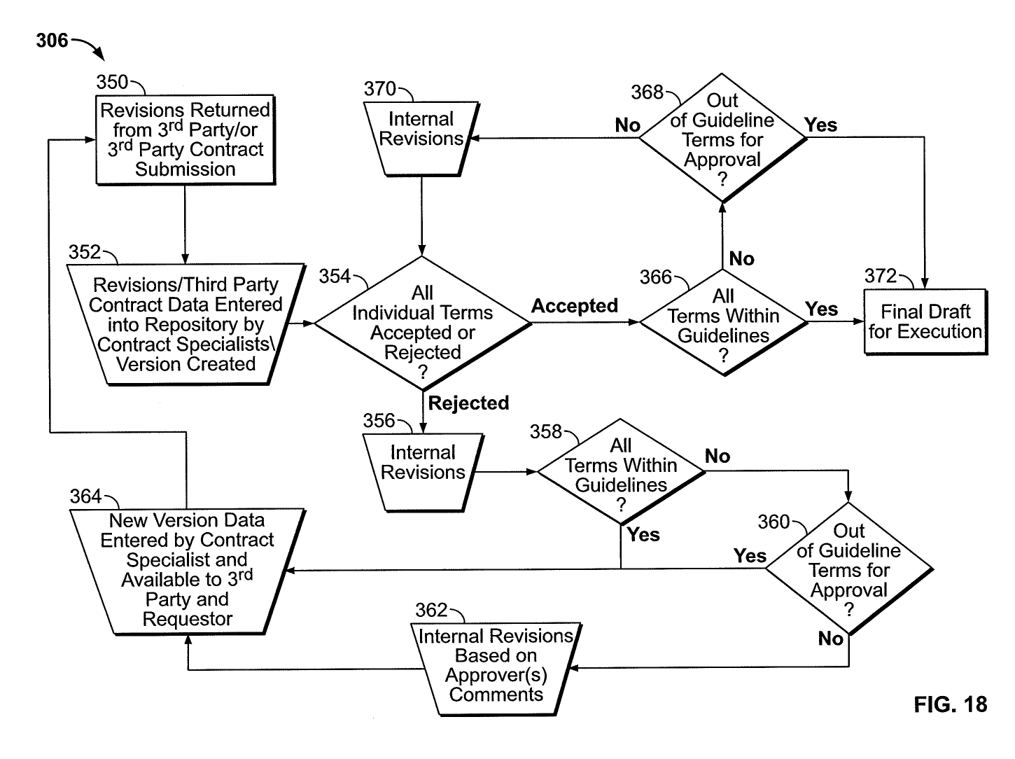

Referring now to FIG. 18, the negotiation operation 306 is shown in greater detail. Initially, at operation 350, the revisions from the third party (i.e., the party with which the company is contracting) are received. Alternatively, the operation 350 can also be implemented if a third party original contract (i.e., a contract generated outside the system 100) is received.

Next, at operation 352, the revisions (or terms of the contract, if third-party originated) are entered into the system. The revisions can be entered in by the customer or by the third party in a process known as ‘synchronization.’ In synchronization, a user interface is given in the system that notifies the third party that a contract has been edited, and data needs to be extracted from it. The revisions are captured and an audit trail created for reporting and workflow. Different versions of the contract are maintained so that a historical record is available. For example, in one embodiment, the third party can be granted limited access to the system 100 to review the draft contract and submit proposed revisions. The revisions are then captured and an audit trail maintained.

Next, at operation 354, approval is sought for all revised terms. Approvers can be notified of revised terms (e.g., by email or other method) and can approve or disapprove the revised terms. If the revised terms are approved, control is passed to operation 366. At operation 366, the revised terms are validated again against the guideline values. If all of the revised terms fall within the guidelines, control is passed to operation 372 for creation of the final draft of the contract for execution.

Alternatively, if any of the revised terms fall outside the guideline values, control is passed from operation 366 to operation 368, whereat approvals are sought for any non-standard terms. If approvals are received, control is passed to operation 372. Alternatively, if the revised terms are not approved, control is passed to operation 370 for internal revisions to the draft, and then control is passed to operation 354.

If a determination is made at operation 354 that one or more of the terms is rejected, control is passed to operation 356 for internal revisions to the contract. Once the revisions are complete, control is passed to operation 358 to determine if all of the revised terms fall within guideline values. If so, control is passed to operation 364, at which a new draft of the contract is created and sent to the third party and/or requester. If, alternatively, the revised terms fall outside guidelines values at operation 358, control is passed to operation 360 for approval of the non-standard terms. If approved, control is passed to operation 364. If not, control is passed to operation 362 for revisions to the non-standard terms per comments from the approver. Control is then passed to operation 364.

An example of the approval process of the operation 306 is as follows. A customer returns a draft and requests a warranty in excess of 12 months, which falls outside the define guideline value for the warranty term. The contracts attorney can then review the term and either accept or reject the proposed change. If accepted, the system notes that the term is out of guidelines, and the proposed change, along with comments by the managing attorney, is sent to a revenue recognition “approver” for review and sign off. This can happen with multiple terms and with multiple layers of approvers. In all cases, the approver will receive access to the system (through email notification or other methods), enter into a specific dashboard, and see the information that is required to make the approval decision. If enabled, they will also be able to see the entire document to understand all of the parameters of the transaction. Comments may be exchanged between the approver and the managing attorney or other individuals throughout this process. These comments are captured by the system.

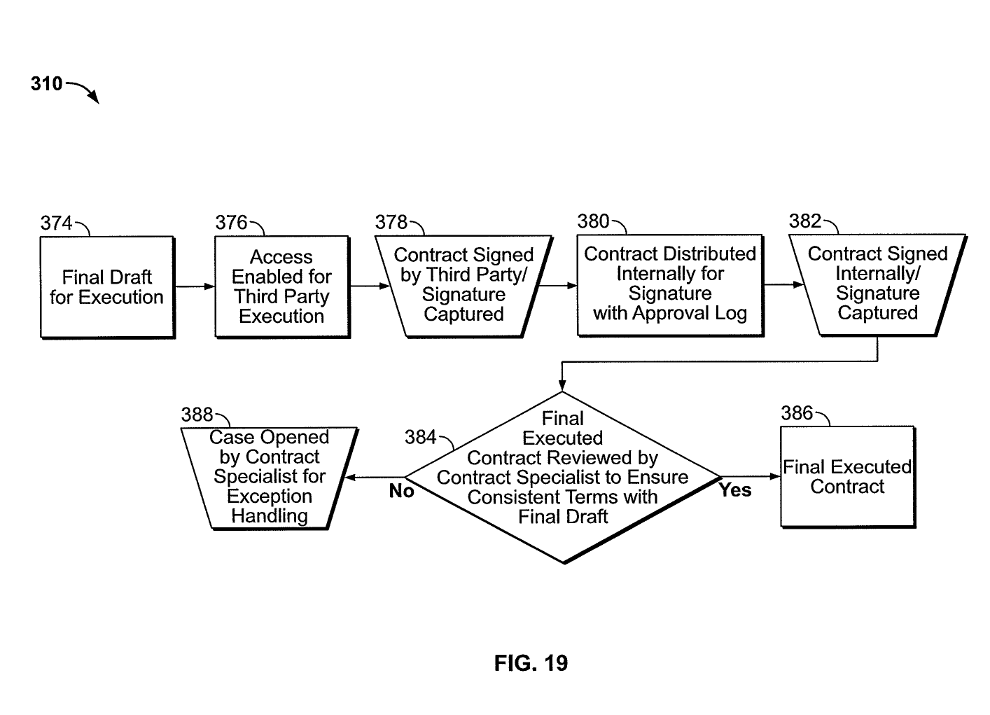

Referring now to FIG. 19, the execution operation 310 is shown in greater detail. Initially, at operation 374, the final draft of the contract is available for execution. Next, at operation 376, the third party is given access to the final draft for execution. This can involve sending a hard or soft copy to the third party, or granting the third party limited access to the system 100 for final review and execution.

Next, at operation 378, the signature of the third party is captured, and the contract is distributed internally for signature at operation 380. The internal signatories can access the final draft for review, as well as an overview of the approval process for the contract. The internal signature is then captured at operation 382.

Next, at operation 384, the executed contract is reviewed to ensure consistency in terms with the final draft. If a determination of consistency is made, control is passed to operation 386, and the executed control is stored on the system. Alternatively, if discrepancies are found, control is passed to operation 388 and an internal investigation is initiated to handle the exceptions.

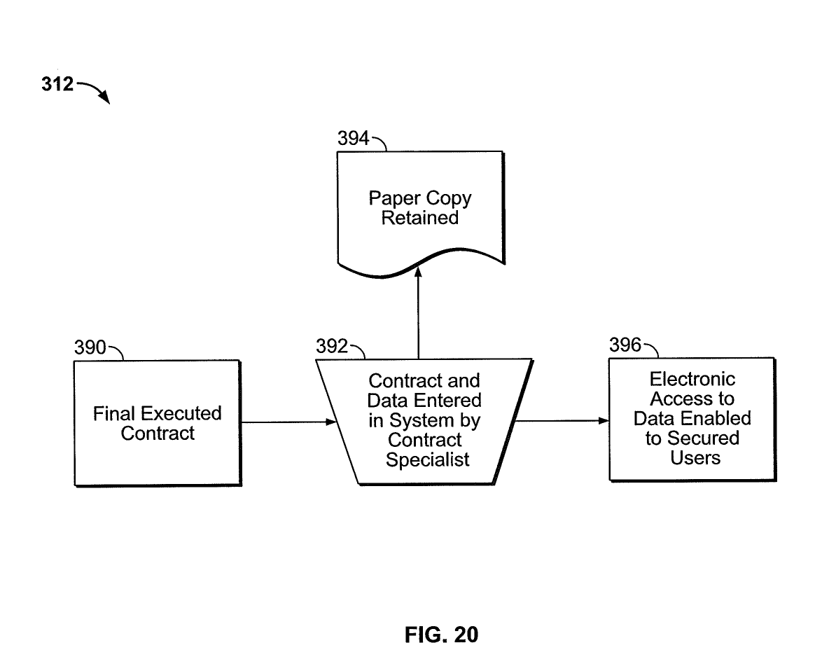

Referring now to FIG. 20, the example filing operation 312 is shown in greater detail. Initially, at operation 390, the finally-executed contract is available on the system 100. Next, at operation 392, the contract is broken down into its terms/data elements and entered into the system. Next, at operation 394, a paper copy of the contract can be created and retained, and electronic access to the contract is granted to the appropriate users at operation 396.

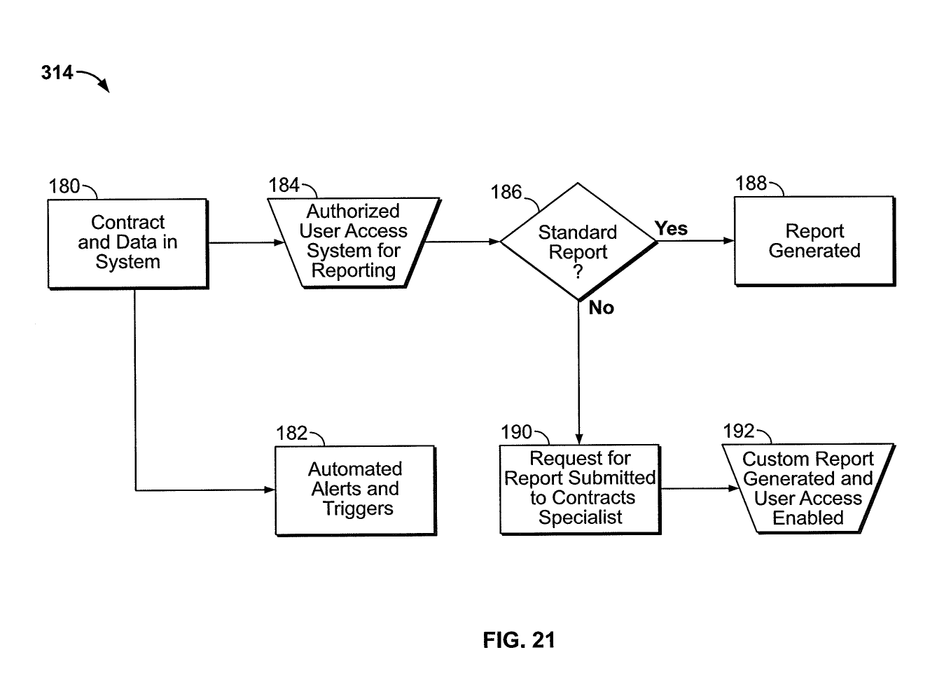

Referring now to FIG. 21, the example reporting and analysis operation 314 is shown. Initially, at operation 180, the contract and terms associated therewith are available in the system 100.

Next, at operation 182, automated alerts and triggers are executed. The triggers and alerts are customizable. For example, triggers can be defined to alert certain users (e.g., by email) when a contract is executed having specific terms. Example triggers/alerts include: advance notice of contract termination; the ability to increase or assess additional charges based on time parameters; expiration of warranties; key milestone dates, etc. At the time of the alert or trigger, the individual receives an email or other communication prompting the user to access the system 100. When the user logs into the system, the alerts can be presented on the dashboard, along with all the appropriate and necessary accompanying information. The date and receipt of the trigger or alert is captured for internal control purposes.

In addition, at operation 184, a user can access the system 100 for reporting purposes. Many of the reports are standardized. Because the contracts are broken down into their individual data elements, a plurality of reports based on any term or combination of terms can be generated. For example, a ‘report’ can be run which merges all of the amendments and changes made to a contract over time between parties into one document, creating a ‘pseudo-contract’ removing the need to undertake the time consuming task of reading through multiple amendments and cross-referencing with master documents. Other examples of standard reports include: contracts by customer; contracts signed by quarter for financial audit purposes; metrics and analytics on the contracts process such as contracts closure rates and terms accepted and rejected by customers on a percentage basis; and a contracts pipeline which can be compared against existing sales pipeline information to ensure consistency and monitor sales.

Once a report is requested at operation 184, control is passed to operation 186, and a determination is made as to whether the user has requested a standard report. If so, control is passed to operation 188, and the requested report is generated for the user. If not, control is instead passed to operation 190, and a request is generated to have the report created. Control is then passed to operation 192, and the custom report is run for the requestor.

In example embodiments, a large percentage of the operations of the method 300 can be automated. For example, the population of the template with data element values to create the draft contract at operation 304 can be automatically completed by the system 100 without user intervention. Alternatively, some of the operations of the method 300 can be performed manually by the user within the system 100. For example, the user can manually create a template on the system 100 and then have the system 100 populate the elements at operation 304. In another example, most approval processes are manual, in that the user is required to manually indicate approval or disapproval within the system 100. However, in some alternatives, the user can define rules that automate some approval. For example, the user can automate approval of non-standard warranty terms as long as the term of the warranty is less than five years. Other configurations are possible.

In example embodiments, non-automated tasks in the system 100 can be handled by the users at the company that owns the contracts. Alternatively, the company can contract for services from a third party to manage the system 100 and/or to provide services to accomplish the manual tasks. For example, the company can contract with a third party to create wizards, templates, and to input existing (i.e., dissect into terms/elements) contracts into the system 100. The third party can provide both technical and legal expertise to accomplish the tasks. By leveraging economies of scale and preferred labor environments, the third party can potentially provide these services more efficiently. Other configurations are possible.

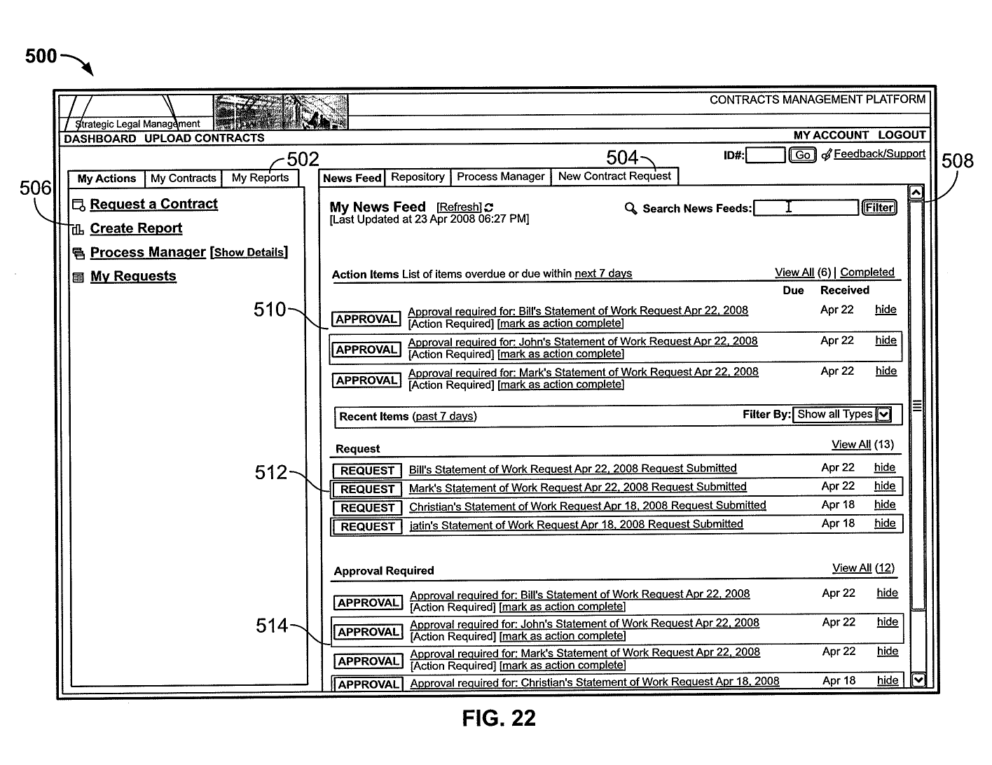

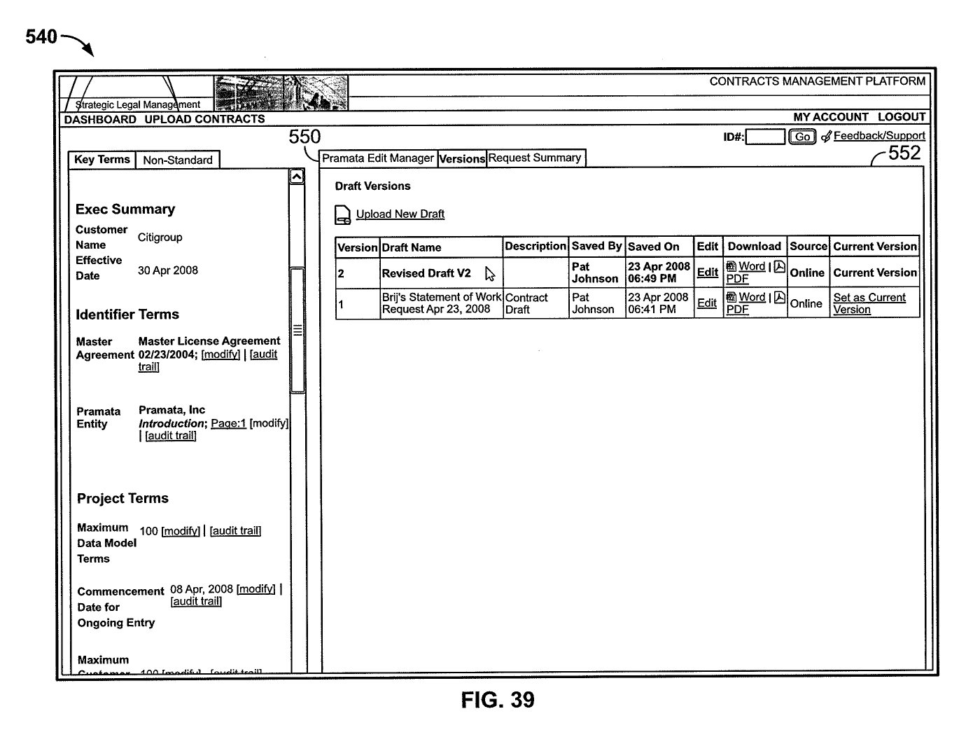

FIGS. 22-54 show example user interfaces generated while using the system 100. In example embodiments, the interfaces are programmed to facilitate contract creation on the system 100, as well as to search for and review contract information within the system 100.

Referring now to FIG. 22, an example dashboard interface 500 is shown. The interface 500 includes toolbars 502, 504, and a personal module 506.

The toolbar 502 allows the user to select among various personalized information modules, such as personal actions, contracts, and reports. Once a module is selected in the toolbar 502, the personal module 506 displays the desired information. As shown, the personal module 506 displays actions available to the user, such as to request a new contract, create a report, and to review the user's requests. If the user selects the contacts attribute from the toolbar 502, links to the contracts the user has selected as being personal contracts are shown. If the user selects the reports attribute, links to the reports the user has selected as personal reports are shown.

The toolbar 504 allows the user to select among various attributes associated with the creation of a contract, such as a news feed, contract repository, process manager, and new contract request. Each of these attributes is described further below.

In the example shown, the news feed attribute is selected on the toolbar 504. When selected, an interface module 508 displays a news feed with various approval items and request items shown for the particular user. In examples shown, the approval items are approval requests that are sent to the user. For example, the user can be requested to approve certain non-standard terms in a contract. The request items are requests the user has created and sent to other users for approval. For example, the request items can include requests for approval of non-standard terms in contracts the user has requested and sent to other users for approval.

The user can search for and filter the approvals and requests shown in the module 508. In addition, in example embodiments, the module 508 can be configured to show approvals/requests for a particular time period (e.g., overdue or next seven days) and can be sorted by due date or received date.

The interface module 508 is broken into several sub-modules 510, 512, 514. The sub-module 510 lists the action items for the user that need approval. Each approval item includes a description of the approval request. The user can click on the description to access more information about the request for approval, such as the underlying information about the contract, as described further below. The action items also include a link that allows the user to mark the actions as complete, as well as the due date and date received for each action item. The user can also select a hide link to hide an action item. The user can also select a link to view all items, as well as a link to view completed items.

The sub-modules 512, 514 similarly list request and approval items that have been generated recently by the user. The request items include a description with a link that allows the user to access additional information about the request. The approval required items show those items for which the user has been recently requested to approve. The user can filter the items shown in the sub-modules 512, 514 by type of request/approval.

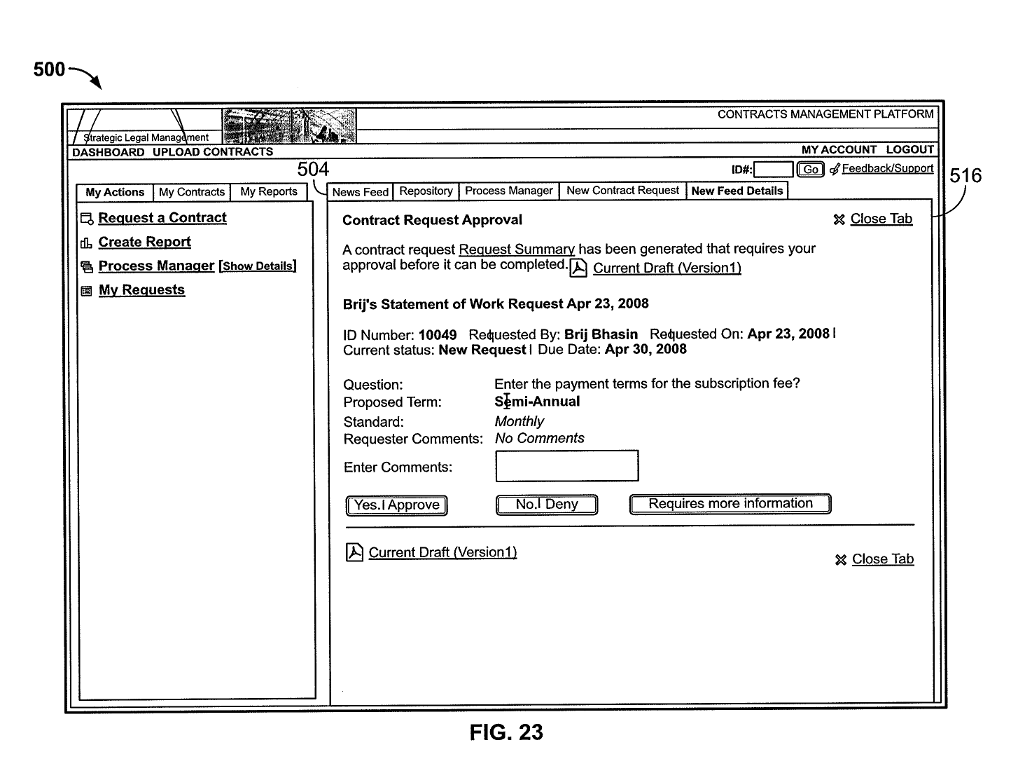

Referring now to FIG. 23, when the user selects one of the items listed in the module 508, additional details about the items are shown in a module 516. As shown, the module 516 includes details about an approval request sent to the user. The module 516 includes the title of the contract, information such as bibliographic information about the request (e.g., requester name, date, status, and due date), and a summary of the questions for which approval is sought. For example, in the embodiment shown, the user is requested to approve the payment terms for the particular contract. The user can select buttons to approve, deny, or request additional information about the request. The user can also enter comments associated with the approval item, if desired. The user can also access a full-text draft of the contract from the module 516, if desired.

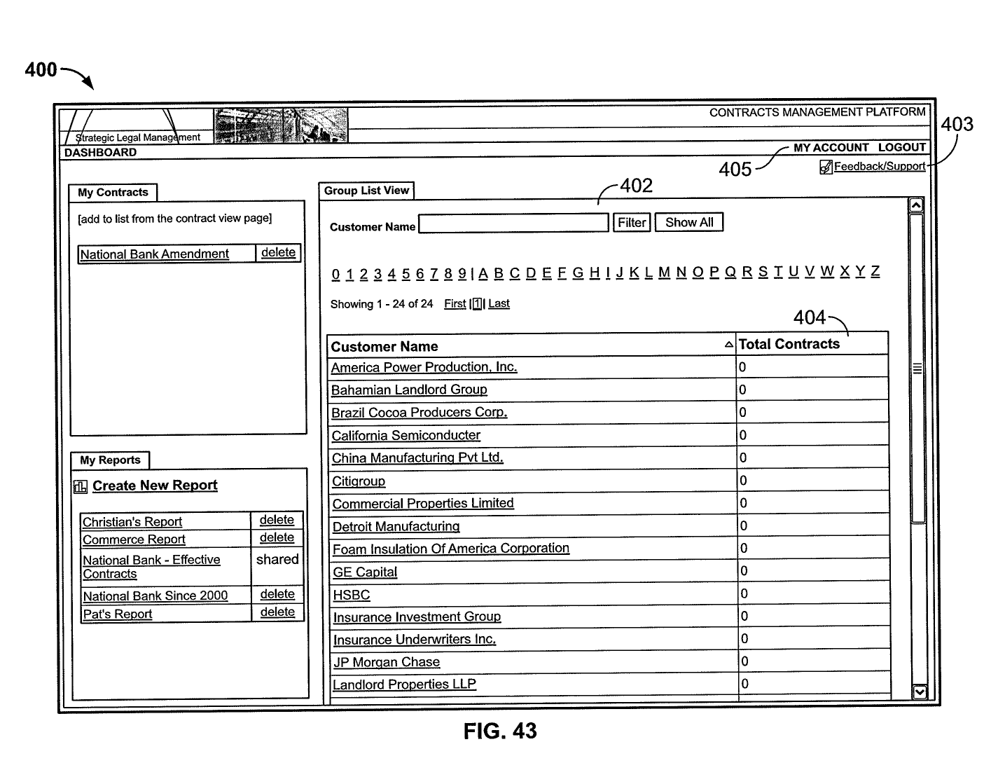

If the user selects the repository attribute from the toolbar 504, the user can access information associated with the contracts stored in the system 100. For example, the user can search for, locate, and review contract information, as described further below in reference to FIGS. 43-54.

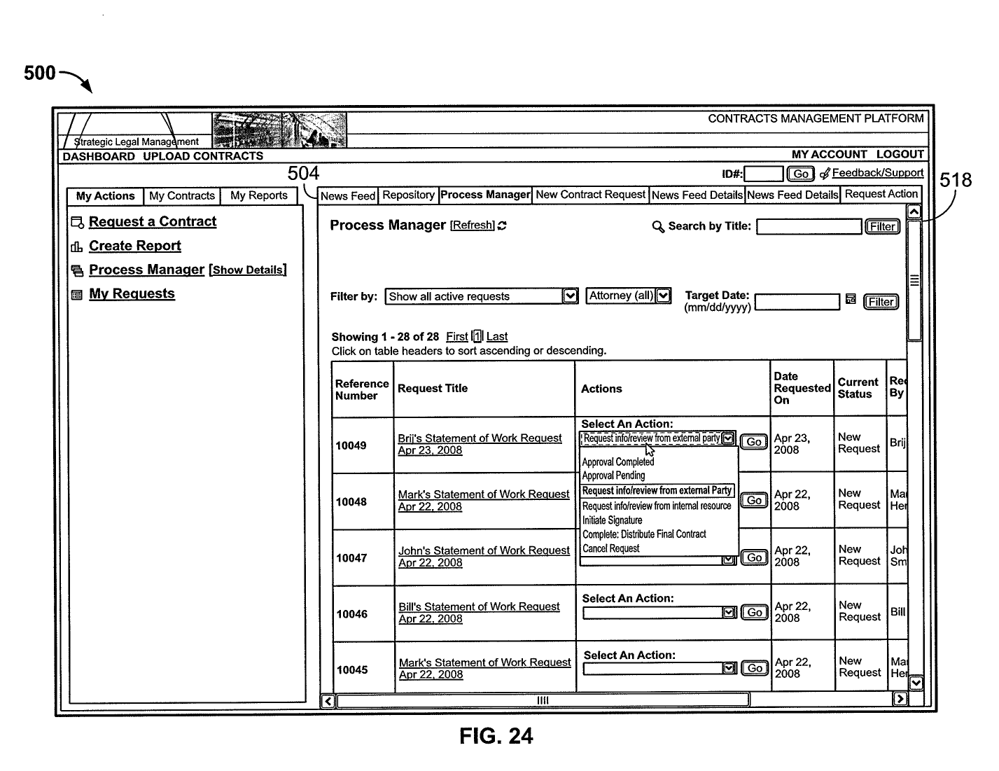

Referring now to FIGS. 24-26, the user selects the process manager attribute from the toolbar 504 to manage requests for action. As shown in FIG. 24, when the user selects the process manager attribute, a module 518 is shown listing specifics about the action items associated with the user. The module 518 allows the user to search for and filter the items shown by, for example, title, status, user, and target date. The module 518 lists each item meeting the search criteria. Information shown about each action item includes reference number, request title, action(s), request date, current status, request creator, and to whom the request was sent. Other information can also be shown.

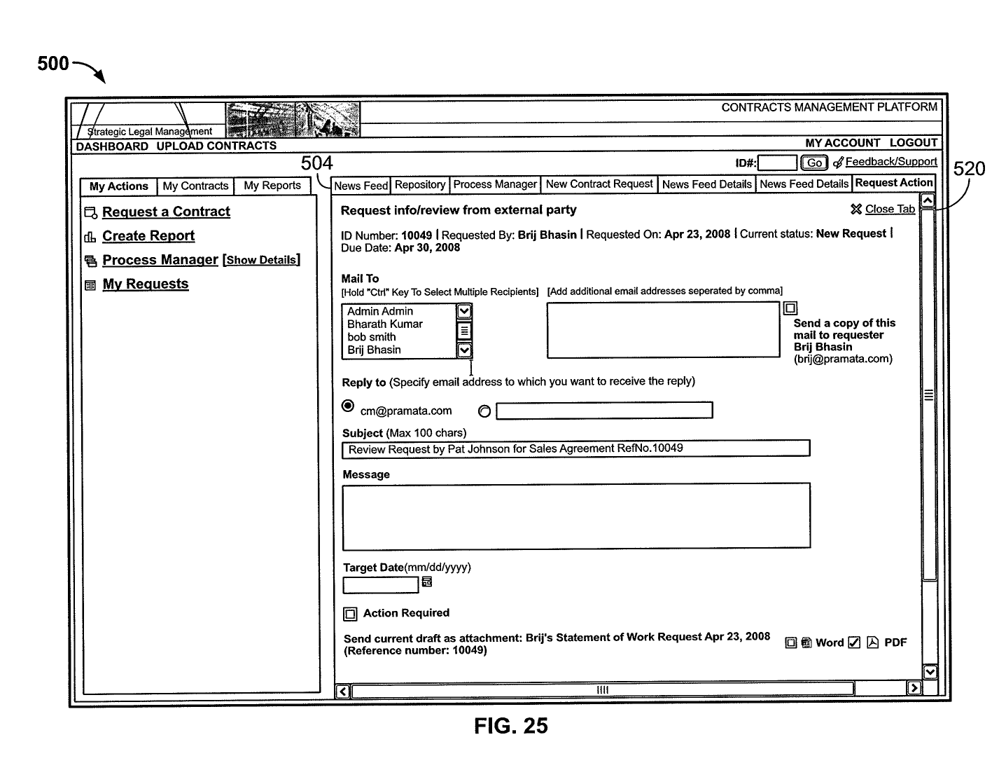

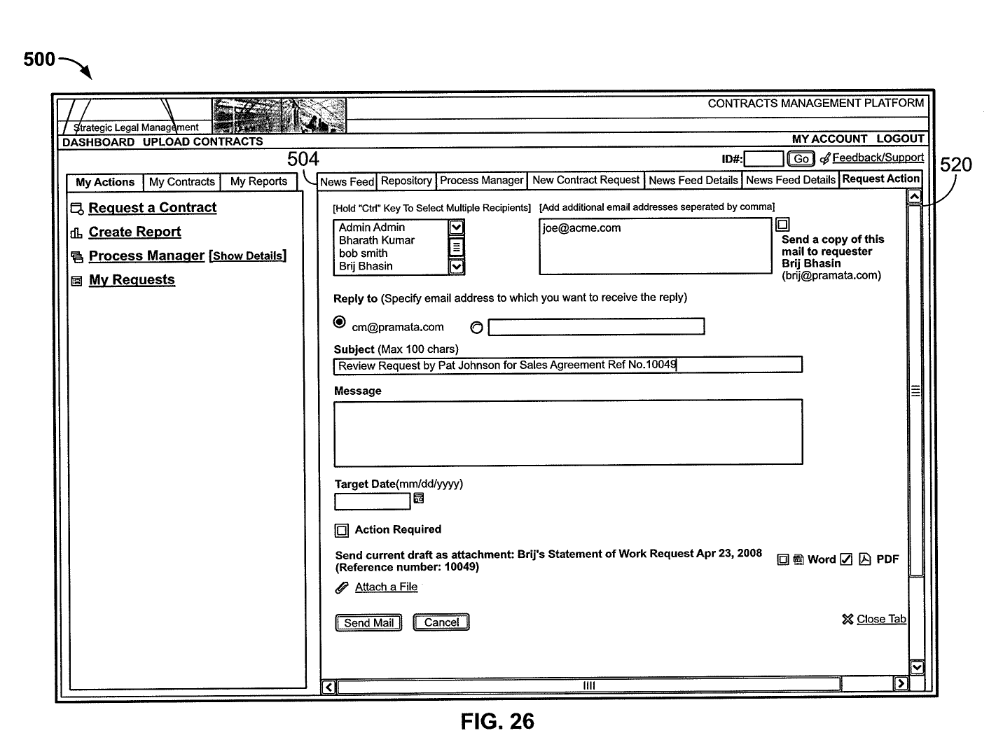

Referring now to FIGS. 25 and 26, if the user selects a particular action, an interface module 520 is shown. The module 520 allows the user to configure attributes associated with the request. In the example shown, the user can define such attributes as: select to whom the request is directed; create a reply-to address; provide a subject and message for the request; define a target date; and attach supporting documents such as a draft copy of the contract. Once complete, the user can select to send the request to the appropriate user(s) for approval.

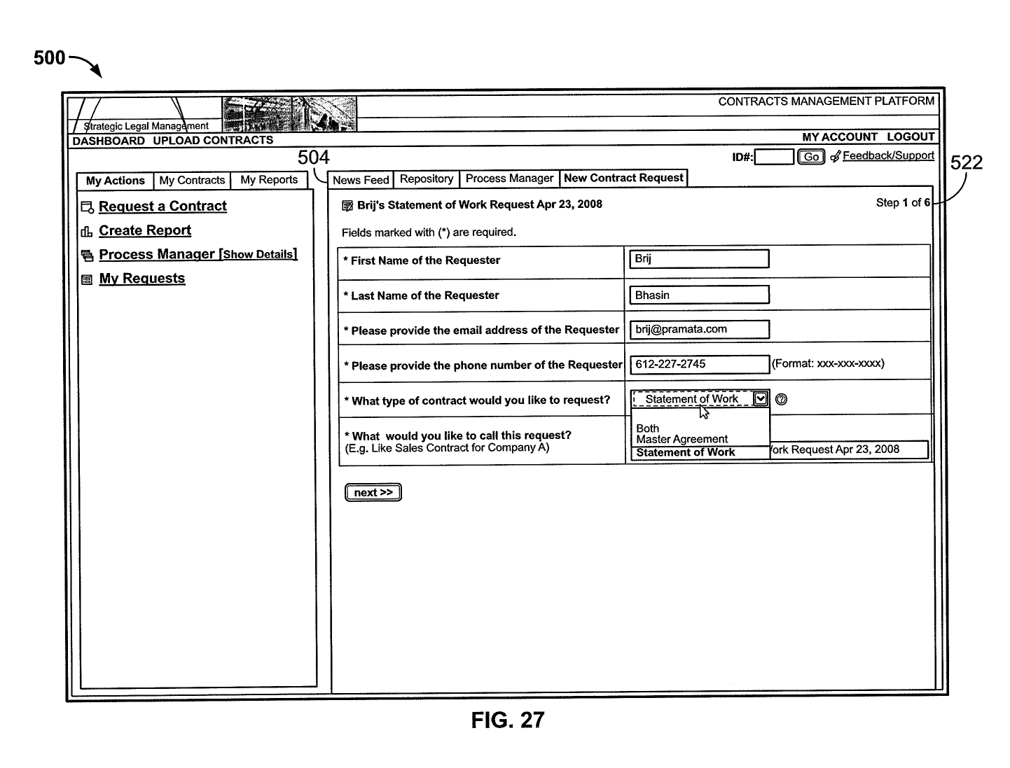

Referring now to FIGS. 27-33, when the user selects the contract request attribute from the toolbar 504, a wizard module 522 is shown that assists the user in requesting the creation of a new contract. In example embodiments, the module 522 poses a series of questions to the user that, when answered, provide sufficient information to generate a draft contract and send the necessary requests for approval to allow the requested contract to be created.

Referring to FIG. 27, the module 522 initially asks the user a series of bibliographic questions. For example, the module 522 asks the user to provide the user's name, email address, and phone number. The module 522 also asks the user to describe the type of contract requested (e.g., master agreement, statement of work, NDA, etc.) and to title the contract request.

In the example shown, the user creates a statement of work for an existing agreement. Based on this selection, the module 522 is programmed to ask the user a series of additional questions particular to the requested contract.

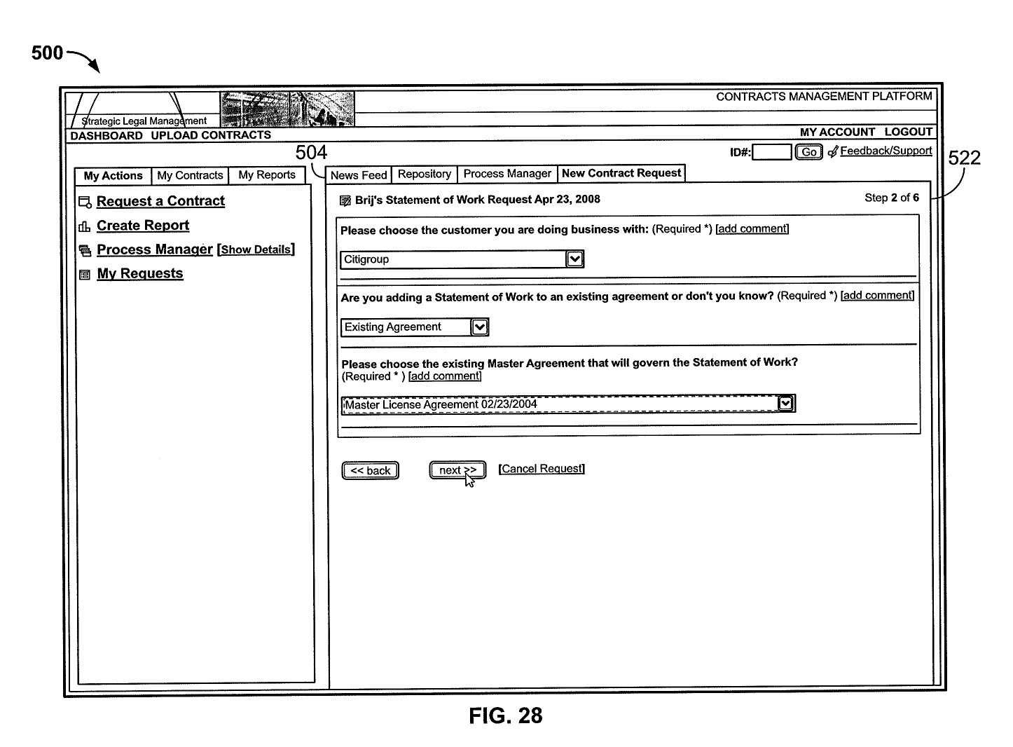

Referring now to FIG. 28, the module 522 asks the user to provide information including the customer for which the contract is directed and the underlying existing agreement (if any). If an existing agreement is selected, the user is asked to choose the existing master agreement.

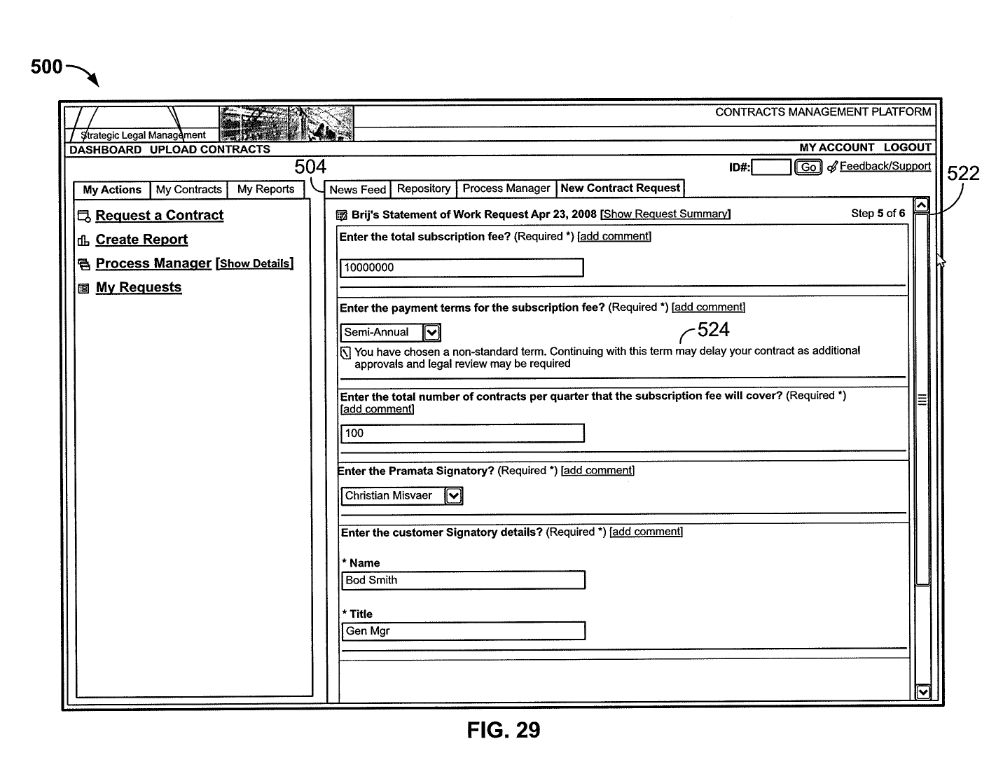

Referring now to FIG. 29, the user is asked specific questions about the statement of work. Each question that must be answered is noted as being required, and the user can add comments to any answer by selecting the corresponding comments link. Examples of the questions include: the subscription fee; payment terms, total number of contracts; and signatories for the contract. If a non-standard term is provided for any question, the wizard indicates the non-standard term. For example, the selection of semi-annual for the payment term is indicated by a notation 524 as being a non-standard term that will require additional approval.

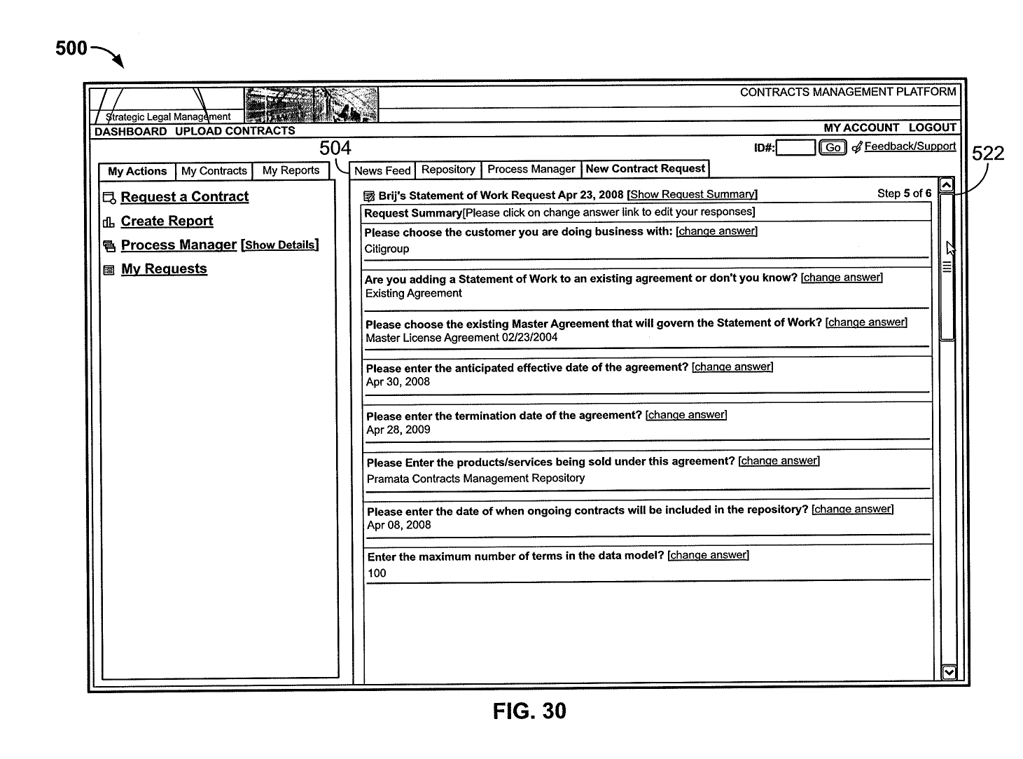

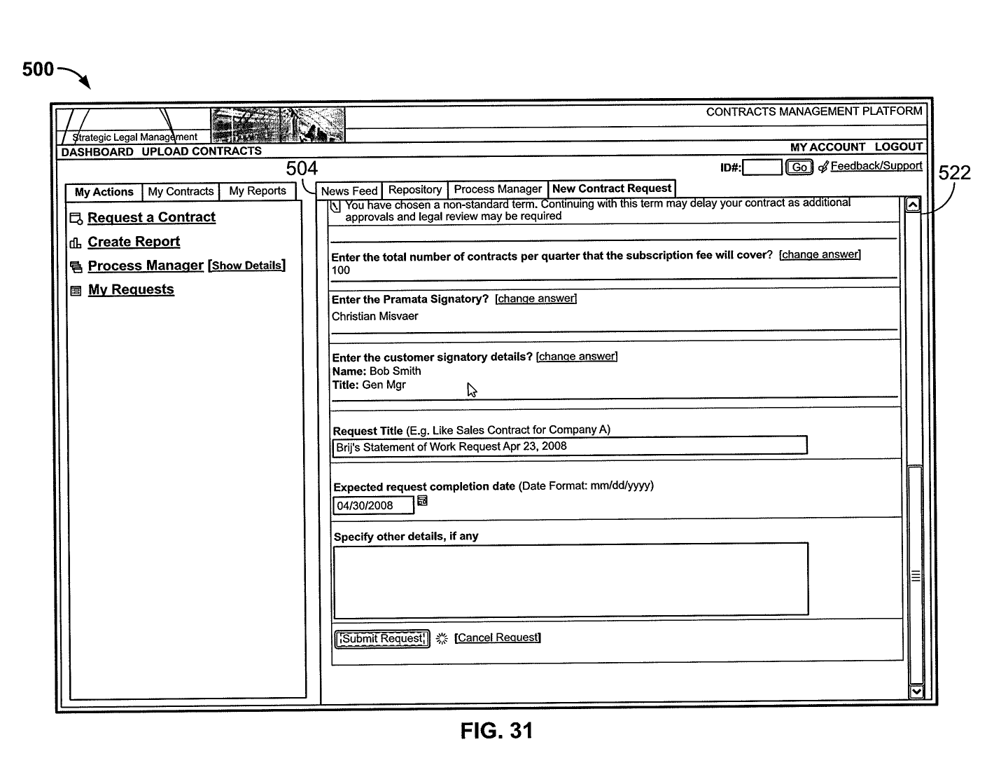

Referring now to FIGS. 30 and 31, once the user has answered the questions, the module 522 presents a summary of the request to the user. The user can select a link to change the user's answer to any of the questions. Once complete with the review, the user selects the submit button to submit the request for the contract.

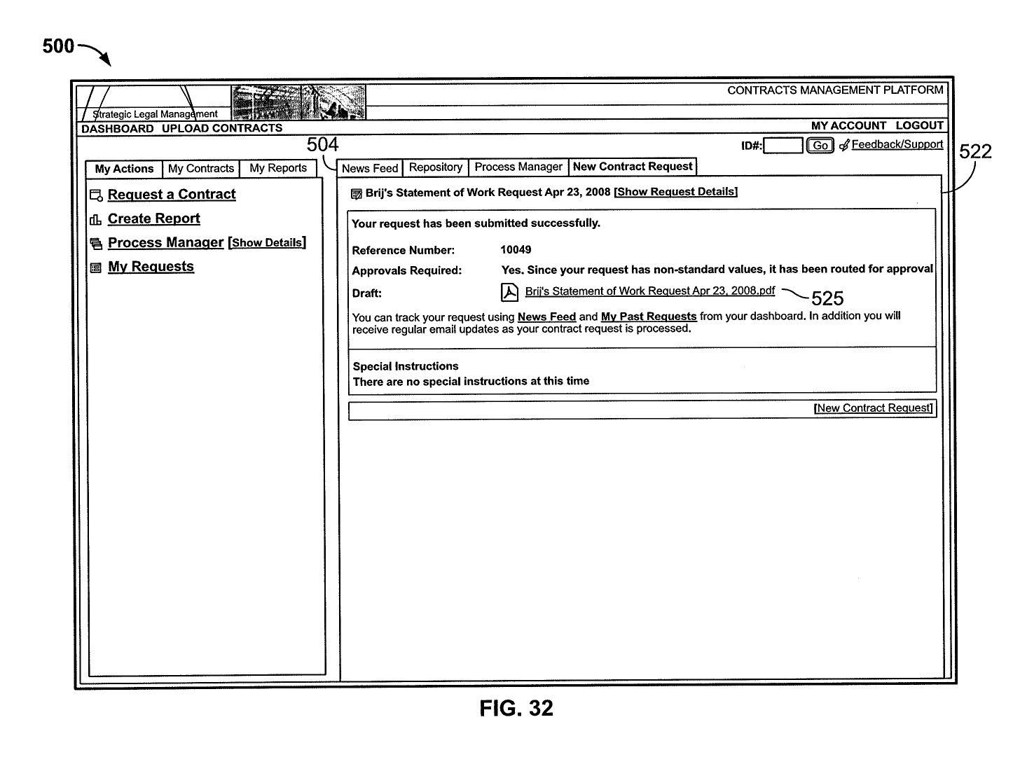

Referring now to FIG. 32, upon submission, the module 522 presents the user with an indication of successful submission and a summary of the request. The summary can include information such as the reference number, any approvals required, and a link 525 to the full-text of the draft contract. Other links to the newsfeed and past requests are provided to allow the user to track the requests.

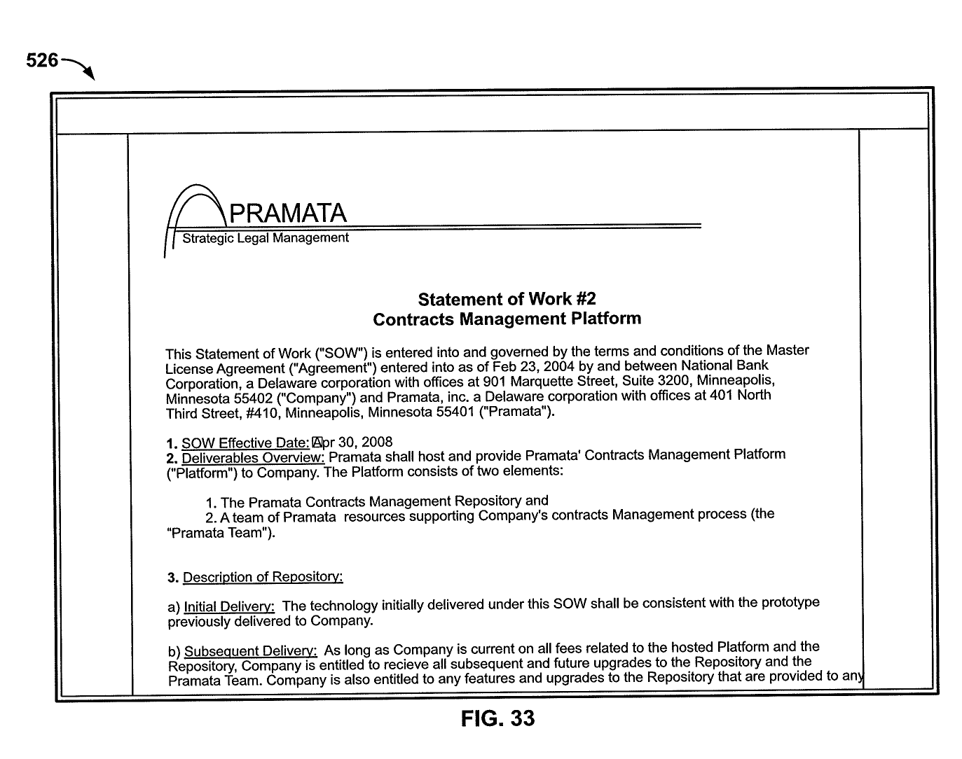

Referring now to FIG. 33, if the user selects the link 525 to show the full text of the contract, a module 526 is generated showing the full text of the draft contract. In example embodiments, the terms of the contract that are populated by the wizard module 522 can be highlighted in the draft (e.g., by color and/or underlining) for easy recognition. In addition, in the example shown, the user can modify these terms in the full text view, and the modifications are stored by the system 100.

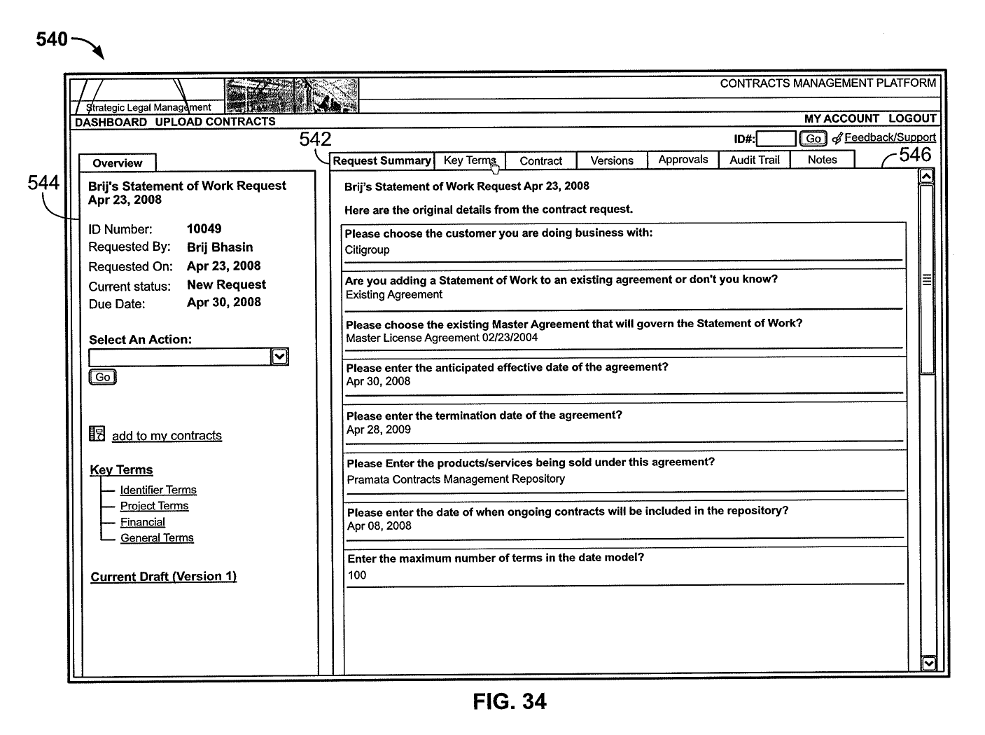

Referring now to FIGS. 34-42, once a request for a contract is made, the users of the system 100 can access an example interface 540 that includes information associated with the request. The interface 540 includes a toolbar 542 listing attributes associated with the request, such as a request summary, key terms, full text of the draft contract, versions, approvals, audit trail, and notes.

Also, the interface 540 includes a summary module 544 that lists bibliographic information about the request, such as the user who made the request, request date, current status, and due date. The module 544 also includes a drop down box to select an action item associated with the request, as well as links to key terms of the request and a full-text version of the draft contract. A link is also provided to allow the user to add the contract to the user's personal list of contracts.

Referring now to FIG. 34, if the user selects the request summary attribute from the toolbar 542, a summary of the request is shown in a summary module 546. The summary can list the specific terms of the contract as provided by the original requester of the contract.

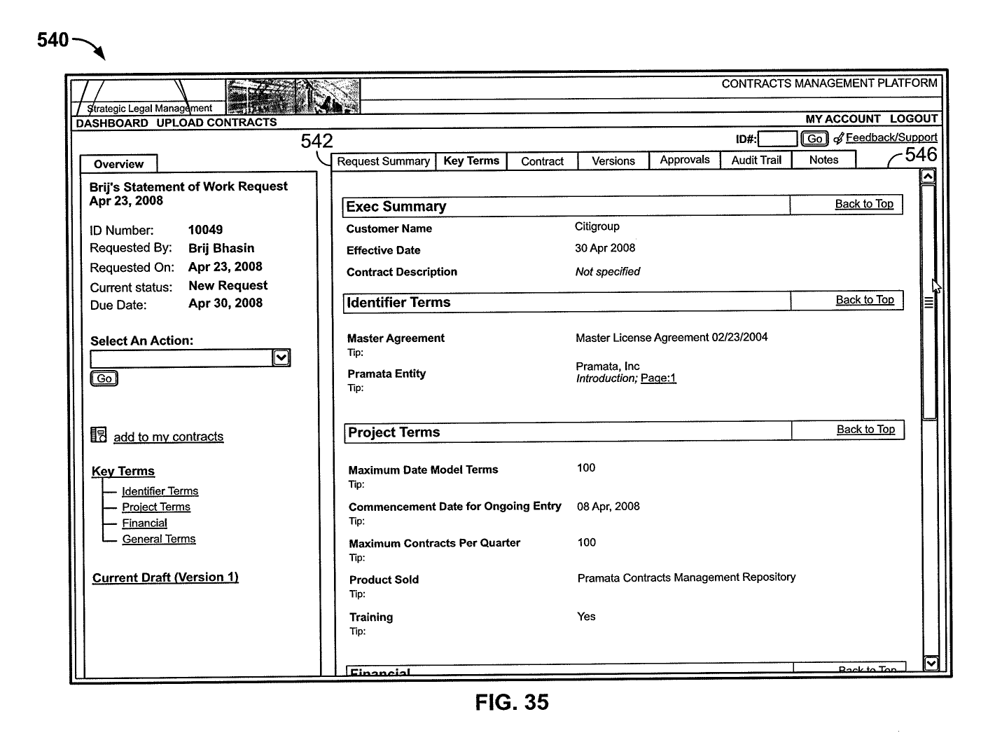

Referring now to FIG. 35, if the user selects the key terms attribute from the toolbar 542, the key terms associated with the contract request are shown in the module 546. The key terms are organized into sections and can be displayed differently depending on the user's role, as described herein.

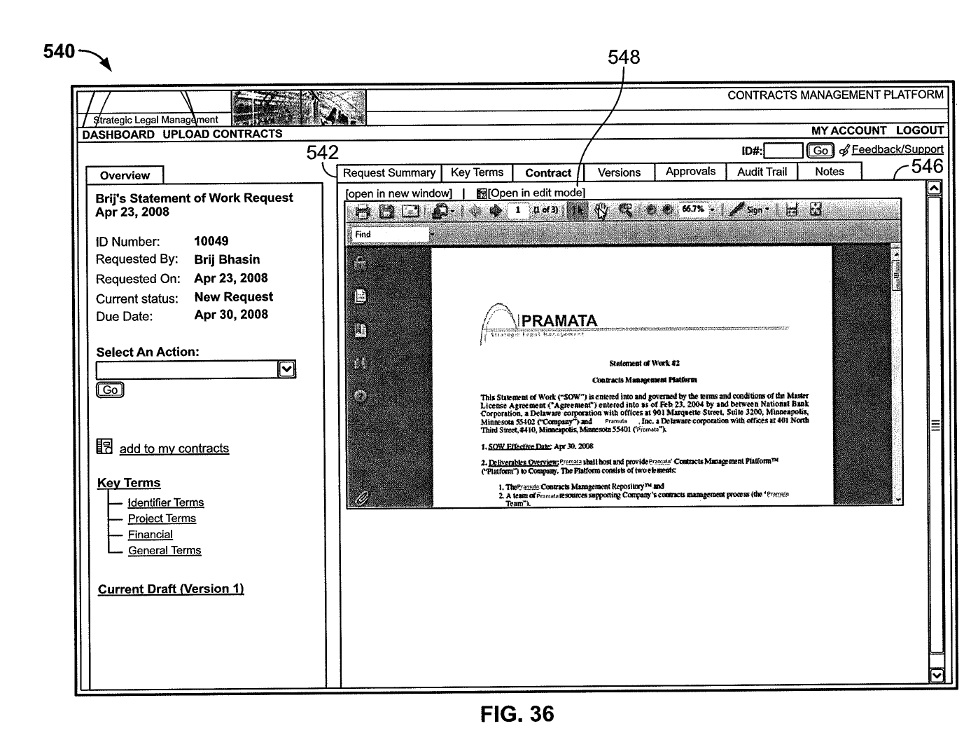

Referring now to FIG. 36, if the user selects the contract attribute from the toolbar 542, a full-text version of the contract is shown. In example embodiments, the contract can be shown in various formats, such as PDF or Word. The user can edit the full-text of the draft contract by selecting a link 548

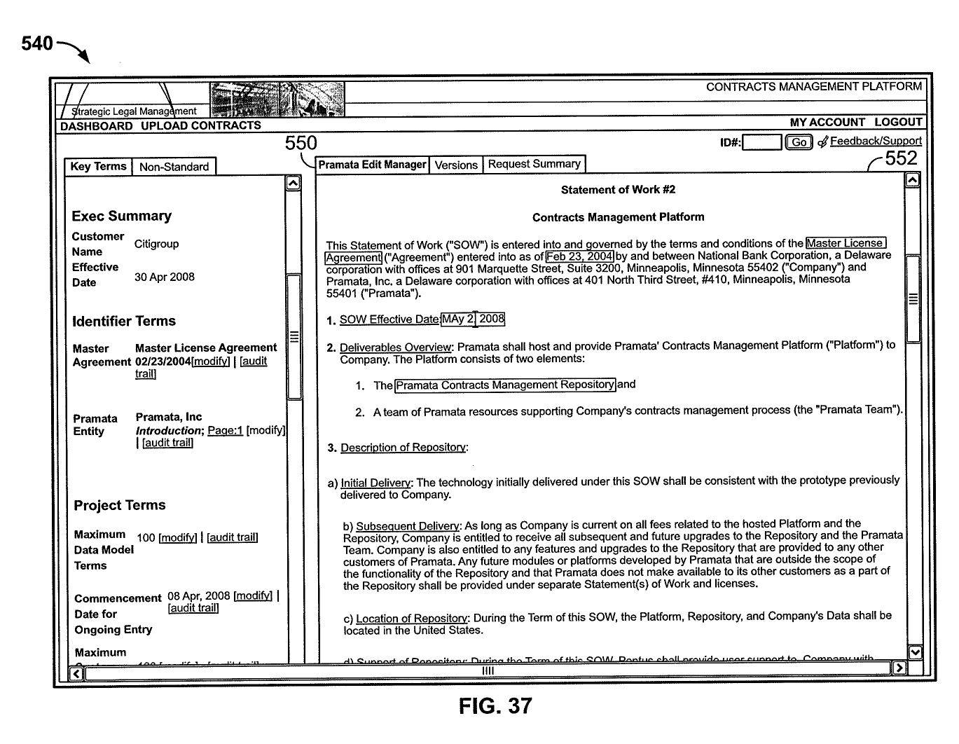

Referring now to FIGS. 37-39, an editor module 552 is provided when the user selects to edit the full text of the draft contract. The terms of the draft contract are highlighted for easy recognition, and the user can edit the terms as desired.

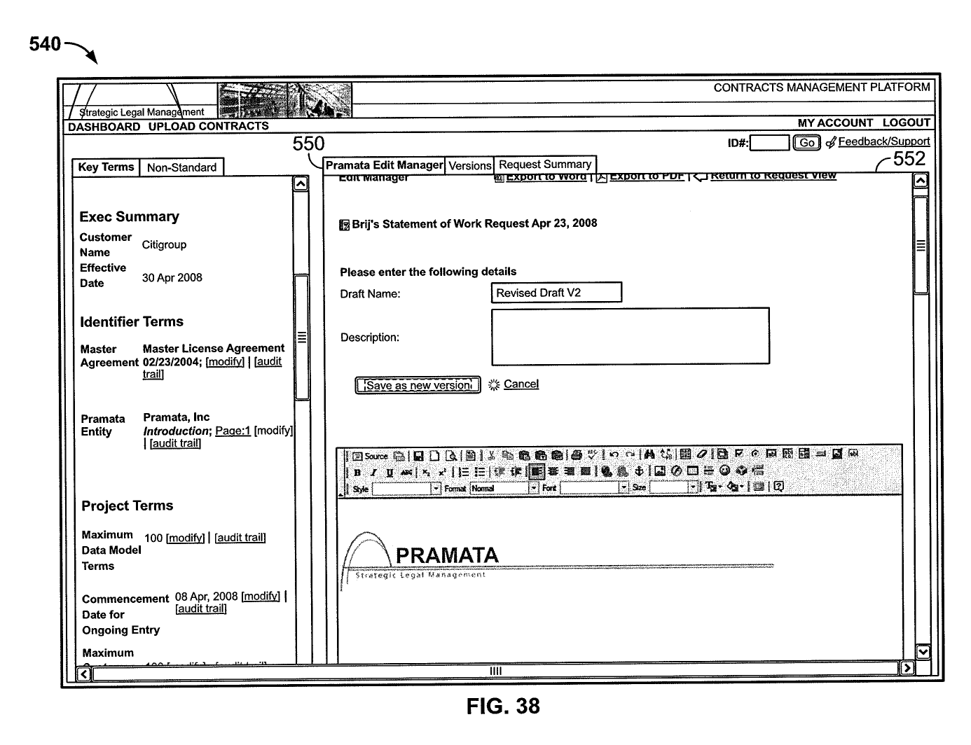

As shown in FIG. 38, the user provides a name for the new draft, as well as a description of the revised draft, if desired. The user selects the save button to save the new version of the draft contract. The user can select a versions attribute in a toolbar 550 to access a list of the various versions of the draft contract. Various information associated with each version can be provided, such as: draft name, description, user who created the draft; and date saved. Links are also provided to allow the user to access and edit the full text of the version.

Once editing is completed, the user selects the request summary tab from toolbar 550 to again access the summary module 546.

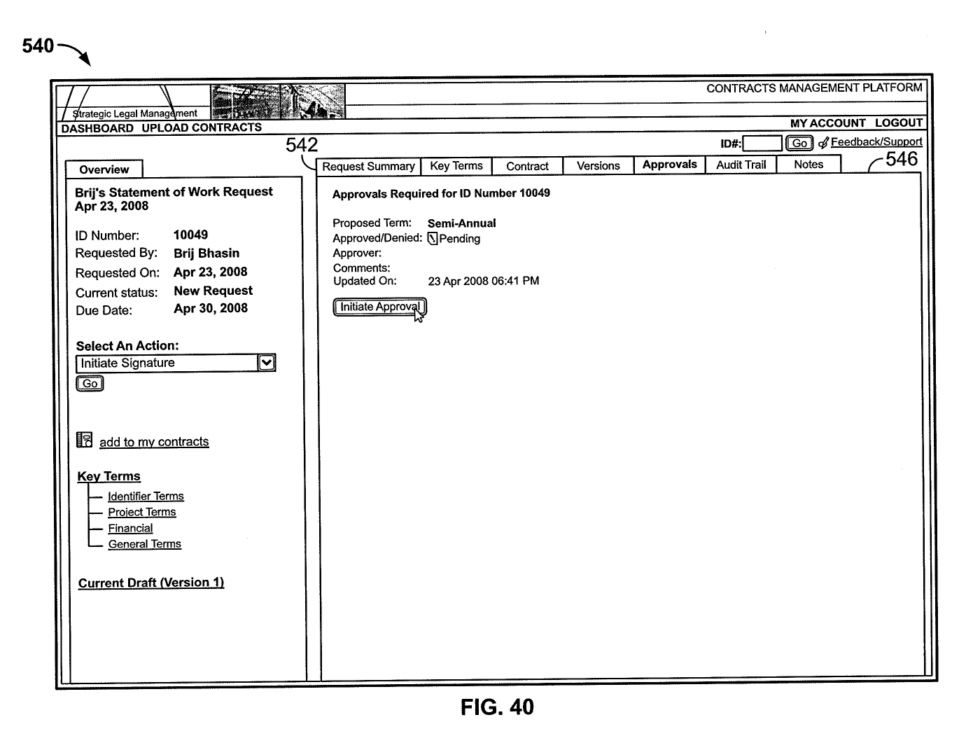

Referring now to FIG. 40, if the user selects the approvals attribute of the toolbar 542, the module 546 shows the approvals that are pending for the contract request. The user can select an initiate approval button to access the module 516 to approve or deny a request, as described above. See FIG. 23.

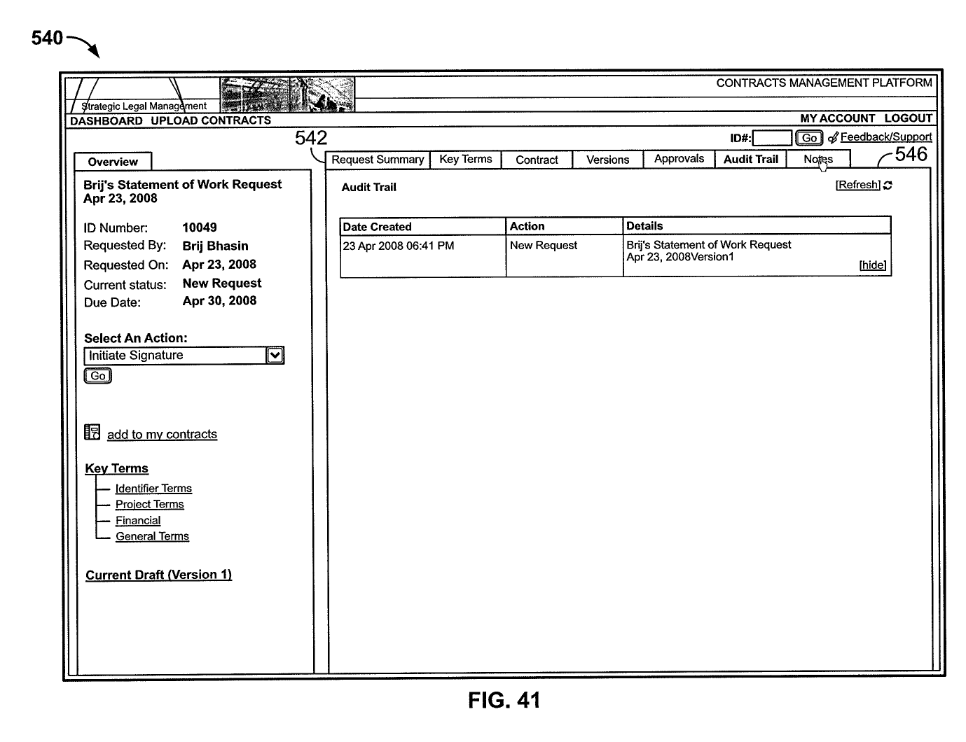

Referring now to FIG. 41, if the user selects the audit trail attribute of the toolbar 542, the module 546 shows the various modifications that have been made to the contract through the contract request process. In the example shown, only the initial request for the contract has been made. However, additional entries are added to the audit trail each time a user edits the contract or provides an approval. Each entry in the audit trail includes the date created, the action, and details. The user can select to hide items in the audit trail.

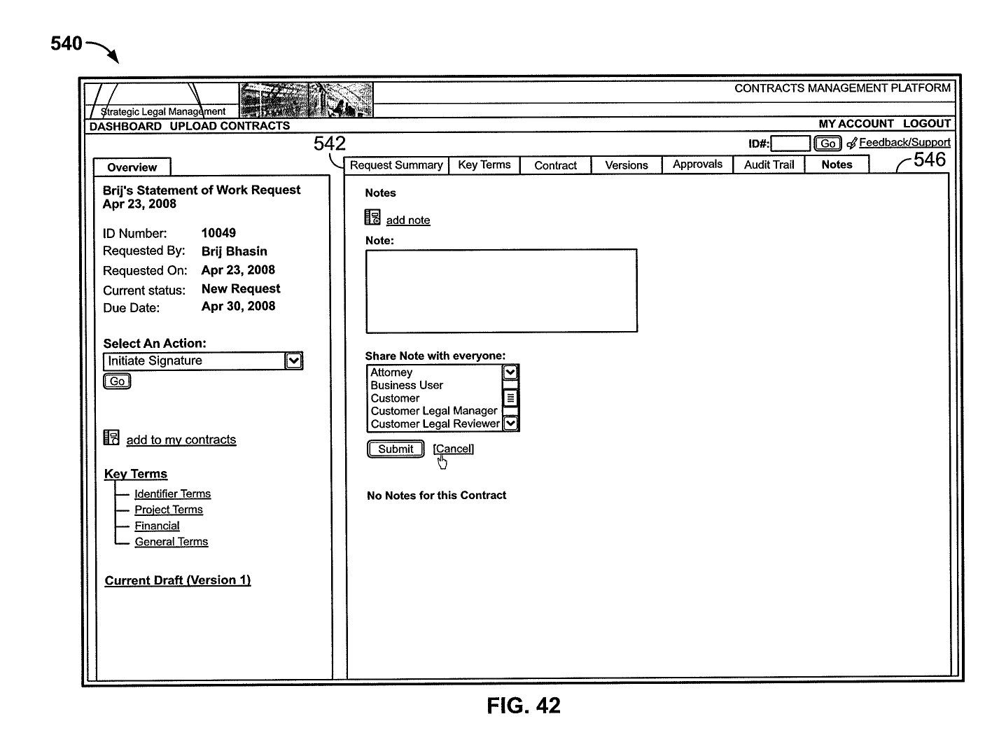

Referring now to FIG. 42, if the user selects the notes attribute of the toolbar 542, the module 546 shows the notes associated with the contract request. The user can add a note by selecting the note link. The note can include a description, as well as to which users the note is displayed.

Referring now to FIG. 43, a search interface 400 is shown. The interface 400 includes a search box 402 in which the user can type the contract name or other meta data to filter the available contracts to search for desired contracts. A table 404 provides a list of the contracts that meet the filter criteria. In the example shown, the table 404 includes the name of the customer associated with the contract, as well as the total number of contracts associated with the customer. Additional or different fields can be added to the table 404 such as, for example, contract execution date and relevant geography. The user can select the desired customer name in the table 404 to access additional information and the actual contracts associated with the customer.

The user can also select the feedback/support link 403 to provide feedback or obtain support regarding the use of the system. In one example, when the user selects the link 403, the user can define the type of feedback or assistance that is needed, such as by selecting a category of issue (e.g., technical issue, enhancement request, data change, etc.), a priority (e.g., low, normal, high, urgent), and a description of the request.

The user can also select the account link 405 to access and manage the user's bibliographic information. For example, the user can modify the user's name, company, and email address for the system 100, as well as change the user's password that is used to access the system 100. Other configurations are possible.

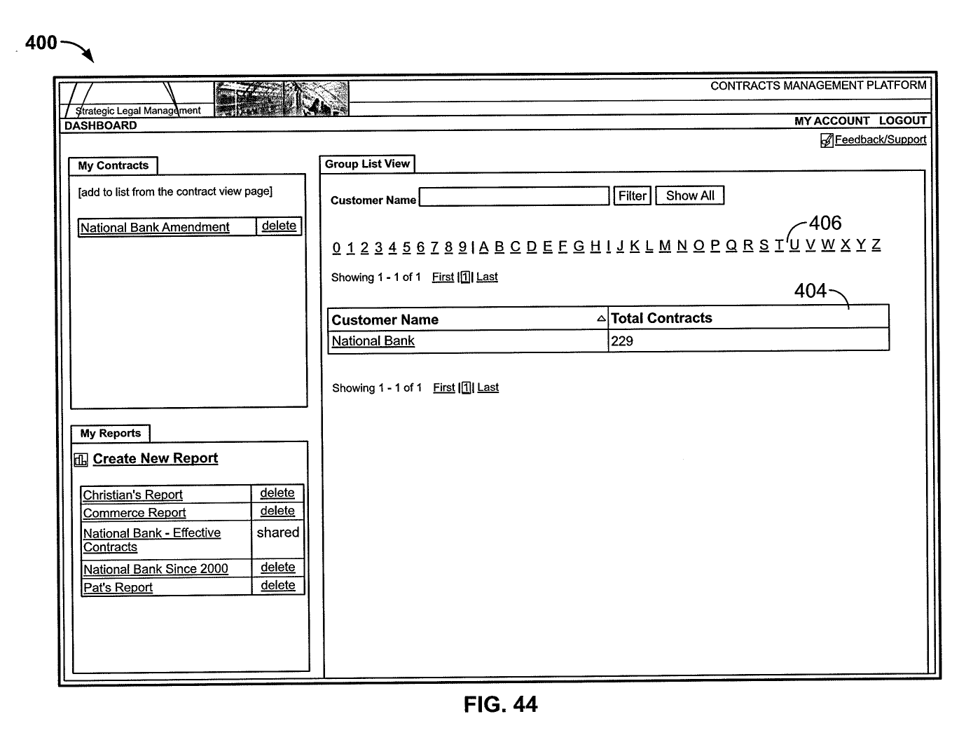

Referring now to FIG. 44, the user can also search by selecting letters or numbers in a bar 406 corresponding to the first letter or number of the customer's name. In the example shown, the user has selected the letter “N,” and contracts with the customer name starting with “N” (e.g., “National Bank”) are displayed in the table 404.

Other searching alternatives are also available. For example, in an advanced search mode, the user can search for particular contracts based on criteria associated with any of the terms in the desired contracts. For example, the user can search for all contracts that have a contract value of less than a certain amount, or search for all contracts associated with a particular customer that have not been accepted. Multiple criteria can be combined to create complex queries using Boolean and/or natural language query logic. Other configurations are possible.

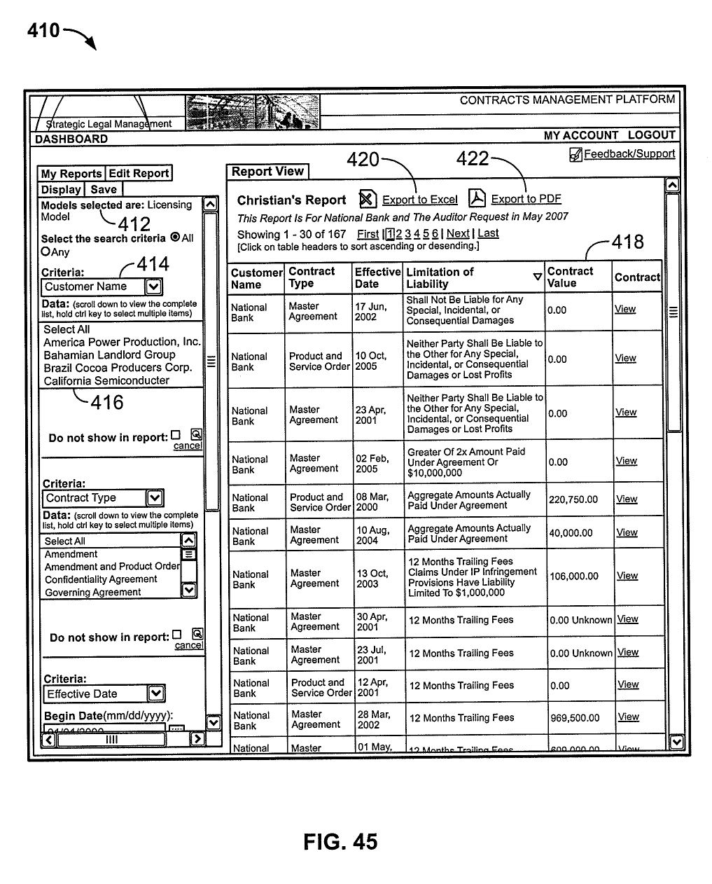

Referring now to FIG. 45, a report dashboard interface 410 is shown. The interface 410 allows the user to define and view a plurality of reports that can be used to locate and present contract information.

For example, the interface 410 includes a search module 412 that allows the user to define the search criteria for a particular report. Examples of the search criteria can include any terms associated with the contracts, as well as allowing the user to select the desired data associated with the criteria from the list of all possible data. For example, if the user selects “Customer Name” as a search criteria 414, the user can then select among one or more of the possible customer names within a data window 416. Multiple criteria can be selected to create a complex query. For example, in the embodiment shown, the user also selected to query contract type and effective date. The user can save a query associated with a particular report in the user's personal module 506 described above so that the user can readily access a report in the future.

The results of the search defined in the search module 412 are displayed in a table 418. The table 418 includes a plurality of fields associated with the resulting contracts (e.g., customer name, contract type, effective date, limitation of liability, etc.). Fields in the table 418 can be added, removed, and rearranged as desired. The user can select links 420, 422 to export the report to one of a plurality of different file types, such as Excel, Word, and PDF file formats. Other configurations are possible.

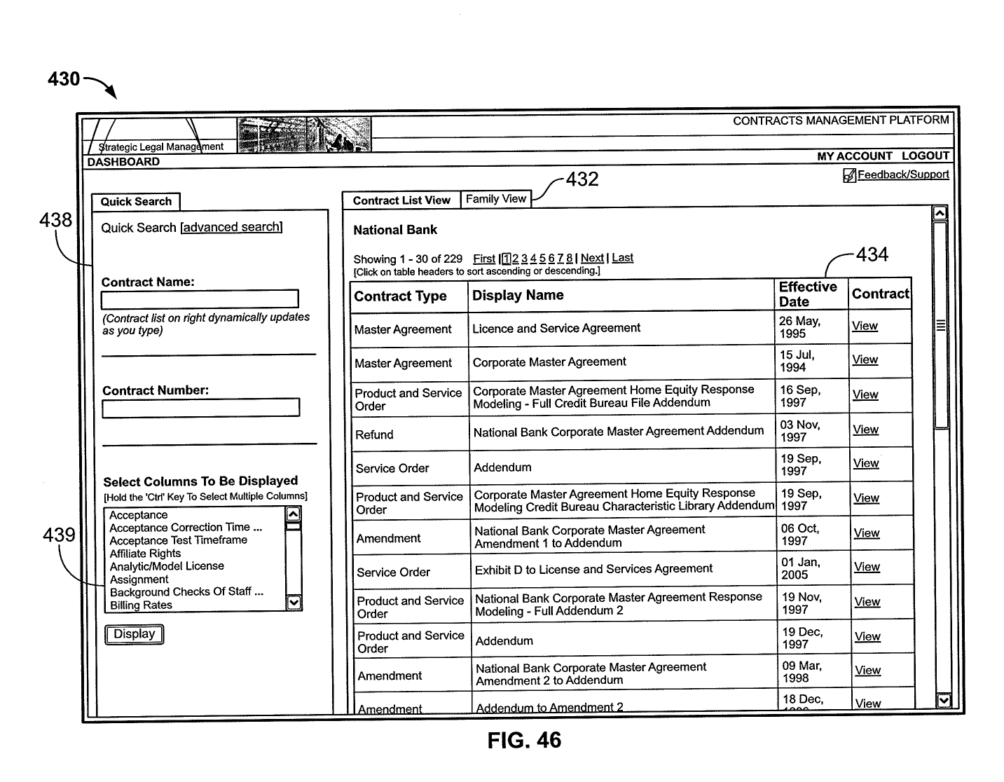

Referring now to FIG. 46, when a particular customer is selected from any of the search or report results, a customer contract interface 430 is displayed. The interface 430 lists the contracts associated with the selected customer. In example embodiments, the user can select between list and family views on a toolbar 432 to determine how the contracts are displayed.

With the list view selected in the toolbar 432, the interface 430 includes a table 434 of all of the contracts associated with the selected customer. The table 434 includes various fields such as contract type, display name, and effective date. Fields can be added and removed from the table 434, as described below.

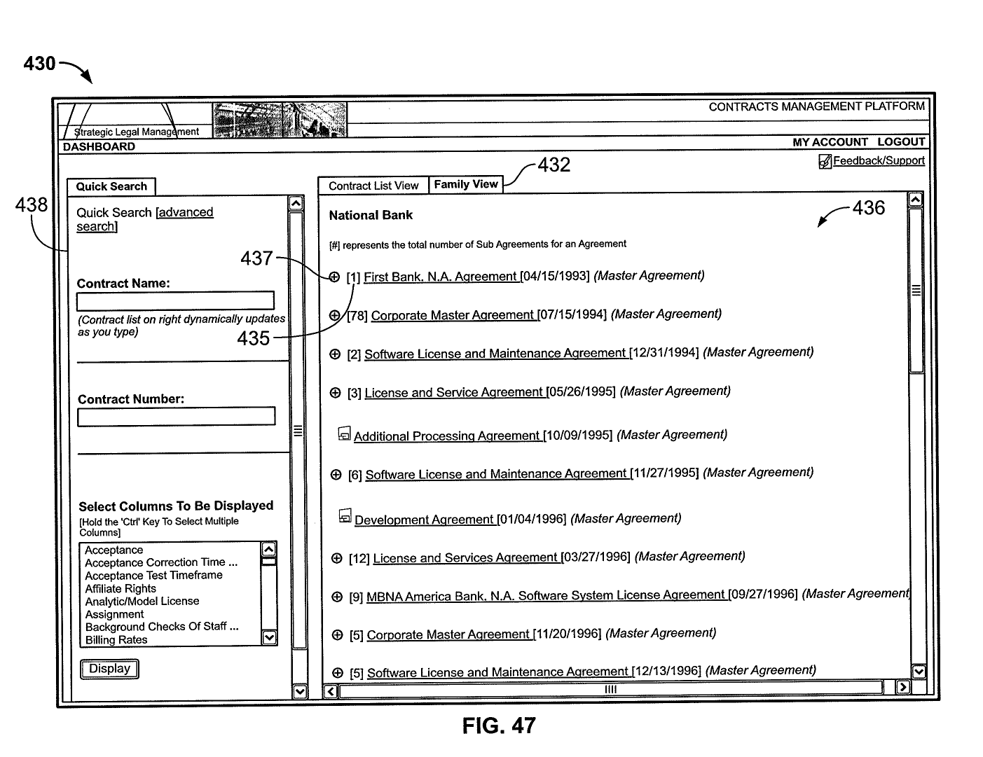

Referring now to FIG. 47, when the user selects the family view from the toolbar 432, a list 436 is shown. The list 436 includes bibliographic information about each contract, such as contract name, execution date, and contract type. In addition, the list is organized by family, so that initially only the master agreement is shown for each contract in the list 436. An indicator 435 displays the number of sub-agreements and other documents associated with each of the entries in the list 436. The user can select the expander indicator 437 (“+”) associated with an entry to view the sub-agreements and other related documents. Examples of such documents include amendments and product orders.

In addition, the interface 430 includes a search module 438 that allows the user to create quick and advanced queries. These queries can be used to filter the number of contracts shown in the table 434 and the list 436 of the interface 430. A window 439 of the search module 438 can also be used to select and deselect the fields that are shown in the table 434.

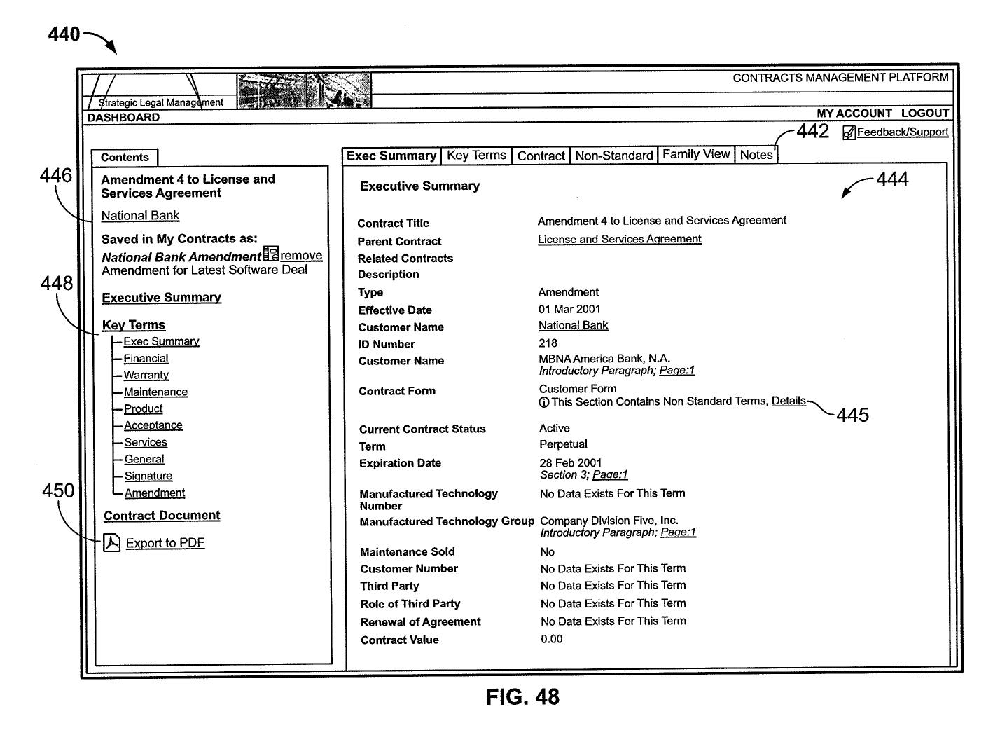

Referring now to FIG. 48, an example contract interface 440 is shown when the user selects a particular contract to view. In example embodiments, the interface 440 includes a toolbar 442 that allows the user to select among the various attributes associated with the contract for viewing, such as an executive summary, key terms, the contract image, non-standard terms, a family view, and notes.

If the user selects the “Exec Summary” tab from the toolbar 442, an executive summary module 444 is displayed to the user. The executive summary module 444 provides the user with various high level information about the contract. Examples of such information include contract title, related contracts, type, effective date, customer name, current status, etc. Other configurations are possible.

In the embodiment shown, the information on the executive summary module 444 is customized based on the role of the user accessing the executive summary module 444. As describe above, the information presented to the user on the executive summary module 444 differs depending on whether the user has a marketing role or a legal administrative role. The user's role can be defined in the user's profile, so that the system can dynamic configure the executive summary to highlight the most important information for a user based on role type. For example, a salesperson may find the revenue-related terms of a contract to be most important, while a finance resource may find the revenue-recognition terms to be the most important part of the contract. The executive summary can thereupon be configured to display the appropriate information based on the user's role.

Particular data within the executive summary module 444 can be highlighted for the user. For example, non-standard terms can be highlighted, and a link 445 is provided to allow the user to obtain details on the non-standard term, such as what the standard terms are for the term and who approved the non-standard term.

The interface 440 also includes a contents module 446. The contents module 446 includes a bookmark list 448 that allows the user to quickly jump to various terms in the contract. Also, the contents module 446 includes a link 450 that allows the user to export the selected contract to a particular file format (e.g., Word or PDF). Other configurations are possible

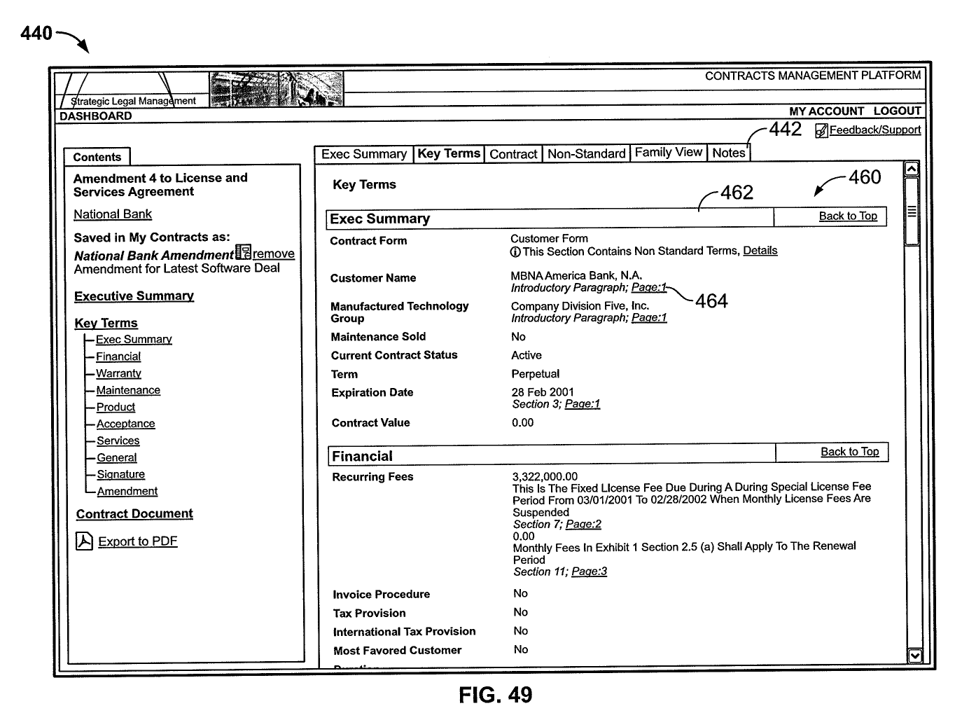

Referring now to FIG. 49, a list 460 of the terms associated with the selected contract is shown when the user selects the “Key Terms” tab on the toolbar 442. The list 460 is organized by sections 462. The terms include links 464 that, when selected by the user, take the user to the portion of the imaged contract at which the term is located.

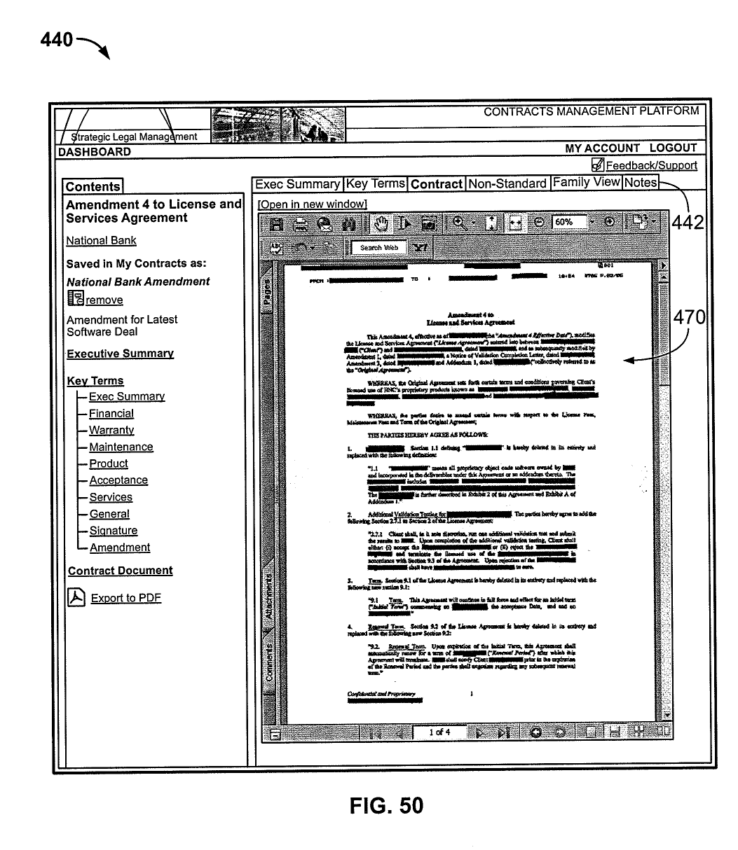

For example, referring now to FIG. 50, the interface 440 is programmed to display an image 470 of the actual contract. This image 470 can be in various formats, such as TIFF, JPEG, or PDF. A particular section of the image 470 can be displayed when the user selects the link 464 associated with a term in the list 460. Alternatively, the user can select the “Contract” tab of the toolbar 442 to access the image 470. The image 470 can be broken into multiple pages through which the user can scroll. In some embodiments, the user can perform text searches through the image 470.

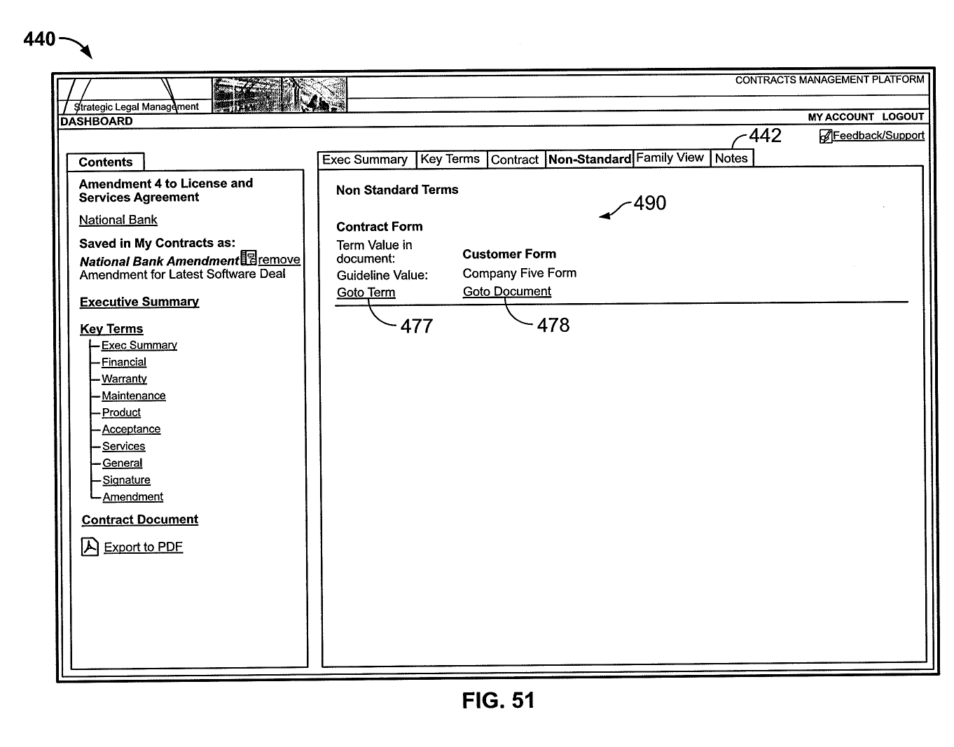

Referring now to FIG. 51, a list 476 of non-standard terms of the selected contract is shown if the user chooses the “Non-Standard” tab of the toolbar 442. In the example shown, the list 476 includes a section for each non-standard term with information including the term name, actual value in the contract, and guideline value. Each section also includes a link 477 that allows the user to go to the term in the list 460 of the terms, as well as a link 478 that displays the portion of the imaged contract at which the non-standard term is located.

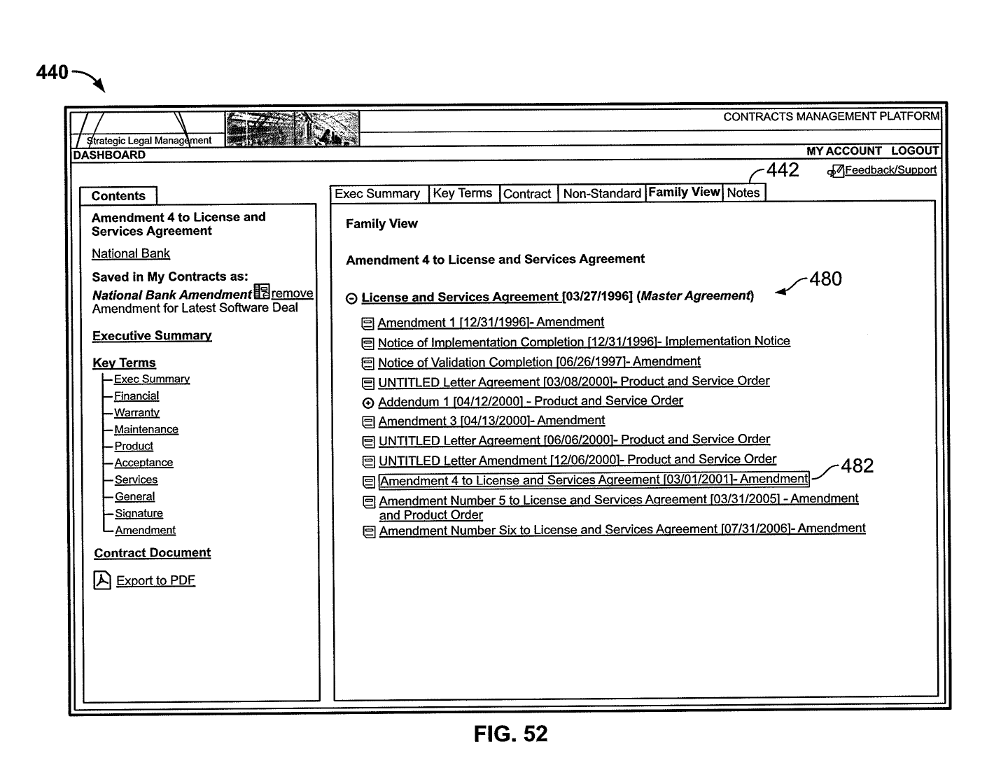

Referring now to FIG. 52, a family list 480 associated with the selected contract is shown when the user selects the “Family View” tab from the toolbar 442. The family list 480 includes all of the contracts that are associated with the contract that was originally selected by the user. The family list 480 can be displayed in a hierarchy showing the relative organization of the various contracts in the family. In addition, the contract that was originally selected by the user can be shown in highlighting 482 so that the user can readily identify the contract and its relationship to other contracts in the family. The user can view other contracts in the family by selecting the desired contract in the family list 480.

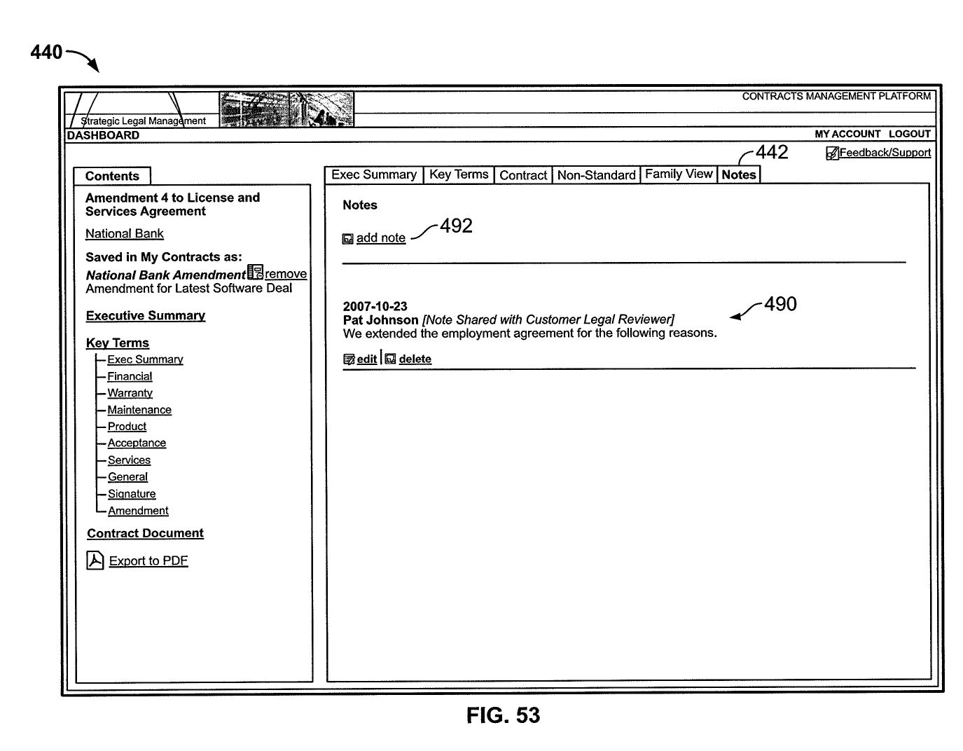

Referring now to FIG. 53, the user can access any notes associated with the selected contract by choosing the “Notes” tab on the toolbar 442. In the example shown, a note 490 is provided for the contact. The note 490 includes the note creation date, the author of the note, and the text of the note. The user can edit or delete the note. Also, the user can select a link 492 to create a new note for the selected contract.

In example embodiments, notes can be used to capture miscellaneous information associate with the contract. For example, the note 490 describes the reasons the contract was extended. Other example notes include notes related to information about the reason for entering into a contract, etc. In some examples, the display of notes is customized based on the user's role. A note related to the rationale as to why a contract was terminated may be displayed to a user having a legal administrator role, but not displayed to a user having a marketing role. For the example shown, the creator of the note can define how the note is shared. The creator can decide to share the note with all, the customer, the customer legal manager, the customer legal reviewer, or make the note private so it is available only to the creator and system administrators.

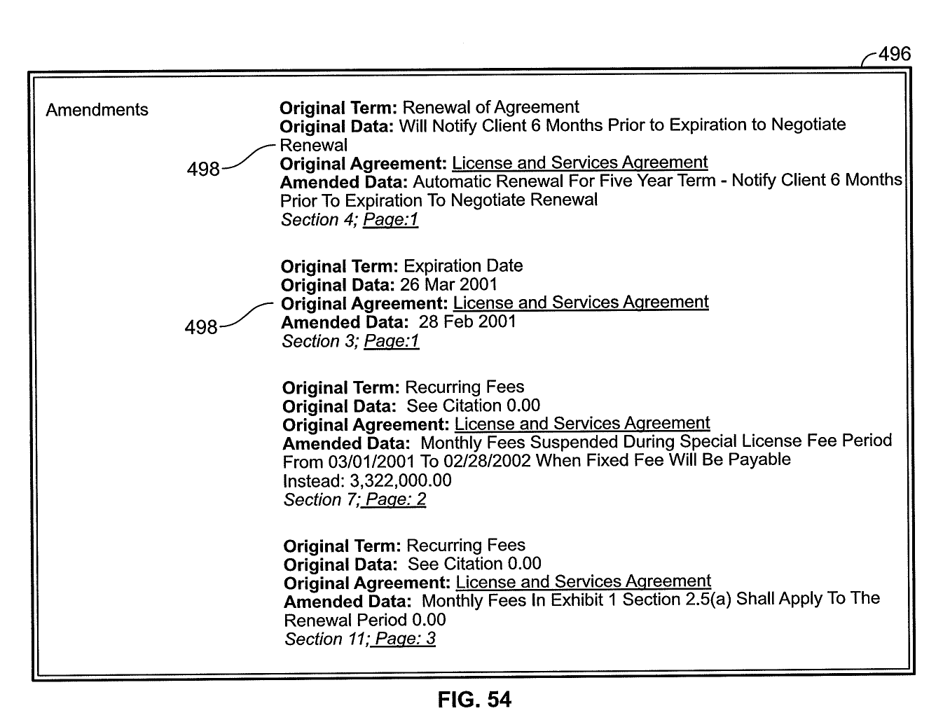

Referring now to FIG. 54, in example embodiments the interface 430 also allows the user to access an example audit window 496 listing all amendments made to the selected contract. The audit window 496 is organized into modules 498. Each of the modules 498 corresponds to an amendment made to the contract and includes information such as the original term and data, as well as the amended data. Links can also be provided to allow the user to go to an image of the original contract text and the amended contract text. In some examples, the audit window 496 is provided as one of the sections of the list 460 of the terms accessible under the “Key Terms” tab on the toolbar 442. Other configurations are possible.

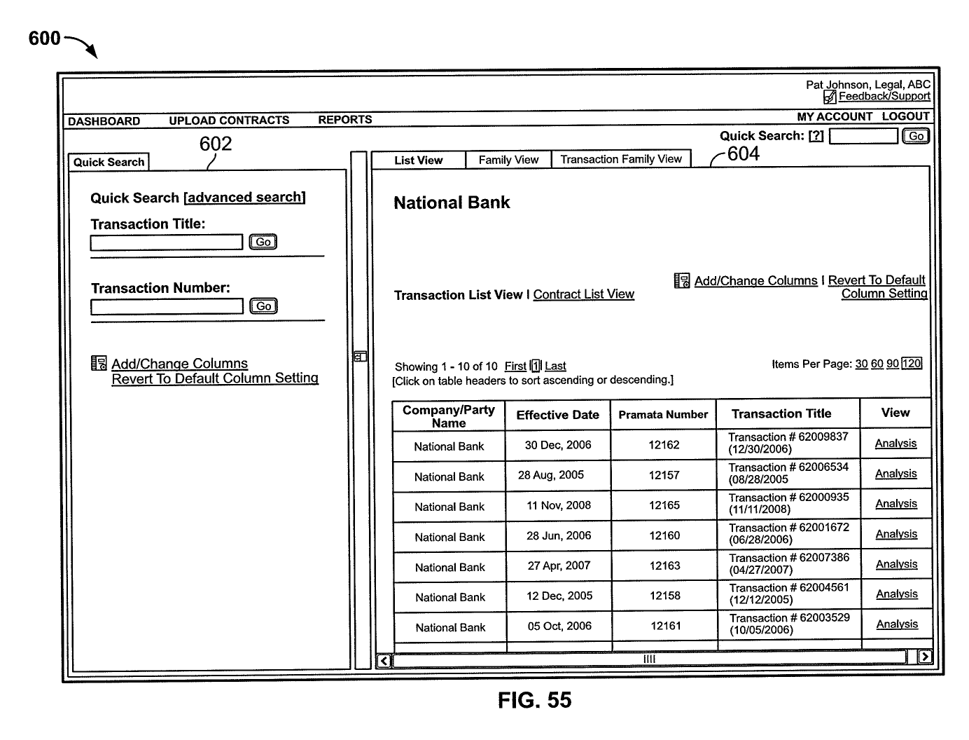

FIGS. 55-69 show example user interfaces generated while using the system 100. In example embodiments, the interfaces are programmed to facilitate contract review by providing information about transactions. The system 100 provides user interfaces that allow a user to browse through transactions and associated contracts or to search for transactions and associated contracts.

Contracts are typically documents that are used to define the parties' agreement in a particular transaction. Although some transactions involve only a single document, many transactions are more complex and include several or many different documents. A single transaction can include multiple documents. Examples of such documents include a master agreement, an addendum, a non-disclosure (or confidentiality) agreement, a product or service order, an amendment, and a variety of other possible documents.

Some embodiments of system 100 facilitate the review and storage of contracts according to the transaction that they are involved in. Examples of transactions include a confidential meeting, the sale of a home or building, the sale of a product, entering into a service agreement, or a variety of other transactions. A transaction typically includes at least one contract or other document. In some embodiments a transaction includes at least two contracts or documents. In some embodiments contracts are oral, but are memorialized in a form that can be recorded by system 100, such as an audio recording stored in an electronic format or a document summarizing the agreement.

Referring now to FIGS. 55-61, example graphical user interfaces are shown that facilitate browsing through transactions and associated contracts.

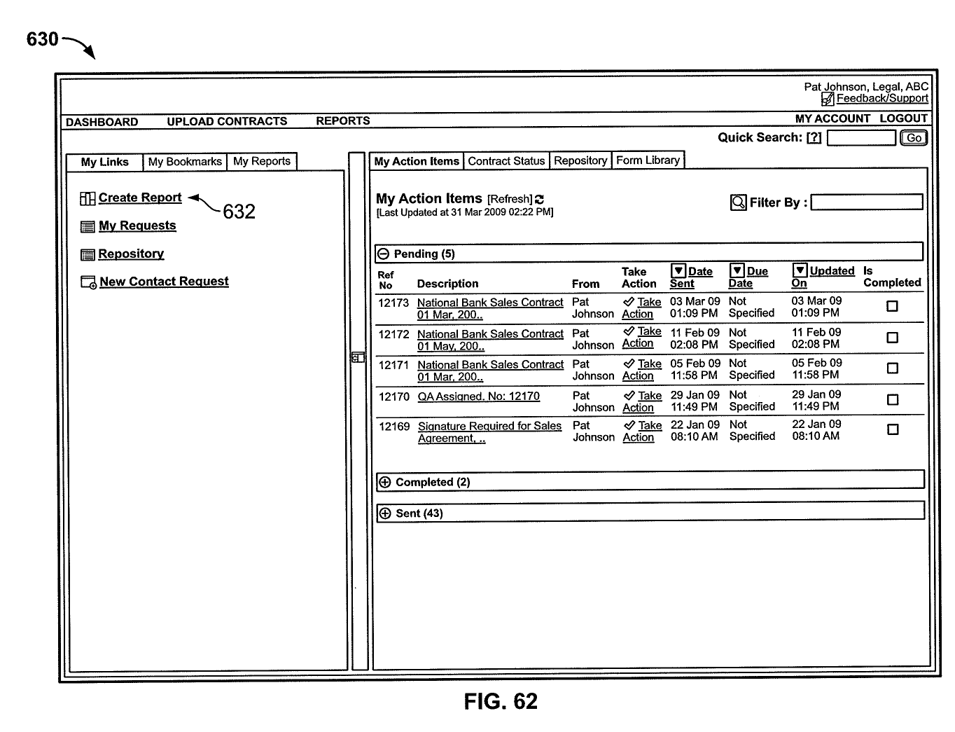

Referring now to FIG. 55, an example transaction list view interface 600 is shown. The interface 600 includes quick search module 602 and interface module 604. The quick search module 602 allows a user to search for a transaction by title or number. If a quick search is performed, interface module 604 is updated to display the results of the search. Alternatively, an advanced search option is also available in quick search module 602. If selected, the advanced search feature is activated, as described in more detail below with reference to FIGS. 62-69.

In this example, however, interface 600 includes interface module 604 that provides a transaction list view that displays a list of transactions associated with a particular company or party. In this example, the company is National Bank. Interface module 604 includes browsing tools, such as links to other pages including additional transactions. In this example, National Bank has ten transactions recorded in system 100 (with seven visible in FIG. 55). Other embodiments include other quantities of transactions.

The transaction list view in interface module 604 is customizable by the user by selecting one of the display option links, including the Add/Change Columns link and the Revert to Default Column Settings link. The Add/Change Columns link allows a user to select what fields should be displayed in each column of the transaction list view in interface module 604. More or fewer columns can be displayed. Alternatively, the user can select to return to the predefined default display settings by selecting the Revert to Default Column Settings link.

If the user prefers to view a list of contracts, rather than transactions, a Contract List View link is provided in interface module 604. Upon selection of the Contract List View link, system 100 generates an interface including the Contract List View. An example of the Contract List View is illustrated and described with reference to FIG. 46.

When the user wants to get more information about a particular transaction listed in the interface module 604, the user selects the Analysis link associated with the transaction. For example, if the user wants to view Transaction #62009837, the user selects the first Analysis link in the view column.

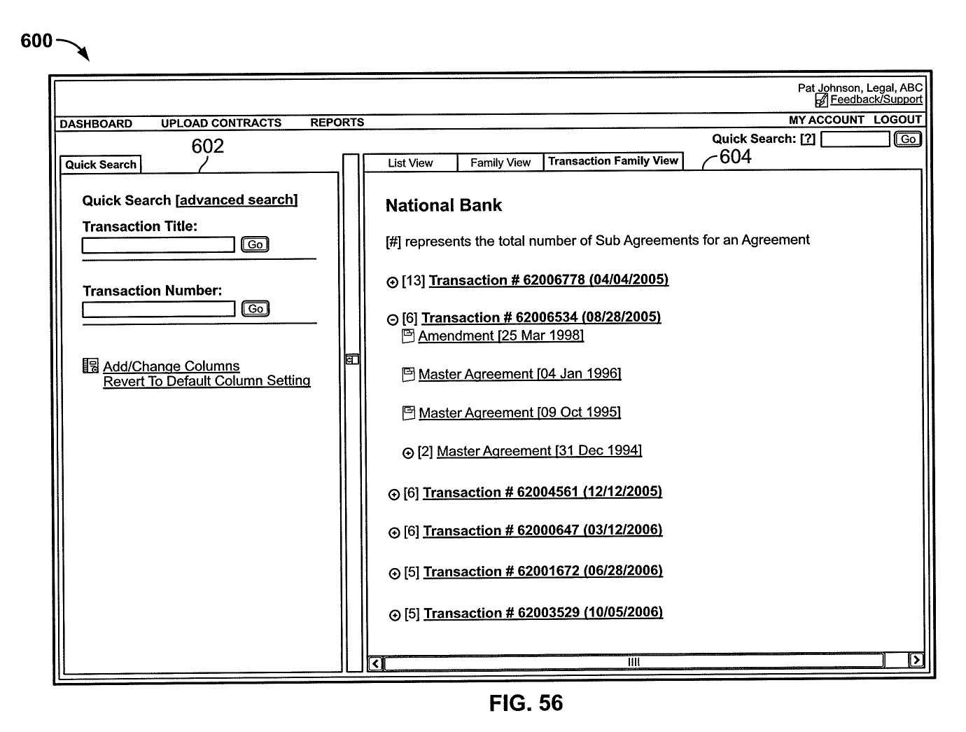

Referring now to FIG. 56, a transaction family view tab can be selected to display the transaction family view in interface module 604. This alternate view provides another list of all of the transactions involving the selected party or company, such as in this example, National Bank.

In addition, each transaction can be expanded to display a list of the documents (or types or groups of documents) involved in the transaction. In this example, the second transaction has been expanded, such as by selecting a plus icon adjacent the transaction, to display some of the documents involved in the transaction, namely the amendment dated Mar. 25, 1998, the Master Agreement dated Jan. 4, 1996, the Master Agreement dated Oct. 9, 1995, and the Master Agreement dated Dec. 31, 1994. The interface also shows that this final Master Agreement includes two documents. This group of documents can also be expanded to show the Amendment dated Sep. 30, 1997 and the Amendment dated May 13, 1999 (not shown in FIG. 56). The documents or group of documents can be hidden, such as by selecting the minus icon adjacent the transaction or group of documents.

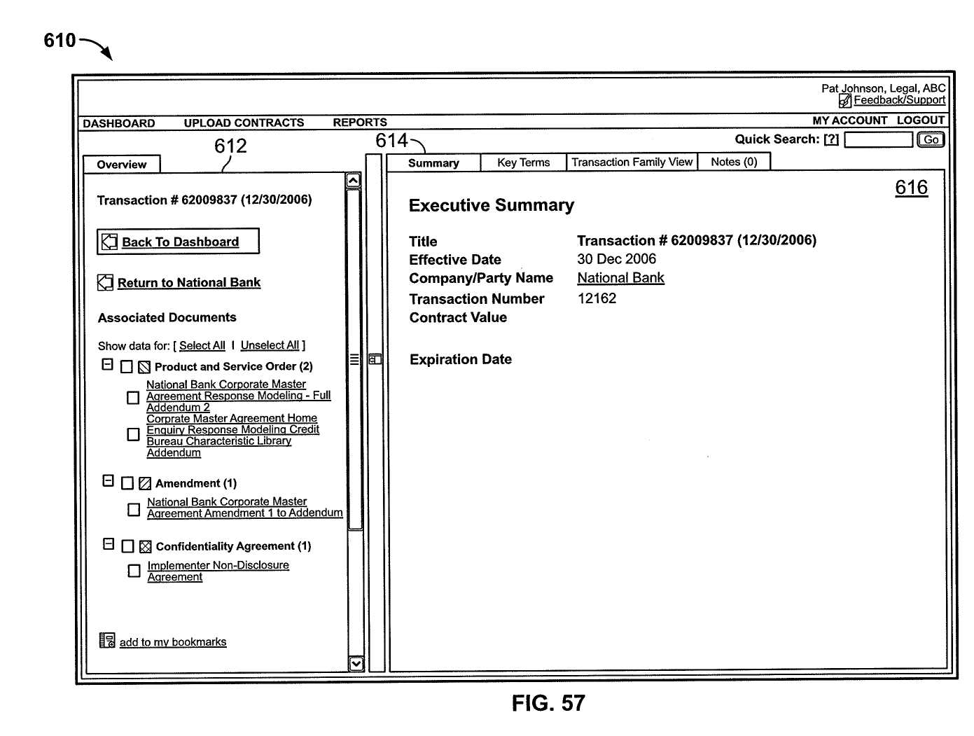

Referring now to FIG. 57, once the user has selected a transaction from the transaction list view interface (FIG. 55) or the transaction family view interface (FIG. 56), information about that transaction is displayed in the Transaction View Interface 610. The transaction view interface 610 includes overview module 612, toolbar 614, and interface module 616.

Overview module 612 provides some brief information about the selected transaction and links to additional information. In this example, overview module 612 includes a transaction name (e.g., Transaction #62009837), an effective date of the transaction (e.g., Dec. 30, 2006), navigation links (such as to return to the dashboard or to return to the transaction list view for National Bank), a list of associated documents, a link to the Executive Summary, and a list of Key Terms.

In example embodiments the list of associated documents separates the associated documents according to the type of documents. In this transaction the types of documents include product service order, amendment, and confidentiality agreement. Each type of document has a color coded box that precedes the title that can be used in interface module 616 to associate information with the document type. Preceding the color coded box is a selection box that allows the user to select which documents are of interest to the user. When a selection box is selected, interface module 616 updates to add information associated with that document(s). Similarly, if a selection box is deselected, interface module 616 updates to remove information associated with that document(s). In this example, none of the selection boxes are selected.

Tool bar 614 is selectable by the user to cause system 100 to display various information in interface module 616. In example embodiments tool bar 614 includes a Summary tab, Key Terms tab, Transaction Family View tab, and Notes tab. The Summary tab is the default in some embodiments.

When the Summary tab of tool bar 614 is selected, interface module 616 is updated to display an Executive Summary of the selected transaction. Since none of the documents in overview interface module 612 are selected, only the transaction information is displayed.

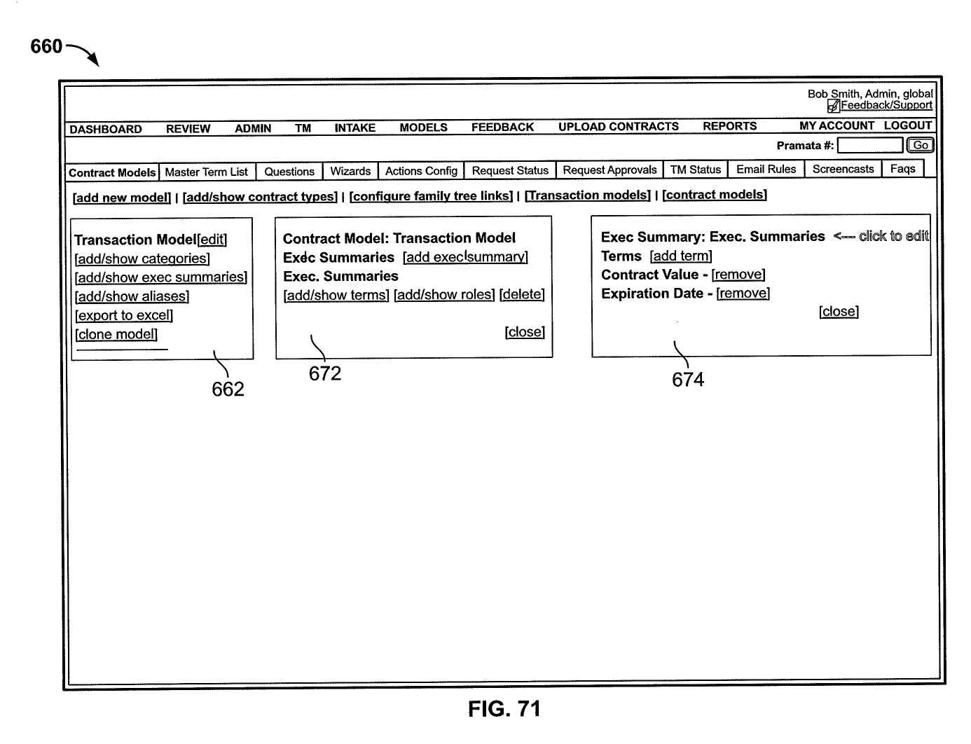

In this example, the Executive Summary displays information about the transaction, such as the title, the effective date, the company/party name, the transaction number, contract value, and expiration date. The transaction name can be any desired name for the transaction, such as a number or brief description of the transaction. The content of the executive summary is customizable in some embodiments through a transaction model interface, such as shown in FIG. 71.

In some embodiments each transaction is given a unique transaction number. For example, each time a new transaction is created, the transaction number can be incremented by one. This number can subsequently be used to identify and quickly locate a transaction (such as by using the quick search module 602 shown in FIG. 55).

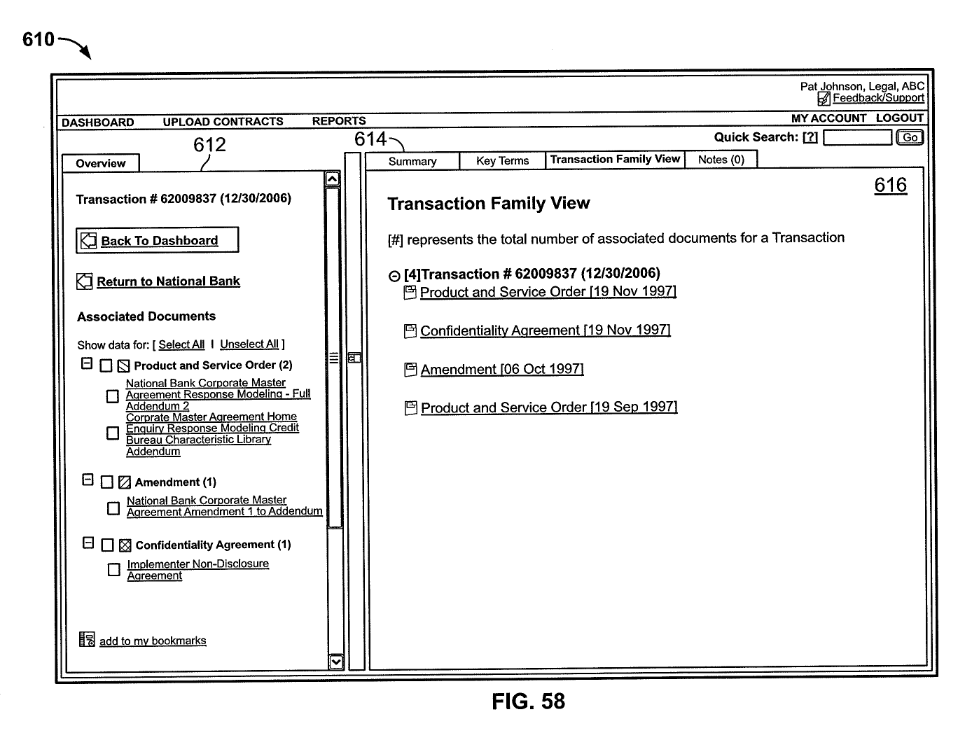

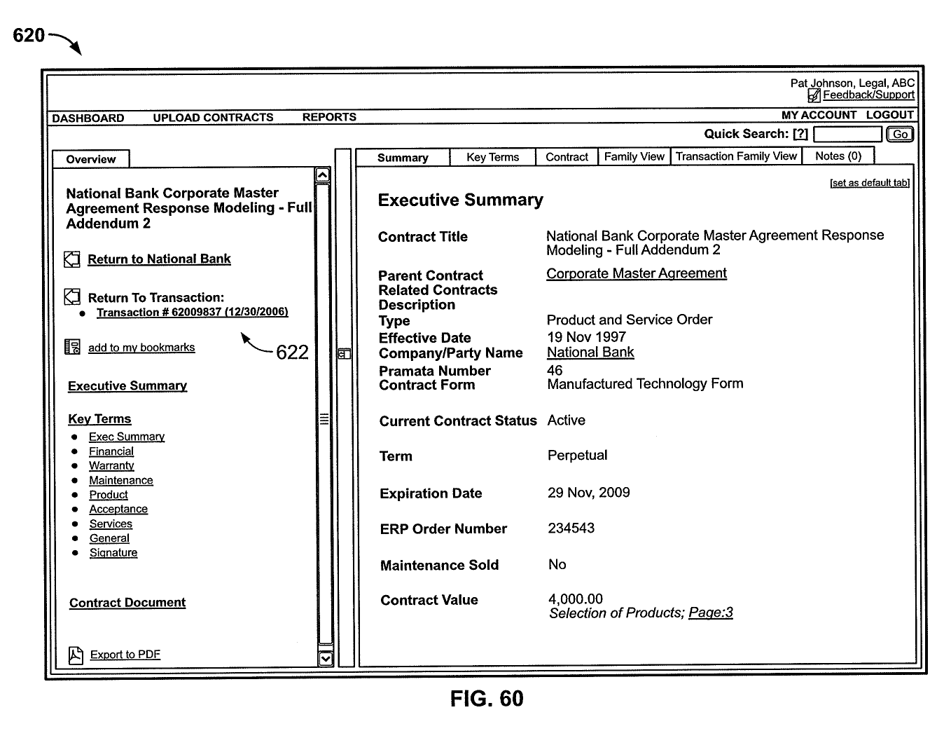

Referring now to FIG. 58, when a user selects Transaction Family View from toolbar 614, interface module 616 updates to display the Transaction Family View. In this example, the Transaction Family View displays the total number of documents associated with the transaction, the transaction name, the effective date of the transaction, a list of all of the documents associated with the transaction, and the effective dates of each document. In some embodiments, the transaction family view interface is a convenient display of all of the documents involved in a transaction. The user can select any of the documents for more information about the particular document. Such as the contract interface as shown in FIG. 60. Other embodiments display other information when the user selects the document, such as a PDF version of the document, or other information about the document.

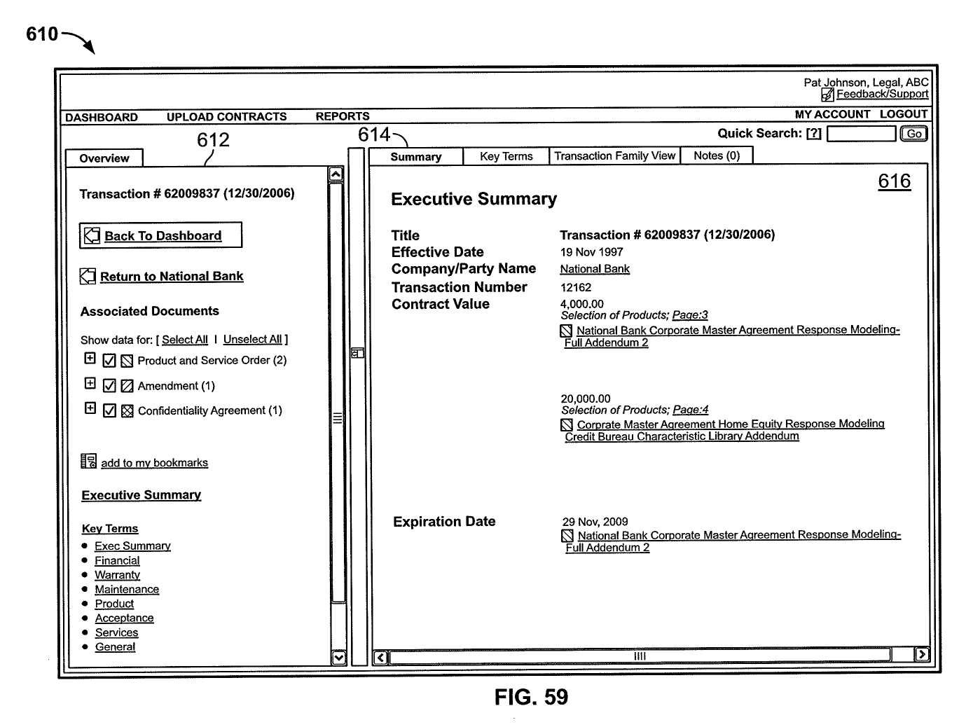

Referring now to FIG. 59, the transaction view interface 610 can also display information about the documents involved in the transaction. To include such information, the documents are selected from overview module 612. In this example, all documents are selected. Upon selection of the documents, interface module 616 is updated to include information about those documents.

For example, the Executive Summary display in interface module 616 is updated to show relevant information from the Product and Service Order documents. In some embodiments interface module 616 displays color coded boxes in front of each document to allow a user to quickly associate the document with the document type shown in overview module 612. The color coded boxes in interface module 616 have the same color as the respective color coded boxes in overview module 612.

Interface module 616 now shows that two contracts within this transaction have a contract value associated with them—one having a value of $4 million and the other a value of $20 thousand. In addition, one of the contracts is shown to have an expiration date of Nov. 29, 2009.

The user can select any of the documents shown in interface module 616 to get additional information about that document.

Referring now to FIG. 60, when a document is selected from interface module 616, the system then displays the contract interface 620 associated with that document. Contract interface 620 is similar to contract interface 440 shown in FIG. 48, except that in some embodiments the contract interface 620 includes an identification of the transaction to which the document belongs, and preferably a link 622 or button to return to the transaction view.

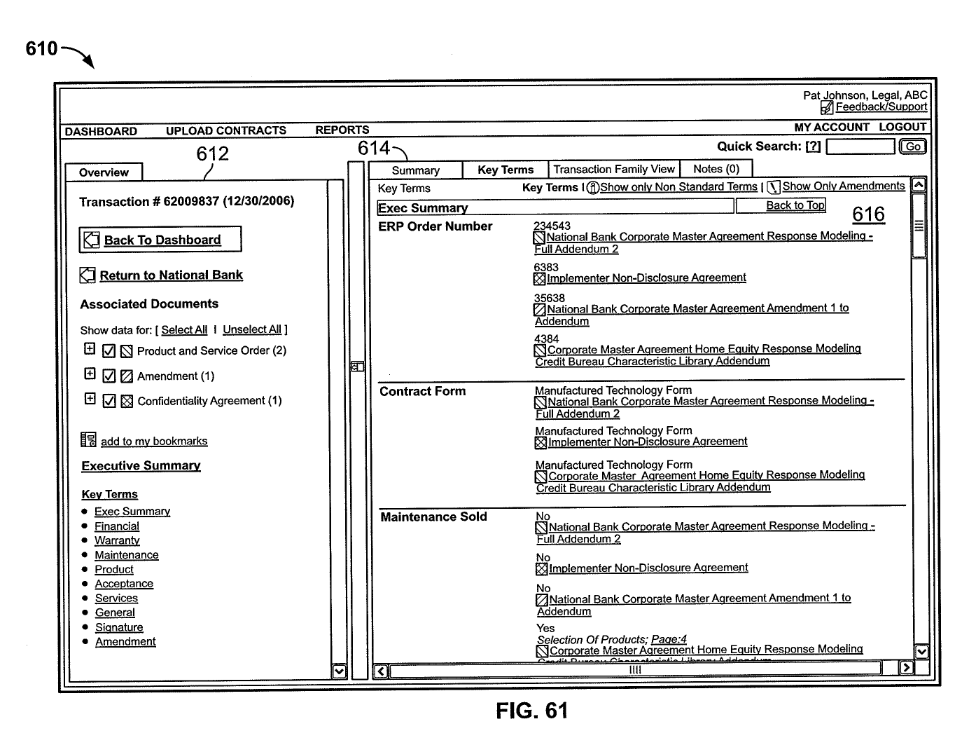

Referring now to FIG. 61, tool bar 614 includes a Key Terms tab. When selected, interface module 616 displays the key terms interface. The key terms interface is similar to the key terms interface described above with reference to FIG. 49, except that the key term interface displayed by interface module 616 can display key terms across multiple documents within the same transaction. In this example, key terms from all four documents of the transaction are displayed, because all selection boxes in overview module 612 are selected. Interface module 616 uses the color coded boxes to associate the documents with the document types in overview module 612, as discussed above. Overview module 612 includes a list of key terms that are present in at least one of the documents in the transaction. If the user selects a key term from overview module 612, interface module 616 is updated to show the document(s) containing the selected key term.

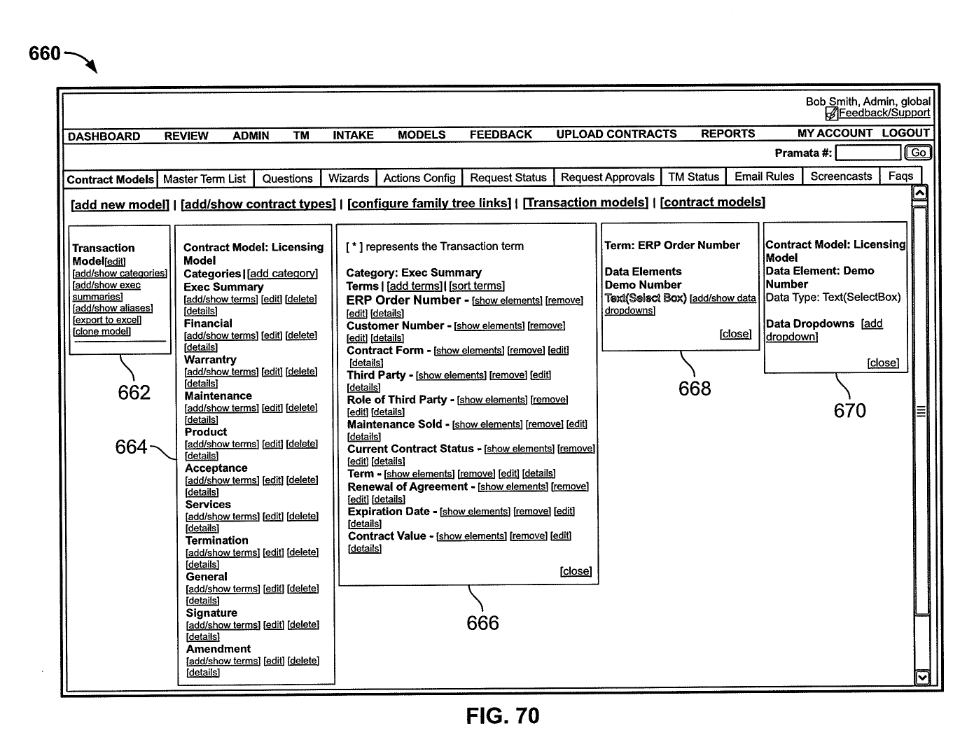

FIG. 61 also illustrates an example of a transaction model, such as defined by a transaction model interface (such as described with reference to FIG. 70 herein). In this example, the transaction model includes one or more categories (e.g., Exec Summary), one or more terms (e.g., ERP Order Number, Contract Form, Maintenance Sold), and one or more data elements (e.g., 234543, 6383, Manufactured Technology Form, No, etc.). The transaction model provides a hierarchical structure of the data from some or all of the documents involved in a particular transaction. Thus, the transaction model is similar to a contract model, but can be used to compile information from multiple documents involved in a particular transaction. The transaction view interface displays that information to the user in such a way that the user can quickly locate desired documents or information from the documents.

In this example, interface module 616 includes buttons for filtering out certain terms. For example, a “Show Only Non-Standard Terms” button is provided in some embodiments. Selection of this button causes interface module 616 to display only those terms that are outside of the predetermined limits for standard terms or that contain terms that are not considered standard terms. All standard terms are not displayed. This allows a user to quickly identify and browse through the non-standard terms within the transaction. As another example, a “Show Only Amendments” button is provided in some embodiments. Selection of this button causes interface module 616 to display only those terms that are part of an amendment. Original terms are not displayed.

In some embodiments amendments can be displayed chronologically by one or more of the interface modules described herein to allow a user to quickly review the history of a transaction.

Referring now to FIGS. 62-69, example graphical user interfaces are shown that facilitate searching for transactions and associated contracts and generating reports from the search results.

Referring now to FIG. 62, an example dashboard interface 630 is shown. Dashboard interface 630 is another possible embodiment of the dashboard interface illustrated and described with reference to FIG. 22 herein. In some embodiments the dashboard interface 630 is the first interface that is displayed to a user after logging in. The dashboard interface 630 acts as a home page for a user that provides links to the most commonly used sections or features of system 100 that are available to the user.

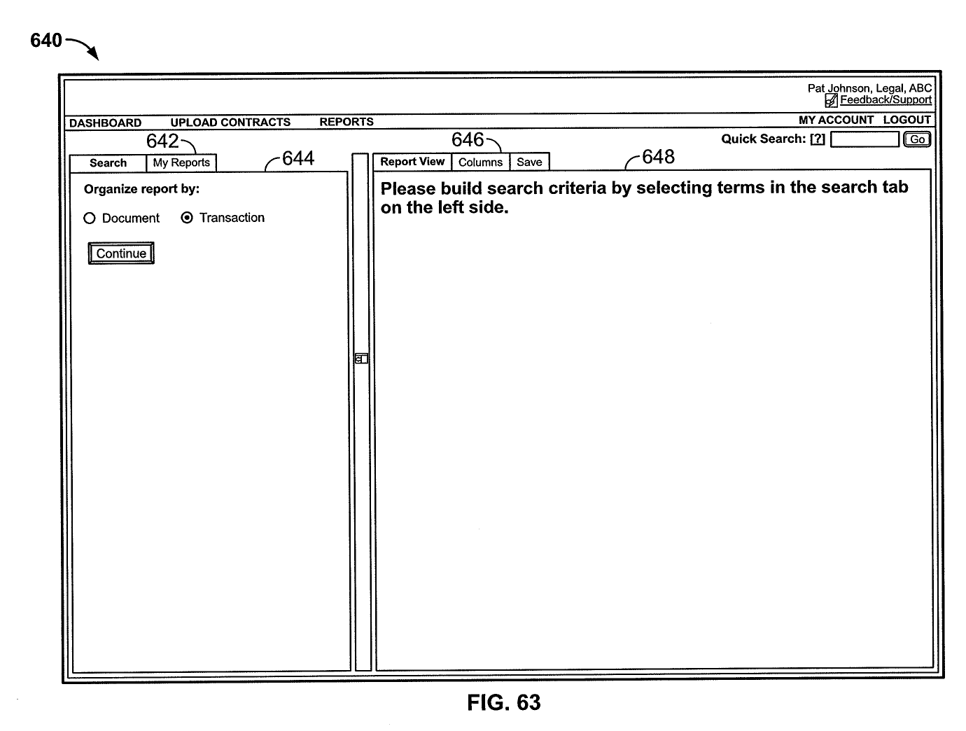

Dashboard interface 630 includes a Create Report link 632. When a user wants to perform a search of documents or transactions in system 100, the Create Report link 632 is selected to initiate a method of generating a report. The method is further illustrated in FIGS. 63-69.

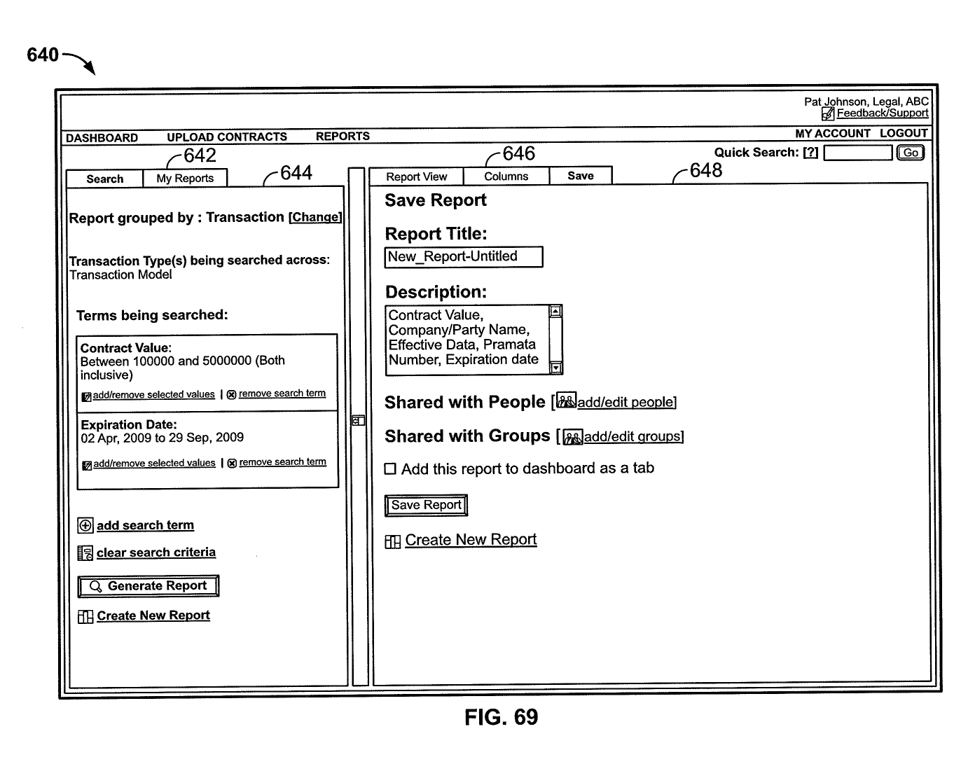

Referring now to FIG. 63, an example reporting interface 640 is shown. Reporting interface 640 includes toolbar 642, search interface module 644, toolbar 646, and results interface module 648. Toolbar 642 includes a search tab and a my reports tab. When the search tab is selected, search interface module 644 facilitates the definition of the search to be performed across system 100. Once a search has been defined, the search can be saved for future use, as discussed in more detail with reference to FIG. 69. When My Reports tab is selected, a list of saved searches is provided to allow the user to quickly run previously defined searches.

To generate a report, reporting interface 640 first prompts a user to choose whether the report should be organized according to documents or transactions. In this example, the transaction option is selected in search interface module 644 to begin generating a transaction report, and then a continue button is selected. If a document report is desired, the user selects the document option. An example of document reporting process is illustrated and described herein with reference to FIG. 45.

Some users may prefer to search by transactions, while other users may prefer to search by documents. For example, an attorney may tend to think in terms of the particular legal documents, and prefer to locate the document (or associated transaction) in that way. Other users, such as an accountant may tend to think in terms of the overall transaction, and prefer to locate the transaction (or associated documents) in that way. Further, the ability to search and generate reports based on either documents or transactions provides improved search and reporting capabilities. For example, a single transaction may have a cumulative value of five million dollars, but the individual documents are each associated with various lesser values. The option to select between documents or transactions allows the user to refine the search results more selectively than if only one or the other was available. However, some embodiments do not include the option to select between document and transaction reporting.

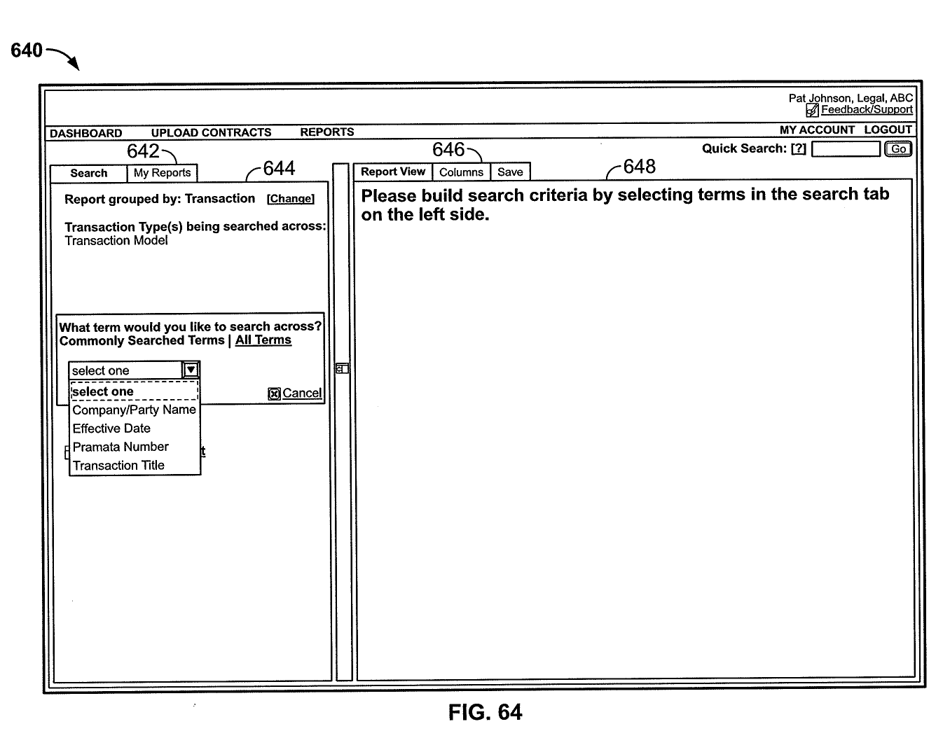

Referring now to FIG. 64, after the transaction reporting option has been selected, the search interface module 644 guides the user in setting the search scope. For example, search interface module 644 prompts the user to enter a first search term. In this example, there are two ways that a search term can be selected. The first is to select the search term from the drop down list of commonly searched terms. The second is to select the All Terms link to select the term from a list of all available search terms. Other embodiments have more or fewer methods of defining search terms.

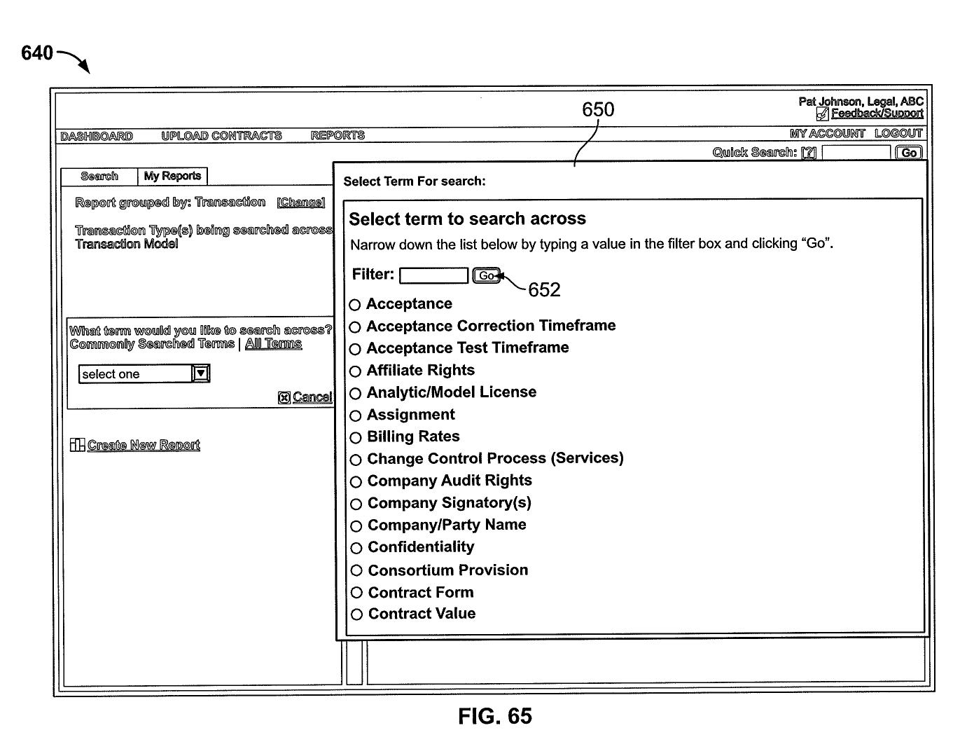

Referring now to FIG. 65, some embodiments of reporting interface 640 include a search term selection module 650. The search term selection module 650 displays a list of all of the available search terms. In some embodiments the search terms are limited to those search terms that are present in at least one transaction stored in system 100. In some embodiments the list of available search terms can be quite large, so a filter module 652 is provided. After part or all of the term is entered into the filter module 652, search term selection module 650 is updated to display only those search terms that include the characters entered into filter module 652.

In this example, the user selects the contract value term.

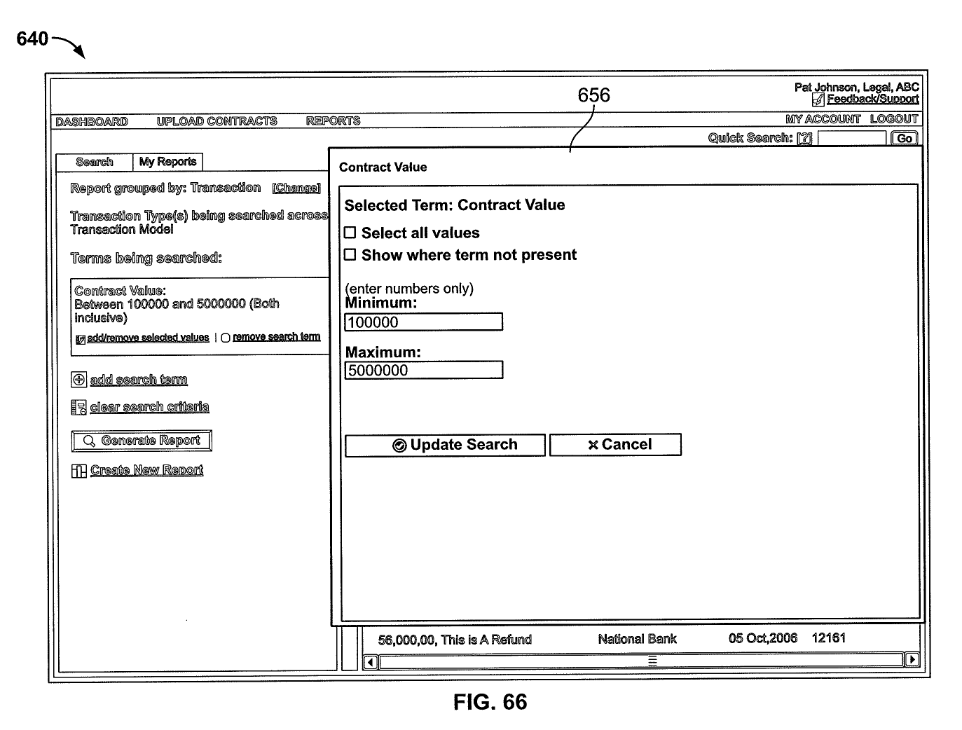

Referring now to FIG. 66, some embodiments of reporting interface 640 include a search term details module 656. The search term details module 656 is used to request additional details from a user to define additional limitations on the search scope. In this example, the user has requested a search for transactions involving the contract value search term. The search term can be used to limit search results to those transactions that have any contract value (i.e., by selecting the Select All Values option), or only those that have a contract value between a selected minimum and maximum value. Some embodiments further include an option to include or exclude those transactions that do not include the term (i.e., using the “Show where term not present” option).

In this example, the user enters a minimum value of $100 thousand and a maximum value of $5 million. The user then selects the update search button.

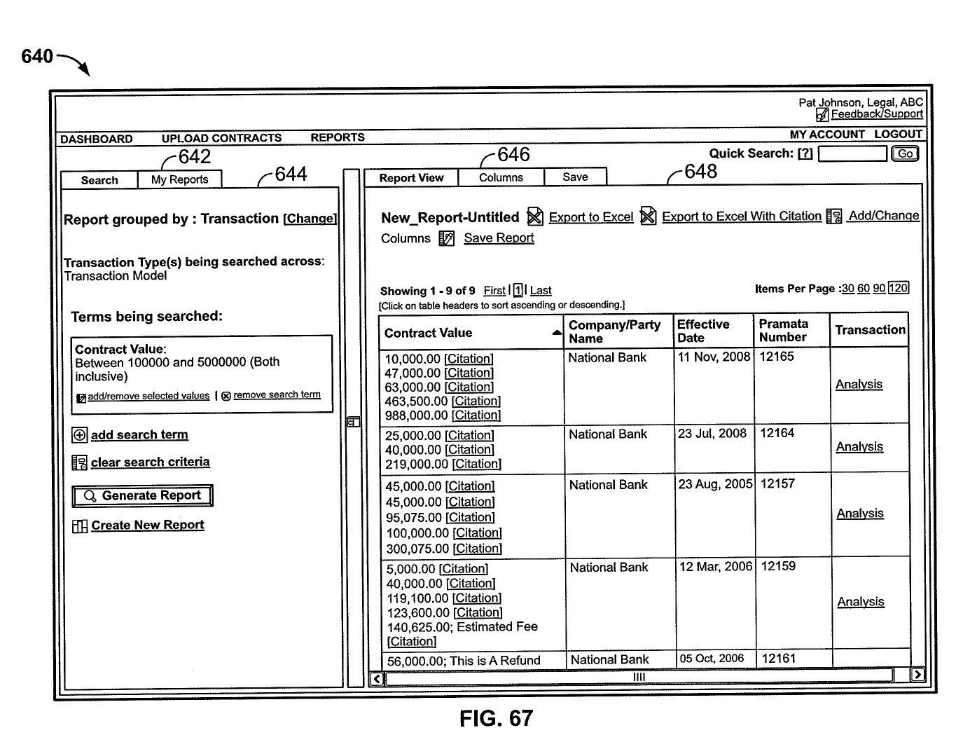

Referring now to FIG. 67, after a search term has been defined, search interface module 644 is updated to display the search term. In some embodiments the search interface module 644 then provides the user with the option of modifying the search term definition, removing the search term, adding additional search terms, clearing the search criteria and starting over, or generating the report.

To run the search, the user selects the Generate Report button from search interface module 644. System 100 then runs the search to identify all transactions that have the search terms defined in search interface module 644. A table of results is displayed in results interface module 648. The results can be sorted in ascending or descending order by selecting the desired table header at the top of the respective column. Each row of the table identifies a separate transaction that is within the search scope defined in search interface module 644. If more information is desired about a particular transaction, the Analysis button can be selected in results interface module 648. For example, if the user wants more information about the first transaction, the user selects the associated Analysis button. System 100 then generates the Transaction View Interface 610 for that transaction, such as shown in FIG. 57.

If a user wants more information about a particular document involved in the transaction, the user can select the Citation button. Referring to FIG. 67, if the user wants to view the first document of the first transaction, the user selects the Citation button following the “10,000.00” contract value for that document. This will, for example, cause the system to generate the contract interface 620, such as shown in FIG. 61. This feature can significantly reduce the time it takes a user to locate a particular document. For example, a single transaction may include several hundred pages of documents. By providing the citation button, the user is guided directly to the relevant pages of the transaction. As a result, the user does not need to look page-by-page through all of the documents involved in the transaction.

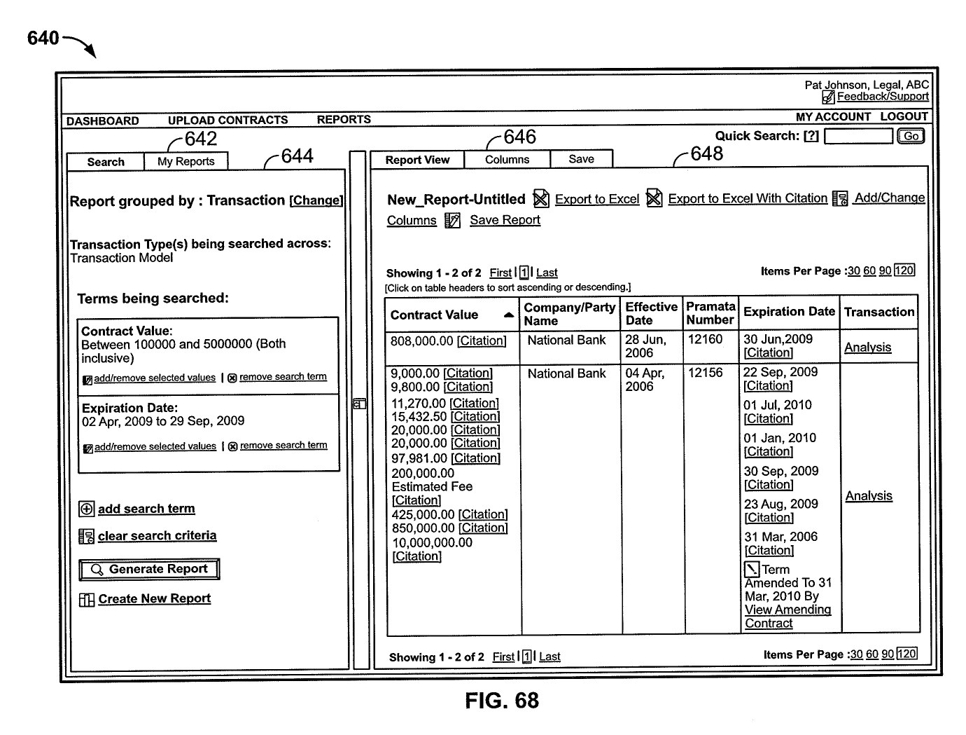

If the user wants to add additional search terms to further refine the scope of the search, the add search term button is selected from search interface module 644. The process described with reference to FIGS. 65-66 is then repeated to add an additional search term. Multiple search terms can be included in a search if desired. An example of a search including multiple search terms is shown in FIG. 68.

Referring now to FIG. 68, an additional search term is defined in search interface module 644. In this example, a user wants to know all of the transactions that have a value between $100 thousand and $5 million and are scheduled to expire (or have already expired) during the 180 day period from Apr. 2, 2009 to Sep. 29, 2009.

The system 100 performs the search and generates the report in search results interface module 648 including a table. Each row of the table identifies a transaction that matches the search criteria defined in search interface module 644.

Referring now to FIG. 69, once a search has been defined in search interface module 644, the search can be saved for later use by selecting the save tab from toolbar 646. When the save tab is selected, search results interface module 648 is updated to prompt the user to enter information about the defined search.

In example embodiments the information about the search includes a title, a description, a list of users to share the search with, a list of groups to share the search with, and an option to add the report to the dashboard as a tab. After the user has entered the appropriate information, the save report button is selected to save the report.

Saved reports allow a search to be performed quickly without requiring the user to redefine the search criteria each time that the user wants to run the search. Instead, the user instructs system 100 to generate an updated report based on the previously defined search criteria. The report is then generated.

FIGS. 70-71 show an example user interface provided to an administrator for defining a transaction model. In some embodiments transaction models are highly configurable by an administrator so that the models can be customized to meet the requirements of a particular customer. This flexibility allows the transaction model to be suitable for a wide range of customers.

Referring now to FIG. 70, an example transaction model interface 660 is shown. Each aspect of the transaction model has a separate module in which that aspect can be defined. For example, transaction model interface 660 includes transaction model module 662, categories module 664, terms module 666, data elements module 668, and data dropdown module 670.

The modules define a hierarchical structure for data within the transaction model. In this example, the transaction model includes one or more categories defined by categories module 664. Each category includes one or more terms defined by terms module 666. Each term includes one or more data elements defined by data elements module 668. In some embodiments data elements are limited to a set of options selected from a list of data elements. The list of data elements can be defined by a data dropdown module 670.

This example illustrates the configuration of one example transaction model. The corresponding transaction view associated with this model is illustrated and described herein with reference to FIG. 61.

In example embodiments the transaction model module 662 includes buttons to add/show categories, add/show executive summaries, or add/show aliases. In addition, the model can be exported to another format (such as to a Microsoft® Excel brand spreadsheet software format) or the model can be cloned.

If a user (such as the administrator) wants to view or edit the transaction model categories, add/show categories is selected to cause transaction model interface 660 to display categories module 664. In example embodiments the categories include executive summary, financial, warranty, maintenance, product, acceptance, services, termination, general, signature, and amendment. The categories module 664 includes options to add/show terms associated with the category, edit the category, or delete the category.

If a user wants to view or edit the terms associated with the executive summary category, the add/show terms option is selected for the executive summary category. The terms module 666 is then displayed. In example embodiments the terms for the executive summary include ERP order number, customer number, contract form, third party, role of third party, maintenance sold, current contract status, term, renewal of agreement, expiration date, and contract value. The terms module 666 also includes options for each term including show elements, remove, edit, or details.

If a user wants to view the data elements in the ERP order number, for example, the show elements option is selected for the ERP order number term. The data elements module 668 is then displayed. In example embodiments the data elements module 668 identifies the content as a single text-based entry. An add/show data dropdown option is also provided in customer number module 668.

If the user wants to add or view a data dropdown associated with the order number, the add/show dropdown option is selected. Data dropdown module 670 is then displayed by transaction model interface 660. In example embodiments the data dropdown module 670 further includes an add dropdown option. The data dropdown module 670 allows the user to define a list of possible data elements for the respective data element.

This example illustrates just one possible configuration of a transaction model. Other embodiments include various possible configurations that are configurable through transaction model interface 660.

Referring now to FIG. 71, another example of the transaction model interface 660 is shown. This example illustrates the configuration of the executive summary of the transaction view interface 610, such as illustrated and described with reference to FIG. 56 herein. In this example, an executive summary configuration of the transaction model is displayed. The transaction model interface 660 includes transaction model module 662, executive summaries module 672, and terms module 674.

If the user wants to view or edit the executive summaries of the transaction model, the add/show executive summaries option of the transaction model module 662 is selected. Transaction model interface 660 then displays the executive summaries module 672. In example embodiments the executive summaries module 672 includes an add/show terms option, an add/show roles option, a delete option, and a close option.

If the user wants to view or edit the terms of the executive summary, the add/show terms option is selected. Transaction model module 662 then displays the terms module 674. In example embodiments the terms module 674 includes contract value and expiration date. The terms module 674 also includes options to edit the term, add a term, remove the terms, and close the terms module 674.

When compared with the resulting transaction model interface 610, shown in FIG. 56 it can be seen that the transaction model interface displays the contract value and the expiration date as configured in transaction model interface 660.

Referring now to FIG. 72, an example block diagram of a computing device, such as the computing device of server 122 (shown in FIG. 1). Additional devices described herein have a structure of or similar to the computing device shown in FIG. 72 in some embodiments. For example, clients 110, 112, and 114, and server 124 (such as shown in FIG. 1) can also be implemented as a computing device.

In example embodiments server 122 is a computing device that includes a processing device 1002, memory 1004, a storage device 1006, a communication device 1008, an input device 1010, and an output device 1012. In its most basic configuration, server 122 typically includes at least processing device 1002, memory 1004, and communication device 1008.

Processing device 1002 is a device that processes a set of instructions. One example of processing device 1002 is a microprocessor. Alternatively, various other processing devices may also be used including central processing units (“CPUs”), microcontrollers, programmable logic devices, field programmable gate arrays, digital signal processing (“DSP”) devices, and the like. Processing devices may be of any general variety such as reduced instruction set computing (RISC) devices, complex instruction set computing devices (“CISC”), or specially designed processing devices such as an application-specific integrated circuit (“ASIC”) device.

Examples of memory 1004 include volatile (such as RAM), and non-volatile (such as ROM and flash) memory. In some embodiments, memory 1004 is part of processing device 1002, while in other embodiments memory 1004 is separate from or in addition to that of processing device 1002.

In some embodiments, server 122 also includes an additional storage device 1006. Storage device 1006 stores digital data. For example, some embodiments of server 122 include removable storage or non-removable storage, including, but not limited to, magnetic or optical disks or tape.

Computer storage media includes volatile and nonvolatile, removable and non-removable media devices implemented in any method or technology for storage of information such as computer readable instructions, data structures, program modules or other data. Memory 1004 and storage device 1006 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by server 122. Any such computer storage media may be part of server 122.

In some embodiments, memory 1004 and/or storage device 1006 store data instructions including one or more of an operating system, application programs, other program modules, and program data.

Server 122 also includes communication device 1008 that allows server 122 to communicate with other devices, such as across network 120 (shown in FIG. 1). Communication device 1008 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. Examples of communication media include wired media such as a wired network or direct-wired connection, and wireless media such as acoustic, radio frequency, infrared and other wireless media. The term computer readable media as used herein includes both storage media and communication media.

In some embodiments, server 122 includes one or more input devices 1010, such as a keyboard, mouse, pen, voice input device, touch input device, or other input device. Some embodiments include one or more output devices 1012, such as a display, speaker, printer, or other output device.

Although the examples described herein relate to the use of the system to create and manage contractual information, the systems and methods described herein can be used to manage other types of legal instruments as well. For example, in alternative embodiments, the systems and methods can be used to manage intellectual property legal instruments, such as by automating the creation and management of documents associated with the preparation, prosecution, and maintenance of patent and trademark portfolios. Other configurations are possible.

The various embodiments described above are provided by way of illustration only and should not be construed to limiting. Various modifications and changes that may be made to the embodiments described above without departing from the true spirit and scope of the disclosure.

What is claimed is:

1. A system for creating and managing contractual information, the system comprising:
a processing device; and
a memory storing program instructions that when executed by the processor cause the processor to generate:
a contract modeling module programmed to define a plurality of contract terms that are incorporated into a contract model, as well as to define a template that is configured to generate a draft contract;
a customer module programmed to execute a wizard associated with the contract model to receive information associated with the contract terms, validate the information, and apply the information to the template to generate the draft contract;
a contract review module programmed to import an existing contract and to identify contract terms within the existing contract; and
a user management module programmed to restrict access to the draft contract based on the contract terms.

2. The system of claim 1, wherein the contract modeling module is further programmed to define a plurality of contract categories for each contract model, and to associate at least some of the plurality of contract terms with each contract category.

3. The system of claim 1, further comprising a contracts repository storing a plurality of contracts.

4. The system of claim 3, wherein the customer module further comprises a search interface programmed to receive a search query, perform a search of the contracts repository, and generate a list of contracts in the contracts repository matching the search query.

5. The system of claim 1, wherein the contract review module is further programmed to associate the identified contract terms in the existing document with normalized contract terms.

6. The system of claim 1, wherein the user management module is further programmed to restrict access based on a user role.

7. A method of managing contractual information, the method comprising:
storing a master term list including a plurality of master terms in memory with a computing device, the plurality of master terms including at least a first master term;
storing a first document in the memory with the computing device;
outputting the first document with the computing device;
receiving with the computing device a first input identifying a first document term in the first document;
receiving with the computing device a second input identifying the first master term of the master term list; and
associating the first document term with the first master term in the memory with the computing device.

8. The method of claim 7, wherein the plurality of master terms comprise a set of normalized terms.

9. The method of claim 8, further comprising:
storing a first contract model in the memory with the computing device, the first contract model including an identifier of the contract model and a first subset of the plurality of terms that relate to the first contract model; and
associating the first document with the first contract model in the memory with the computing device.

10. The method of claim 9, further comprising:
receiving with the computing device a third input identifying a second document term of the first document;
receiving with the computing device a fourth input identifying the second document term as a non-standard document term; and
associating the second document term as a non-standard term in the memory with the computing device.

11. The method of claim 10, further comprising:
receiving a request to perform a search for documents including at least one non-standard term;
performing the search to identify the first document as including the non-standard term; and
generating a report including an identifier of the first document.

12. The method of claim 10, further comprising:
sending a request to an approver requesting review and approval of the non-standard term; and
receiving at the computing device a response from the approver including at least one of an approval or a rejection of the non-standard term.

13. The method of claim 7, further comprising:
storing a second document in the memory;
defining a contract family; and
associating the first and second documents with the contract family.

14. A method of managing contractual information, the method comprising:
storing a master term list in a memory with a computing device, the master term list identifying a plurality of contract terms;
storing a plurality of documents in the memory with the computing device;
associating document terms within the plurality of documents with the contract terms of the master list and storing the associations in the memory with the computing device to normalize the document terms;
receiving with the computing device a search request including at least one of the contract terms;
performing a search to identify a subset of the plurality of documents that match the search request; and
generating a report identifying the subset of the plurality of documents that match the search request.

15. The method of claim 14, wherein a first of the plurality of contract terms is associated with at least two document terms, wherein each of the at least two document terms include different terminology, and wherein each of the plurality of document terms have a similar meaning.

16. The method of claim 14, wherein generating a report includes generating a user interface that includes links for each of the documents in the subset, where when a link is selected by a user, the user interface displays information about the respective document.

17. The method of claim 14, wherein associating document terms further comprises storing normalized data in the memory with the computing device.

18. The method of claim 17, wherein performing the search comprises searching through the normalized data to identify document terms that match the search request and to identify the associated documents.

19. The method of claim 14, wherein the search request further comprises at least one data element for the at least one of the contract terms.

20. The method of claim 19, wherein the at least one data element is a keyword.
